(19) United States
(12) Patent Application Publication
(10) Pub. No.: US 2008/0314277 A1
(43) Pub. Date: Dec. 25, 2008

(54) Printing quality control method and system for relief printing press

(75) Inventors: Akehiro Kusaka, Noda-Shi (JP); Hiromitsu Numauchi, Tsukuba-Shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/213,483

(22) Filed: Jun. 19, 2008

(30) Foreign Application Priority Data
Jun. 21, 2007 (JP) 2007-163377

(51) Int. Cl. B41F 33/00

(52) U.S. Cl. 101/484

(57) ABSTRACT

Provided are an ink supply amount adjustment method and system for a relief printing press including: a first rotor, such as an ink form roller, to which ink is supplied; a second rotor, such as a plate cylinder, to which the ink is supplied from the first rotor; and adjustment means, such as a motor, for adjusting, for example, the nip pressure between the first rotor and the second rotor. The width of a line portion printed on paper W by the relief printing press is measured by a line-width measuring camera, and the adjustment means such as the motor is controlled on the basis of the line portion width obtained by the line-width measuring camera.

### BACKGROUND OF THE INVENTION

1. Field of the Invention

The present invention relates to a printing quality control method and system for a relief printing press.

2. Description of the Related Art

It is known that normal printing products cannot be produced in a conventional relief printing for the following reason. Specifically, ink spreads to the outside of the printed pattern, or a portion of the pattern is not printed, due to changes in nip pressures (contact pressures) between an ink form roller and plate cylinder and between the plate cylinder and a blanket cylinder, as well as a printing pressure between the blanket cylinder and an impression cylinder in the case of a usual offset type relief printing, changes in a nip pressure (a contact pressure) between an ink form roller and a plate cylinder, as well as a printing pressure between the plate cylinder and an impression cylinder in the case of a direct printing type relief printing, or changes in a nip pressure (a contact pressure) between a blanket impression cylinder and a blanket cylinder in addition to the pressures described above in the case of double-sided printing type of relief printing.

The following printing troubles occur, for example, in a case where the amount of ink in an raised portion of a plate is fixed, ink spreads outside from the raised portion when a nip pressure between an ink form roller and a plate cylinder is high, while ink is not printed in some portions or a patchy or thin line is printed when the nip pressure is low. Moreover, in the above case, ink spreads outside from the raised portion when a nip pressure between the plate cylinder and a blanket cylinder or a printing pressure between the blanket cylinder and an impression cylinder is high, while ink is not printed in some portion or a patchy or thin line is printed, when the nip pressure or the printing pressure is low.

Accordingly, in the conventional relief printing, it is necessary for the operator to check printing products while repeating printing many times, in order to adjust nip pressures and a printing pressure. This leads to a problem that a heavy burden is imposed on the operator. In addition, since a nip pressure and a printing pressure are adjusted in accordance with the operator's intuition, the quality of printing products varies and a large amount of waste paper is produced, due to adjustment errors. This leads to another problem, an increase in costs.

### SUMMARY OF THE INVENTION

An object of the present invention is to provide a printing quality control method and system for a relief printing press which can reduce a burden of the operator by enabling automatic adjustment of nip pressures and a printing pressure according to the width or the area of a line portion obtained in advance, and which can also achieve a reduction in costs by reducing the amount of waste paper to be produced.

A first aspect of the present invention for achieving the above-described object provides a printing quality control method for a relief printing press including: a first rotor to which ink is supplied; a second rotor to which the ink is supplied from the first rotor; and contact pressure adjustment means for adjusting the contact pressure between the first rotor and the second rotor. The printing quality control method comprises the steps of: measuring, by using width measurement means, the width of a line portion printed on a print member by the relief printing press; and controlling the contact pressure adjustment means on the basis of the width of the line portion thus measured.

A second aspect of the present invention provides a printing quality control method for a relief printing press including: a first rotor to which ink is supplied; a second rotor facing the first rotor, and holding a print member to which the ink is supplied from the first rotor; and printing pressure adjustment means for adjusting the printing pressure between the first rotor and the second rotor. The printing quality control method comprises: measuring, by using width measurement means, the width of a line portion printed on the print member by the relief printing press; and controlling the printing pressure adjustment means on the basis of the width of the line portion thus measured.

A third aspect of the present invention provides a printing quality control method for a relief printing press including: a first rotor to which ink is supplied; a second rotor to which the ink is supplied from the first rotor; and contact pressure adjustment means for adjusting the contact pressure between the first rotor and the second rotor. The printing quality control method comprises: measuring, by using area measurement means, the area of printed portion printed on a predetermined section of the print member by the relief printing press; and controlling the contact pressure adjustment means on the basis of the area of the printed portion thus measured.

A fourth aspect of the present invention provides a printing quality control method for a relief printing press including: a first rotor to which ink is supplied; a second rotor facing the first rotor, and holding a print member to which the ink is supplied from the first rotor; and printing pressure adjustment means for adjusting the printing pressure between the first rotor and the second rotor. The printing quality control method comprises: measuring, by using area measurement means, the area of printed portion printed on a predetermined section of the print member by the relief printing press; and controlling the printing pressure adjustment means on the basis of the area of the printed portion thus measured.

A fifth aspect of the present invention for achieving the above-described object provides a printing quality control system for a relief printing press including: a first rotor to which ink is supplied; a second rotor to which the ink is supplied from the first rotor; and contact pressure adjustment means for adjusting the contact pressure between the first rotor and the second rotor. The printing quality control system comprises: width measurement means for measuring the width of a line portion printed on a print member by the relief printing press; and control means for controlling the contact pressure adjustment means on the basis of the width of the line portion obtained by the width measurement means.

A sixth aspect of the present invention provides a printing quality control system for a relief printing press including: a first rotor to which ink is supplied; a second rotor facing the first rotor, and holding a print member to which the ink is supplied from the first rotor; and printing pressure adjustment means for adjusting the printing pressure between the first rotor and the second rotor. The printing quality control system comprises: width measurement means for measuring the width of a line portion printed on the print member by the relief printing press; and control means for controlling the printing pressure adjustment means on the basis of the width of the line portion obtained by the width measurement means.

A seventh aspect of the present invention provides a printing quality control system for a relief printing press including: a first rotor to which ink is supplied; a second rotor to which the ink is supplied from the first rotor; and contact pressure adjustment means for adjusting the contact pressure between the first rotor and the second rotor. The printing quality control system comprises: area measurement means for measuring the area of printed portion printed on a predetermined section of the print member by the relief printing press; and control means for controlling the contact pressure adjustment means on the basis of the area of the printed portion obtained by the area measurement means.

An eighth aspect of the present invention provides a printing quality control system for a relief printing press including: a first rotor to which ink is supplied; a second rotor facing the first rotor, and holding a print member to which the ink is supplied from the first rotor; and printing pressure adjustment means for adjusting the printing pressure between the first rotor and the second rotor. The printing quality control system comprises: area measurement means for measuring the area of printed portion printed on a predetermined section of the print member by the relief printing press; and control means for controlling the printing pressure adjustment means on the basis of the area of the printed portion obtained by the area measurement means.

By using the printing quality control method and system for a relief printing press which are configured as described above, the width of the printed line portion or the area of the predetermined section of the printed portion on the print member is measured by the measuring camera, and the contact pressure or the printing pressure between the first rotor and the second rotor is automatically adjusted on the basis of the measurement result. Accordingly, it is possible to reduce the burden of the operator, and also to reduce amount of waste paper to be produced, by preventing errors in manual adjustment.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1(a) is a control block diagram of a control device showing a first embodiment of the present invention;

FIG. 1(b) is a control block diagram of the control device;

FIG. 1(c) is a control block diagram of the control device;

FIG. 2(a) is an operation flowchart of the control device;

FIG. 2(b) is an operation flowchart of the control device;

FIG. 2(c) is an operation flowchart of the control device;

FIG. 2(d) is an operation flowchart of the control device;

FIG. 3(a) is an operation flowchart of the control device;

FIG. 3(b) is an operation flowchart of the control device;

FIG. 3(c) is an operation flowchart of the control device;

FIG. 3(d) is an operation flowchart of the control device;

FIG. 4(a) is an operation flowchart of the control device;

FIG. 4(b) is an operation flowchart of the control device;

FIG. 4(c) is an operation flowchart of the control device;

FIG. 4(d) is an operation flowchart of the control device;

FIG. 5(a) is an operation flowchart of the control device;

FIG. 5(b) is an operation flowchart of the control device;

FIG. 5(c) is an operation flowchart of the control device;

FIG. 5(d) is an operation flowchart of the control device;

FIG. 6(a) is a control block diagram of a control device showing a second embodiment of the present invention;

FIG. 6(b) is a control block diagram of the control device;

FIG. 6(c) is a control block diagram of the control device;

FIG. 7(a) is an operation flowchart of the control device;

FIG. 7(b) is an operation flowchart of the control device;

FIG. 7(c) is an operation flowchart of the control device;

FIG. 7(d) is an operation flowchart of the control device;

FIG. 8(a) is an operation flowchart of the control device;

FIG. 8(b) is an operation flowchart of the control device;

FIG. 8(c) is an operation flowchart of the control device;

FIG. 8(d) is an operation flowchart of the control device;

FIG. 9(a) is an operation flowchart of the control device;

FIG. 9(b) is an operation flowchart of the control device;

FIG. 9(c) is an operation flowchart of the control device;

FIG. 9(d) is an operation flowchart of the control device;

FIG. 10(a) is an operation flowchart of the control device;

FIG. 10(b) is an operation flowchart of the control device;

FIG. 10(c) is an operation flowchart of the control device;

FIG. 10(d) is an operation flowchart of the control device;

FIG. 11(a) is a control block diagram of a control device showing a third embodiment of the present invention;

FIG. 11(b) is a control block diagram of the control device;

FIG. 11(c) is a control block diagram of the control device;

FIG. 12(a) is an operation flowchart of the control device;

FIG. 12(b) is an operation flowchart of the control device;

FIG. 12(c) is an operation flowchart of the control device;

FIG. 12(d) is an operation flowchart of the control device;

FIG. 13(a) is an operation flowchart of the control device;

FIG. 13(b) is an operation flowchart of the control device,

FIG. 13(c) is an operation flowchart of the control device,

FIG. 13(d) is an operation flowchart of the control device;

FIG. 14(a) is an operation flowchart of the control device;

FIG. 14(b) is an operation flowchart of the control device;

FIG. 14(c) is an operation flowchart of the control device;

FIG. 14(d) is an operation flowchart of the control device;

FIG. 15(a) is an operation flowchart of the control device;

FIG. 15(b) is an operation flowchart of the control device;

FIG. 15(c) is an operation flowchart of the control device;

FIG. 15(d) is an operation flowchart of the control device;

FIG. 16 is an explanatory view of a mechanism for adjusting a nip pressure between a plate cylinder and each ink form roller;

FIG. 17 is an explanatory view of a mechanism for adjusting a nip pressure between the plate cylinder and a blanket cylinder;

FIG. 18 is an explanatory view of a mechanism for adjusting a printing pressure between the blanket cylinder and an impression cylinder;

FIG. 19(a) is an explanatory view of image judgment;

FIG. 19(b) is an explanatory view of image judgment; and

FIG. 19(c) is an explanatory view of image judgment.

### DETAILED DESCRIPTION OF THE INVENTION

A printing quality control method and system for a relief printing press according to the present invention will be described below in detail on the basis of embodiments with reference to the drawings.

### First Embodiment

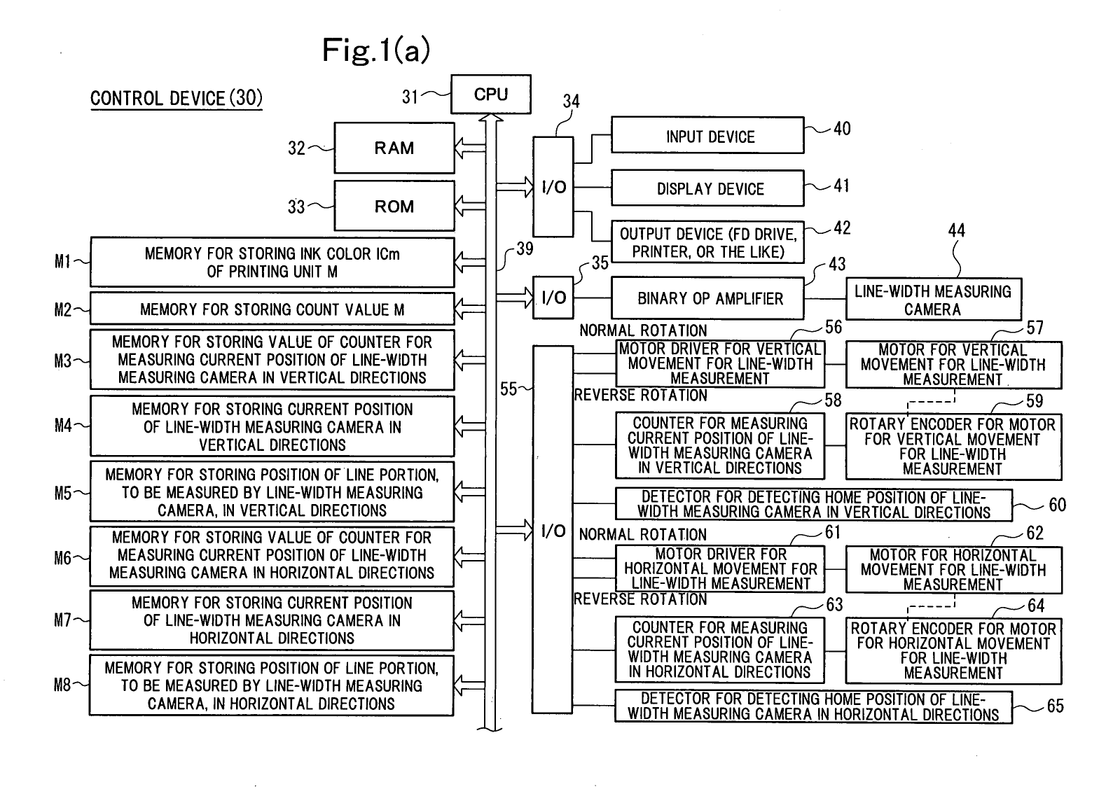

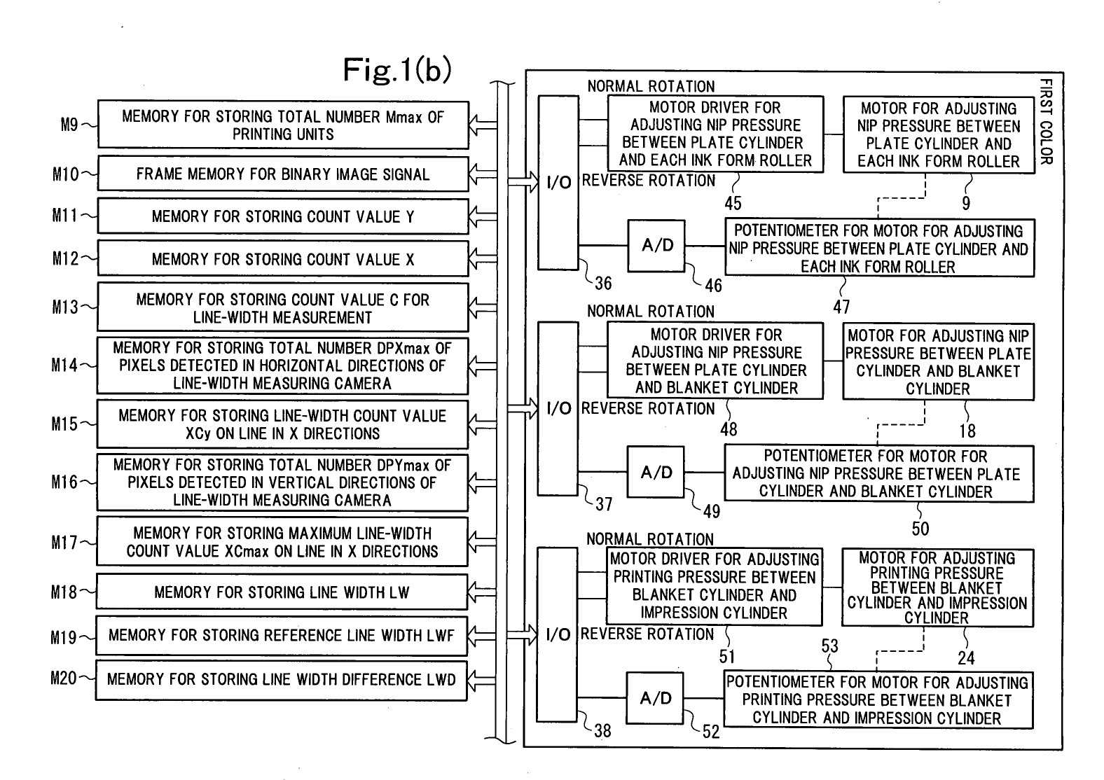

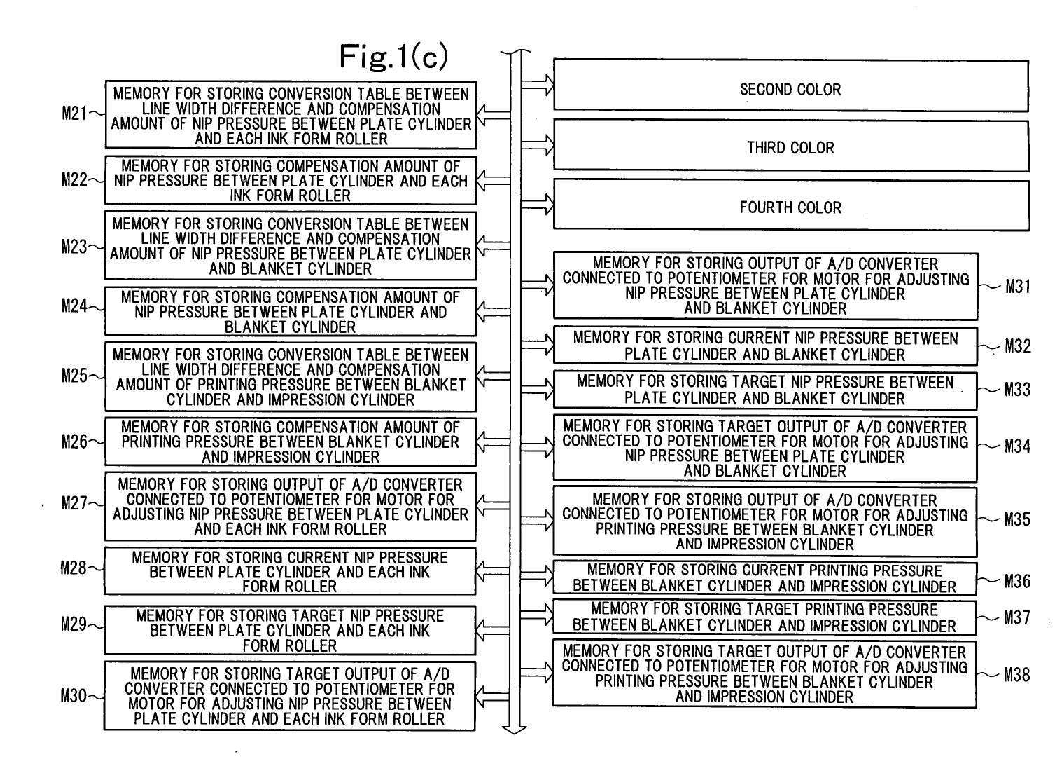

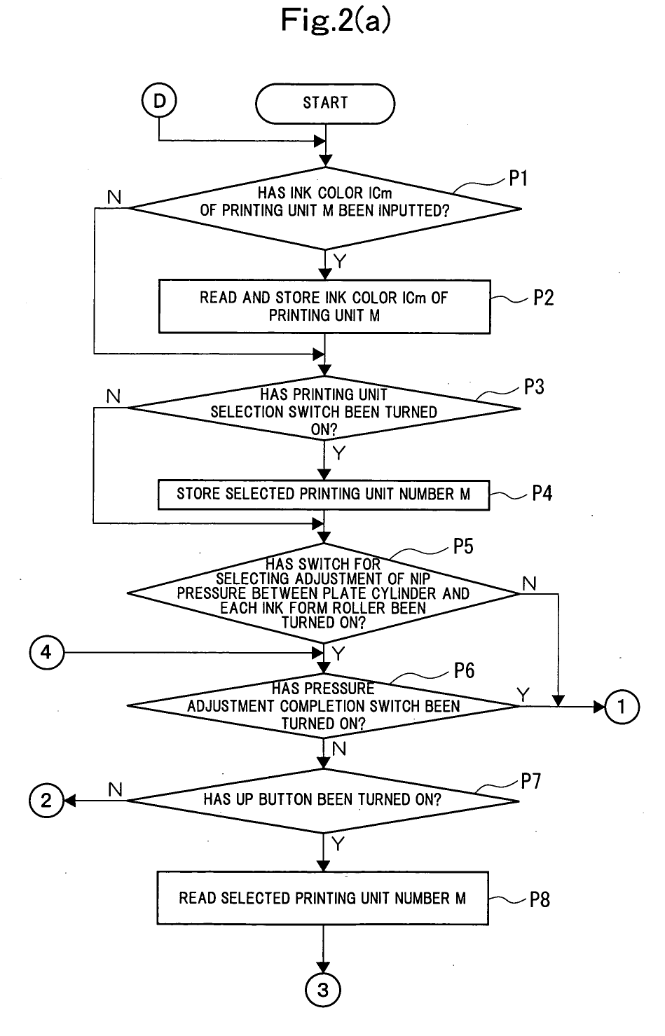

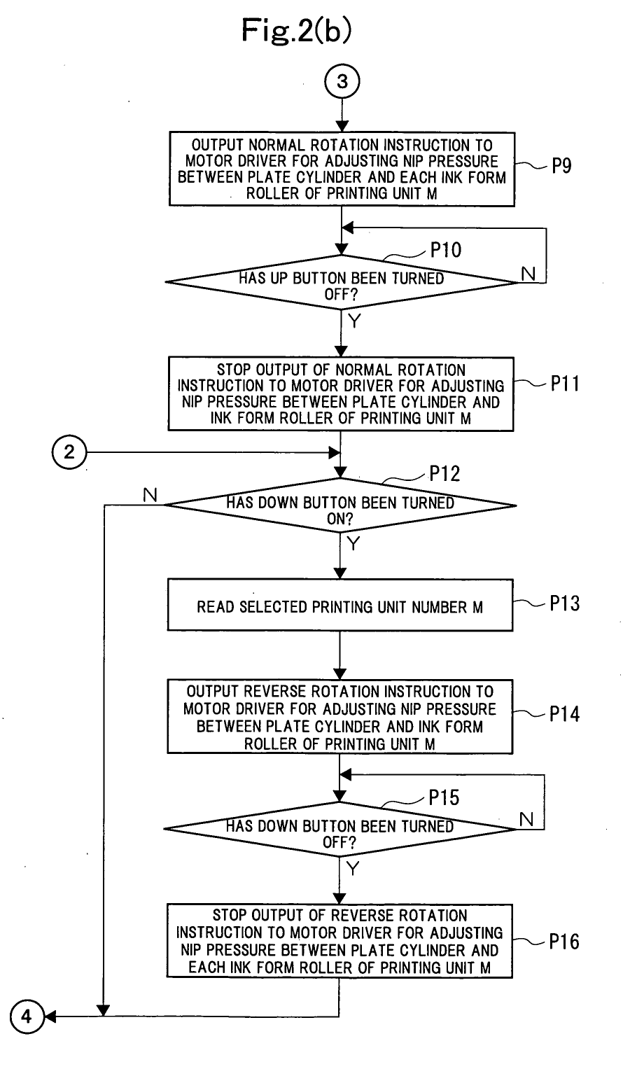

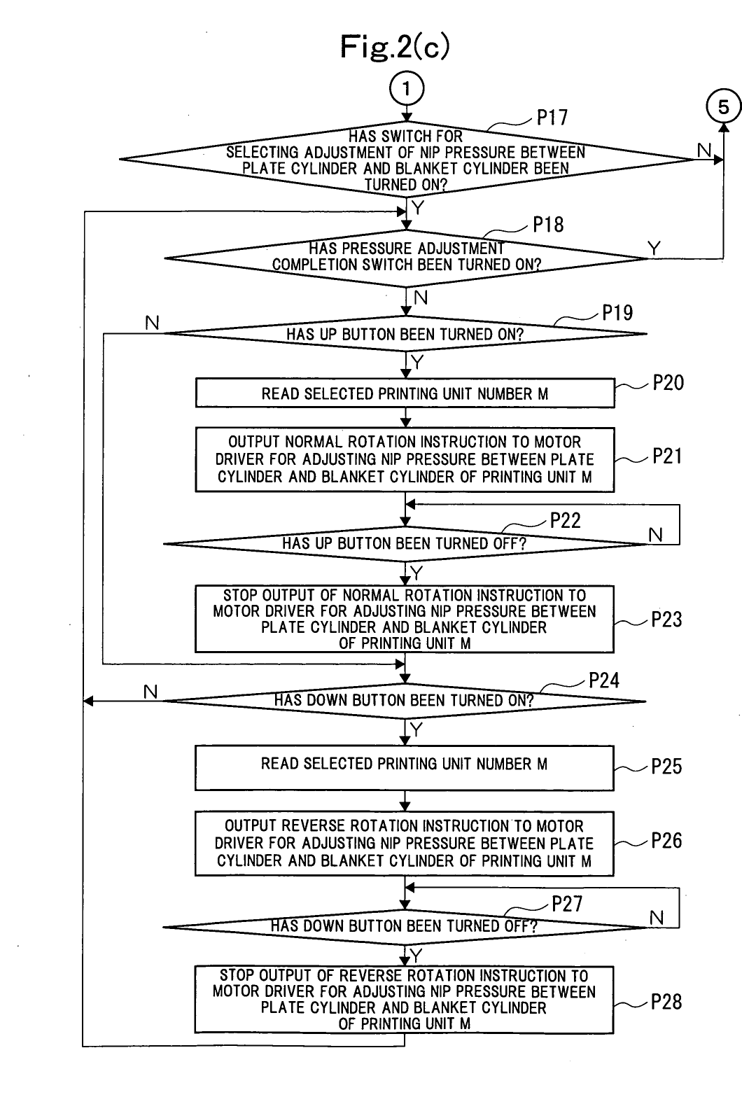

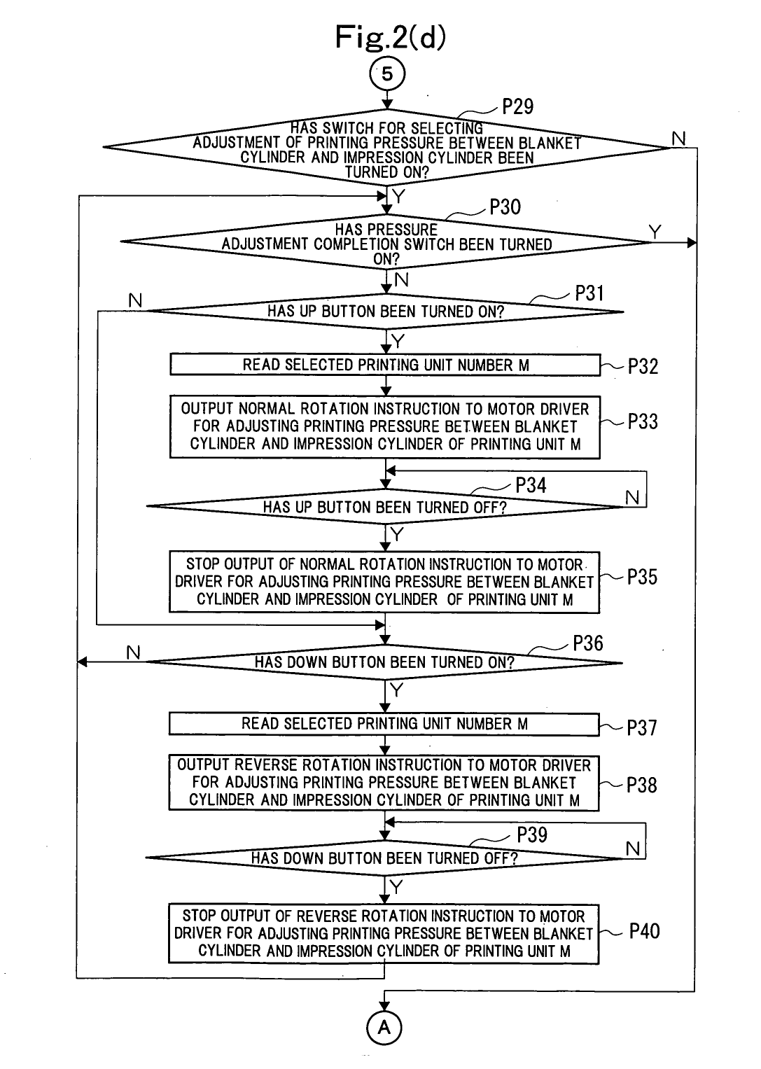

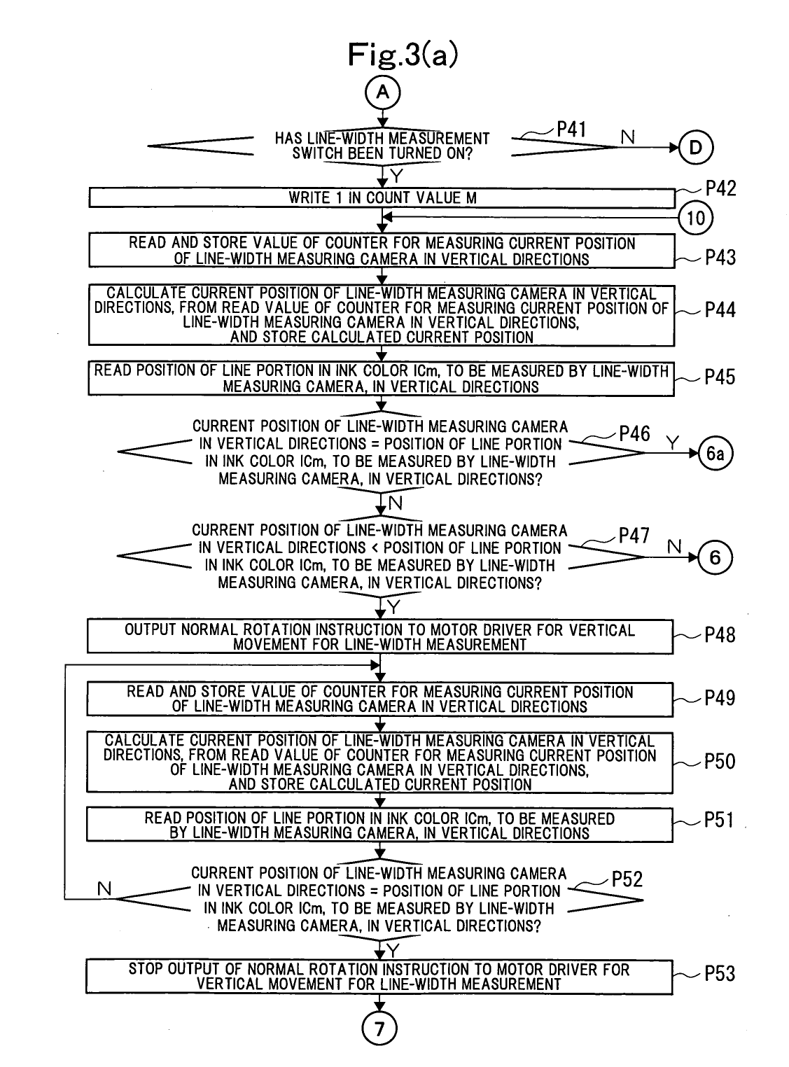

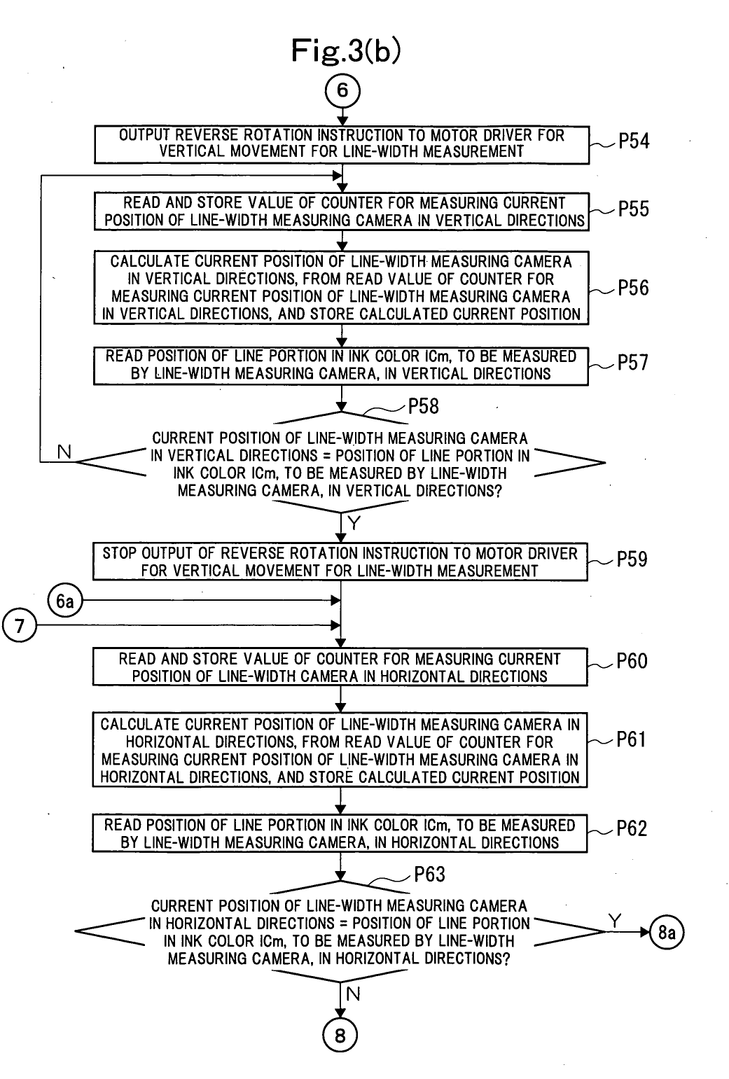

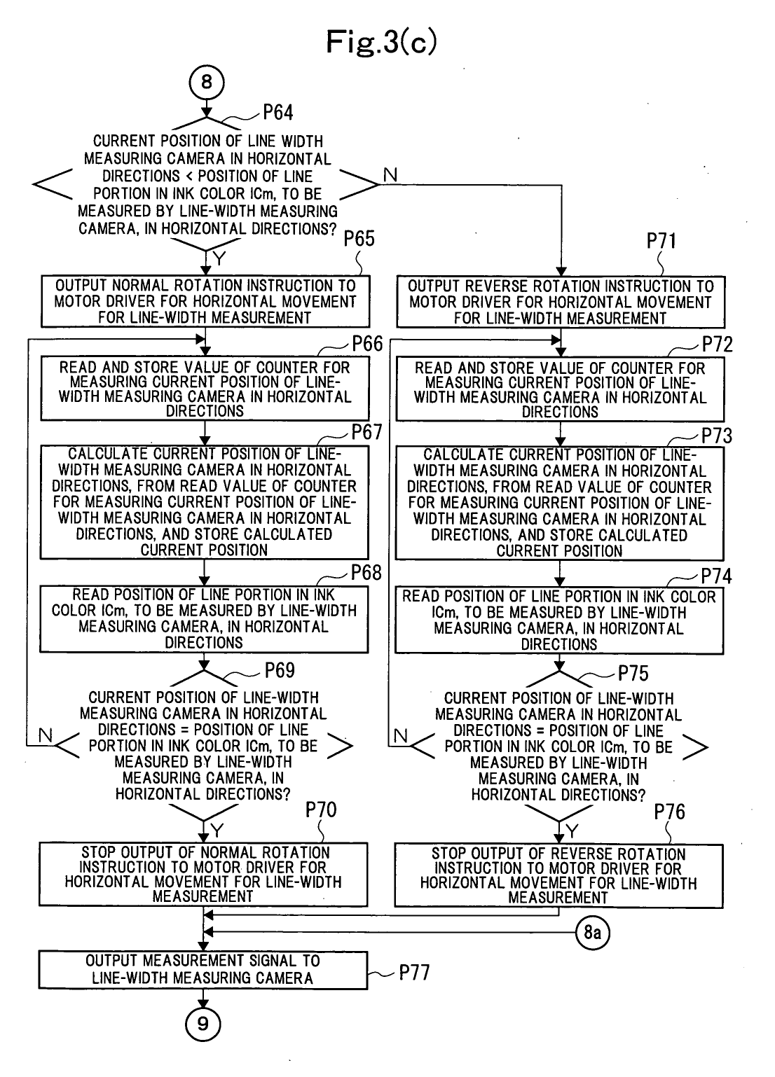

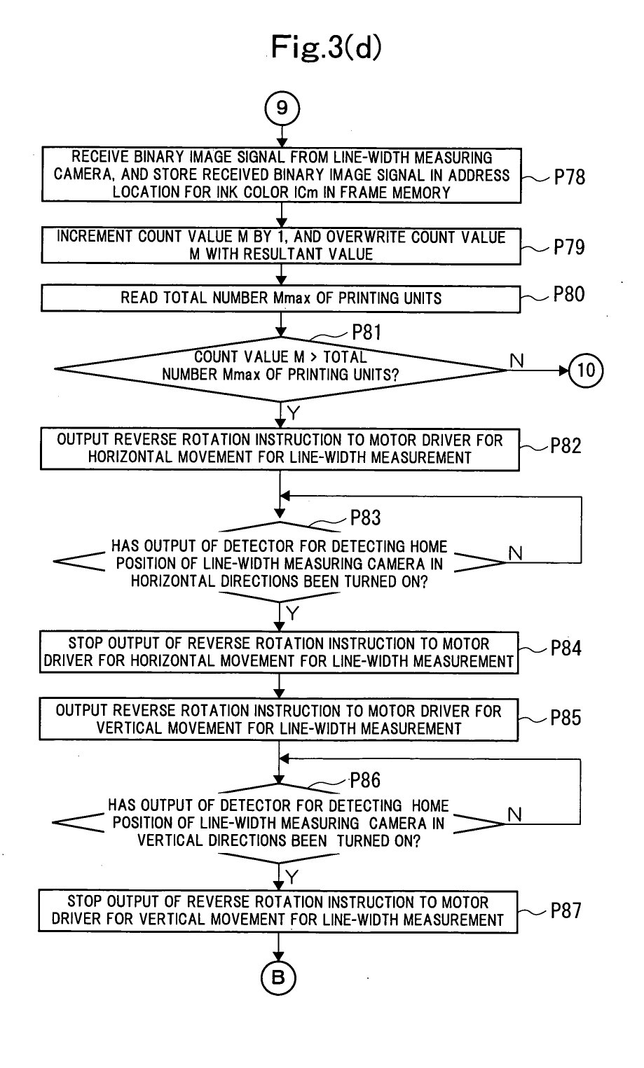

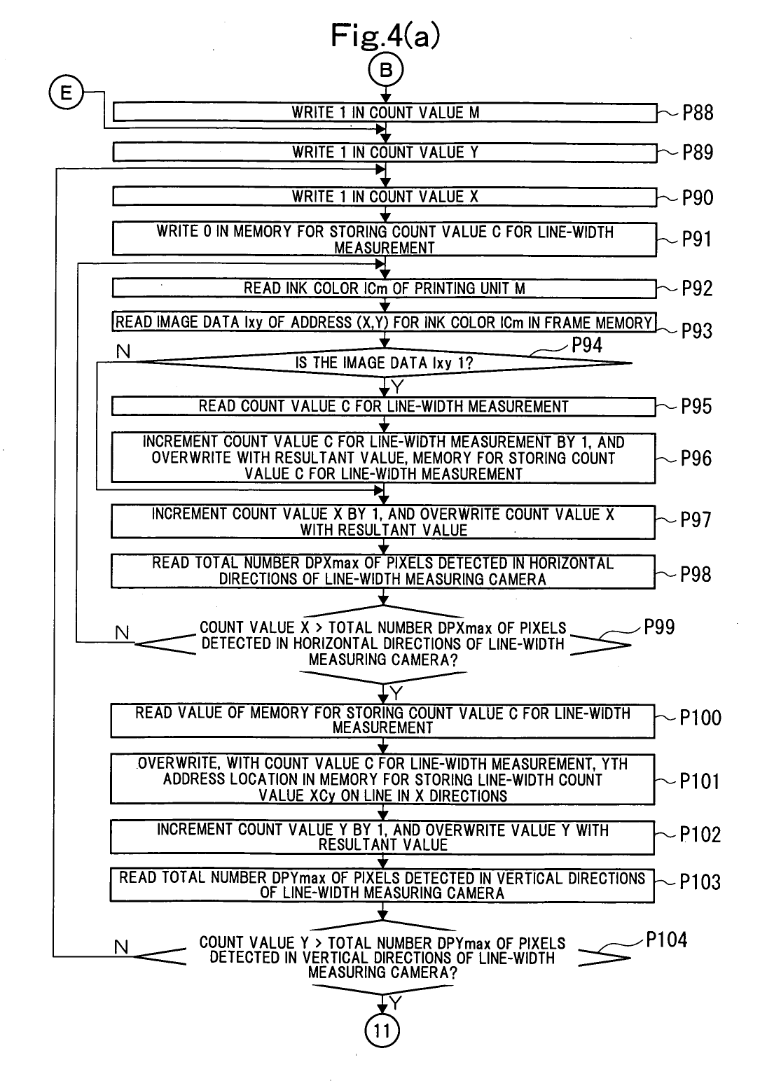

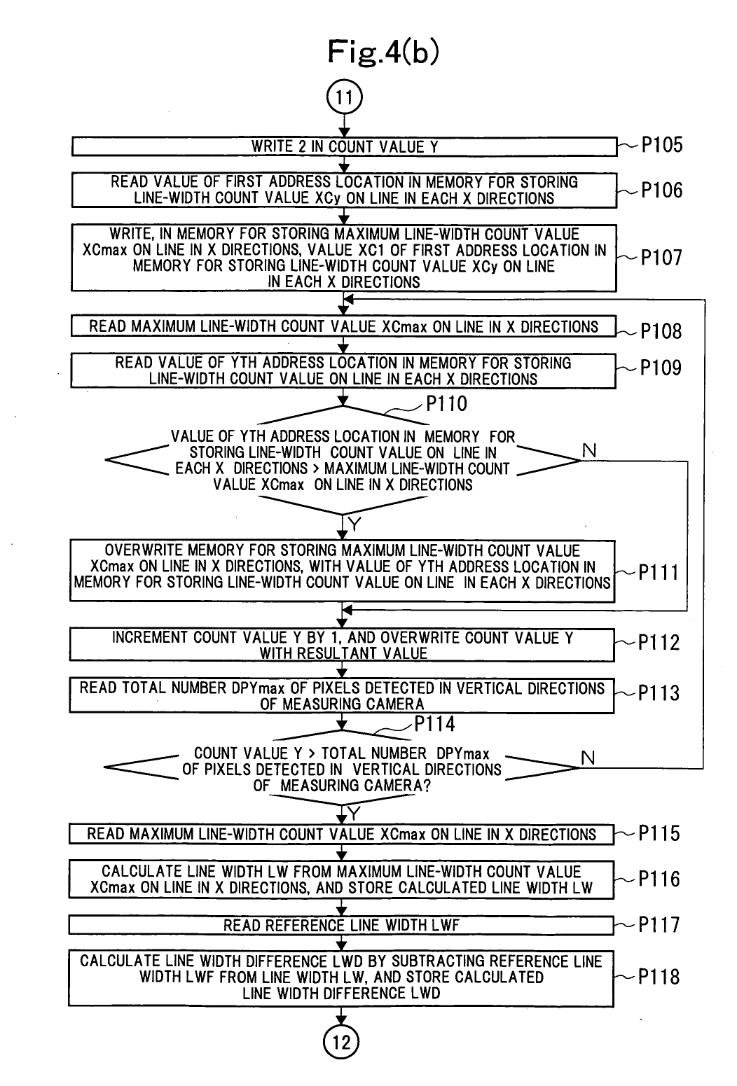

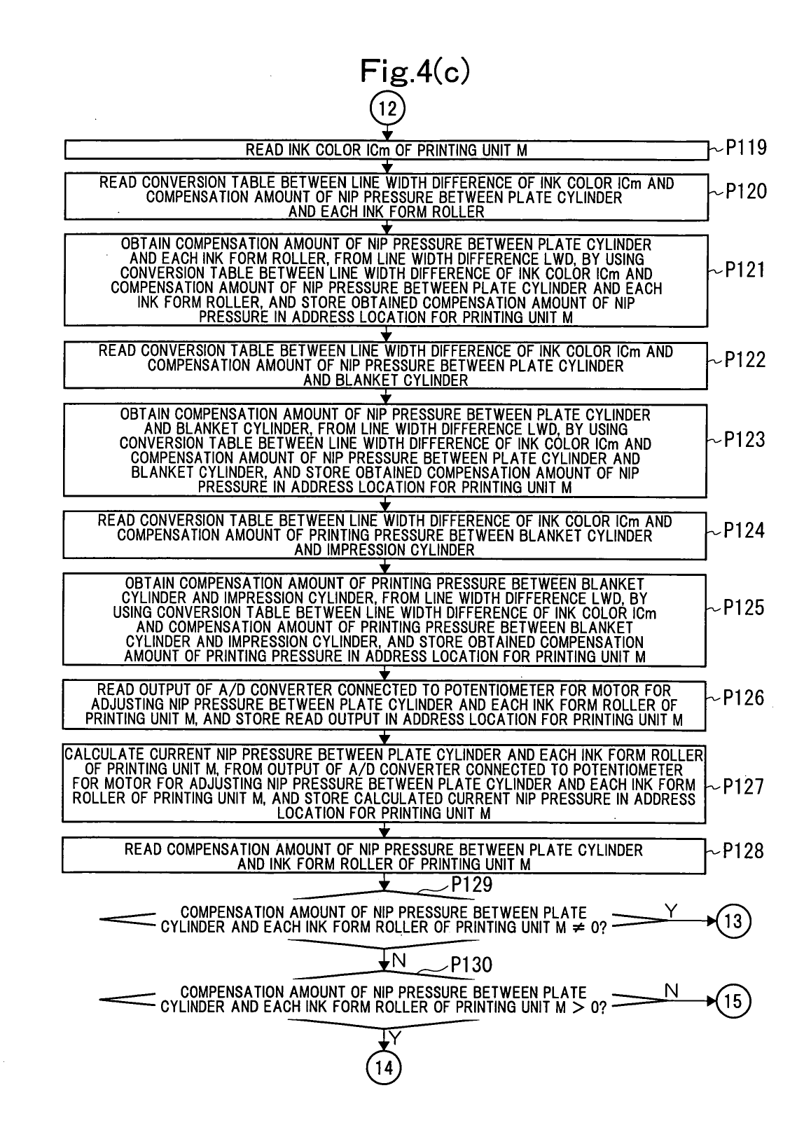

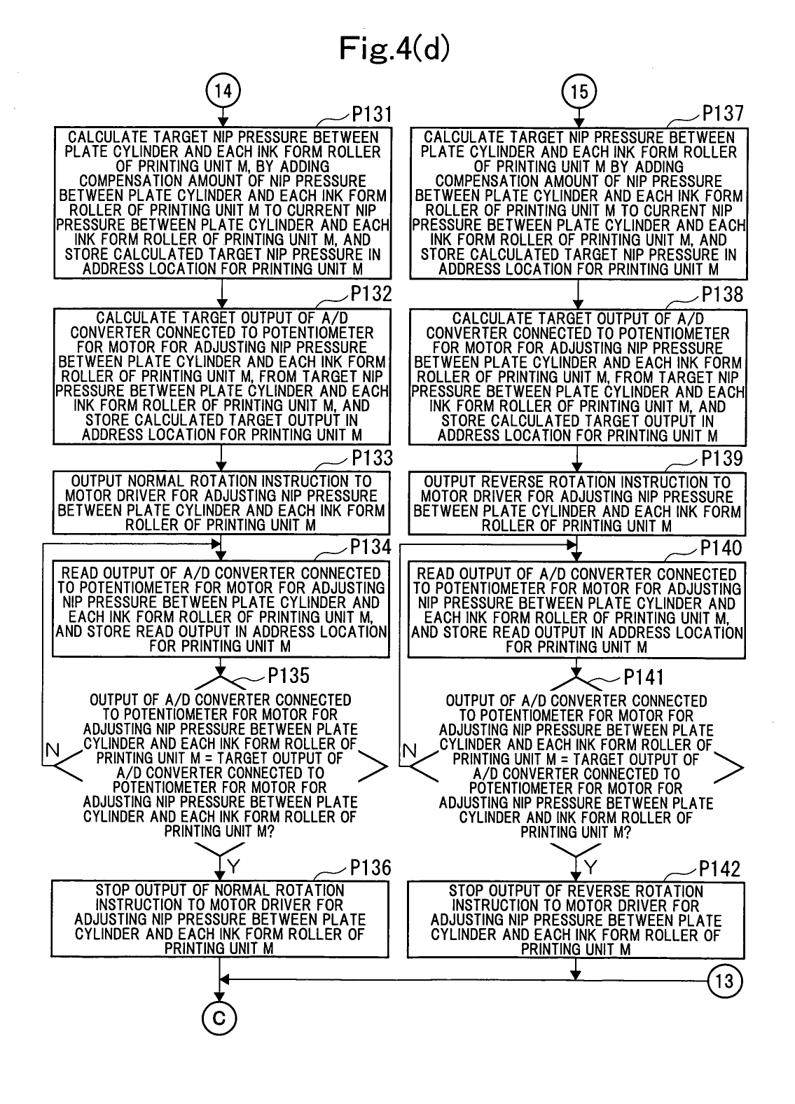

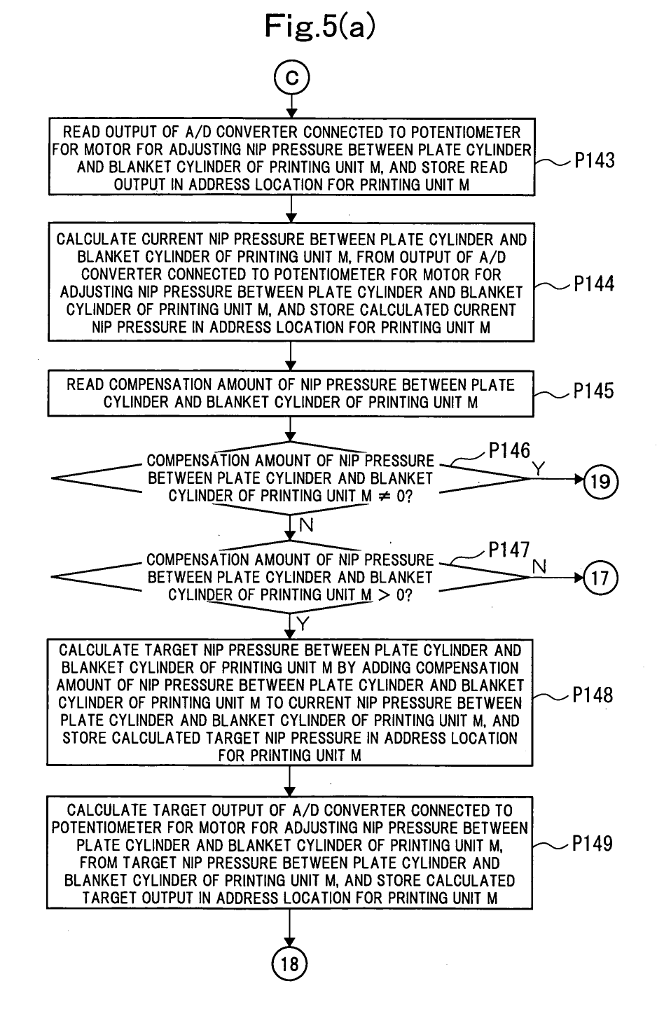

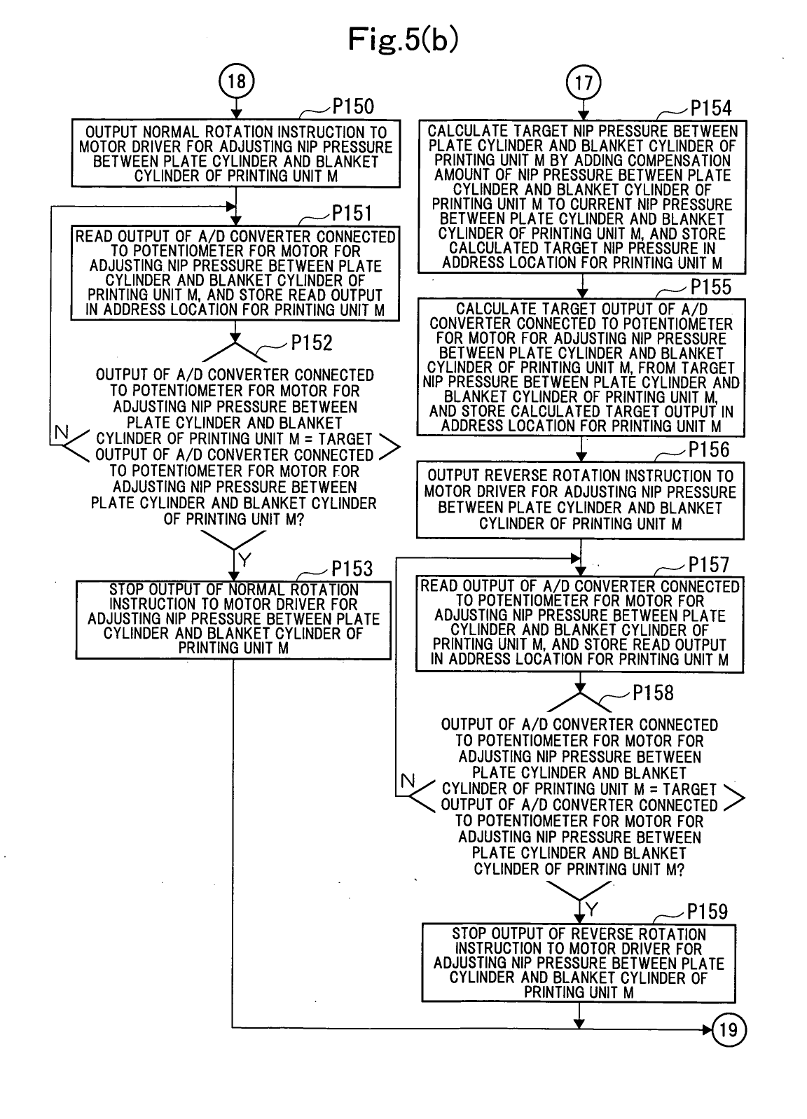

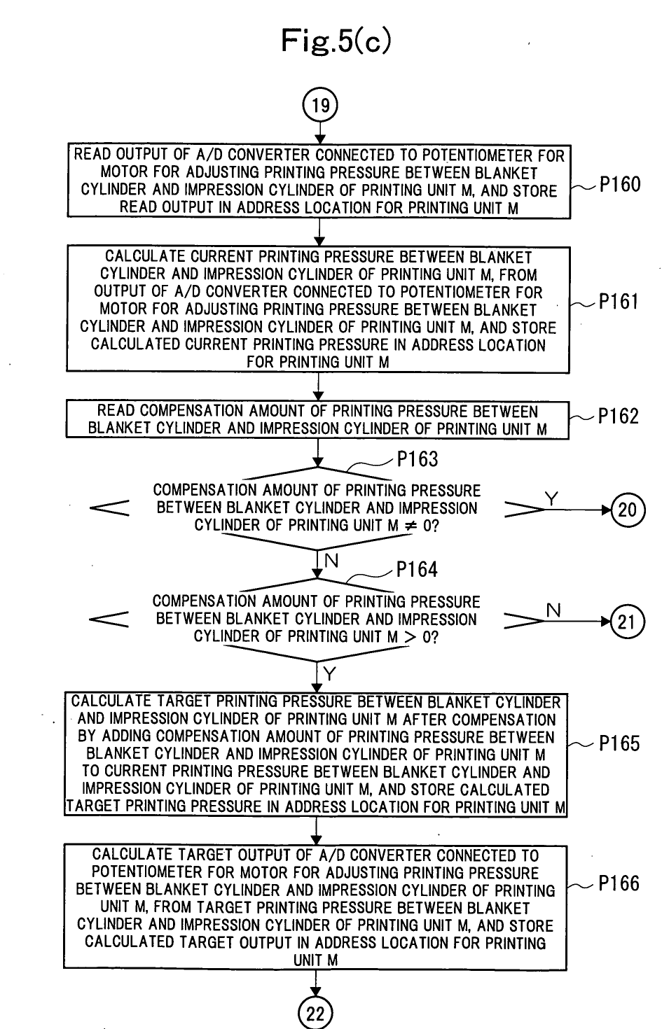

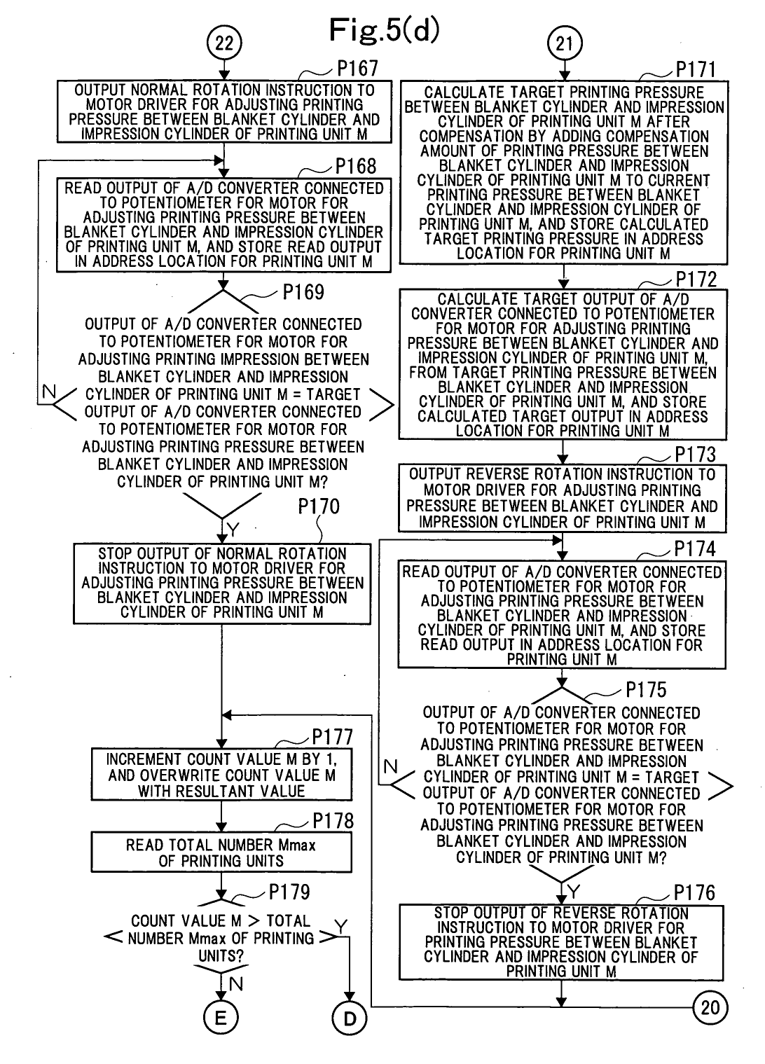

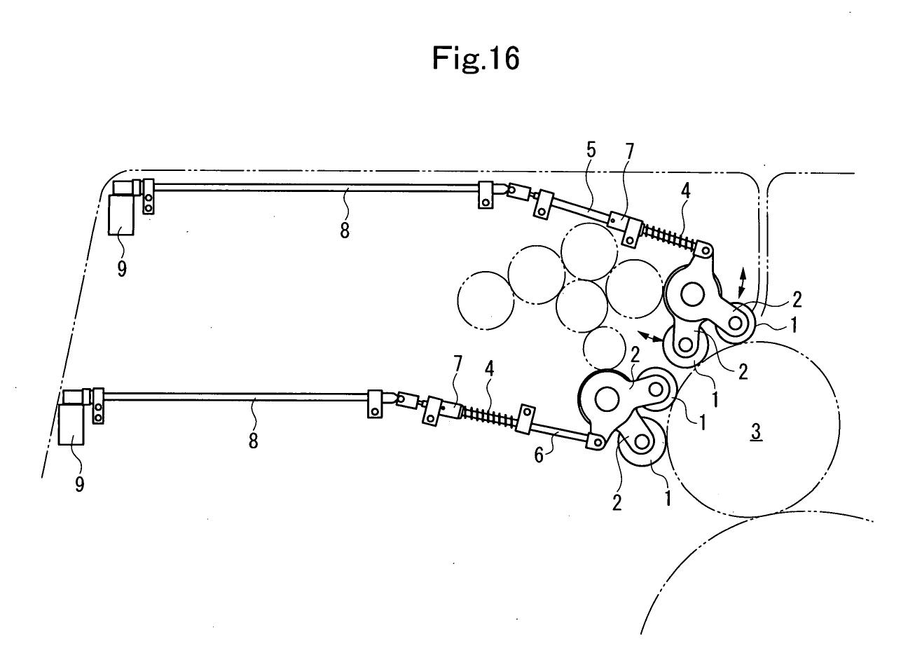

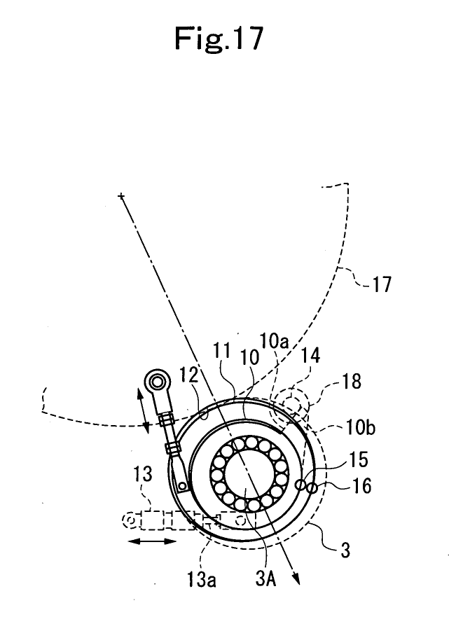

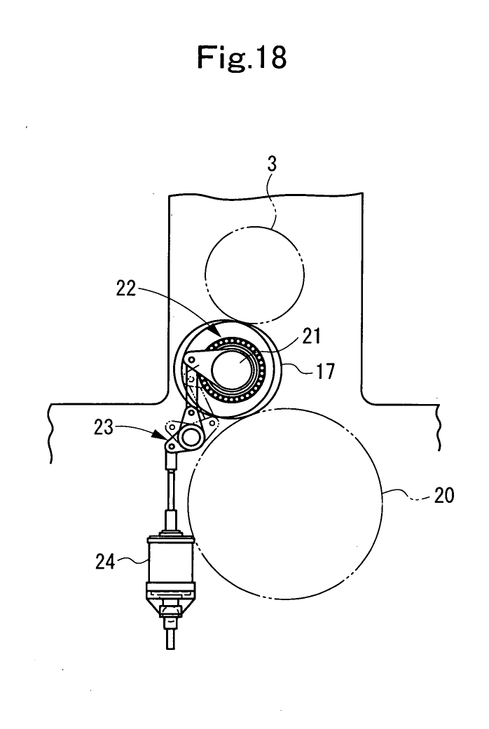

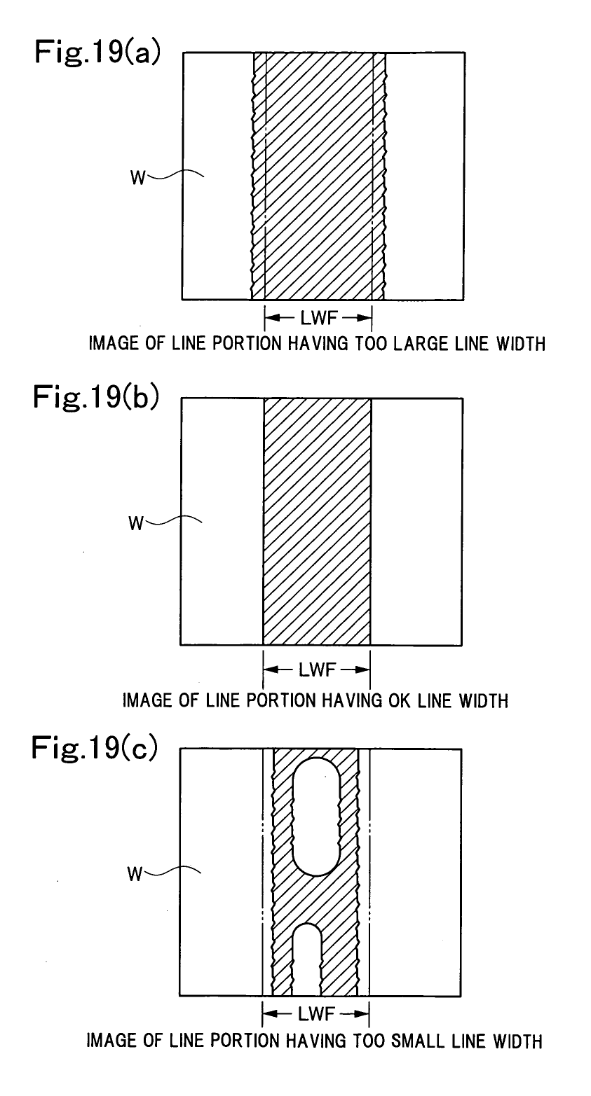

FIGS. 1(a) to 1(c) are control block diagrams of a control device showing a first embodiment of the present invention. FIGS. 2(a) to 2(d), FIGS. 3(a) to 3(d), FIGS. 4(a) to 4(d), and FIGS. 5(a) to 5(d) are operation flowcharts of the control device. FIG. 16 is an explanatory view of a mechanism for adjusting a nip pressure between a plate cylinder and each ink form roller. FIG. 17 is an explanatory view of a mechanism for adjusting a nip pressure between the plate cylinder and a blanket cylinder. FIG. 18 is an explanatory view of a mechanism for adjusting a printing pressure between the blanket cylinder and an impression cylinder. FIGS. 19(a) to 19(c) are explanatory views of image judgment.

Firstly, it is preferable that the mechanism for adjusting the nip pressure between the plate cylinder and each of the ink form rollers have the configuration shown in FIG. 16, for example. The nip pressure adjustment mechanism having the configuration in FIG. 16 includes: swing levers 2, each of which holds, at one end, an ink form roller (a first rotor) 1 so that the ink form roller 1 can be pivotally and rotatably supported; springs 4, which bias the swing levers 2 to push the ink form rollers 1 toward a plating cylinder (a second rotor) 3; lever angle changing means (including a pull rod 5, a push rod 6, nuts 7 and the like) for changing the angles of the swing levers 2 against spring force of the springs 4. In this nip pressure mechanism, one end of each of control rods 8 is connected to the lever angle changing means, and motors 9 are connected to the other ends of the control rods 8, respectively.

With this configuration, the control rods 8 are rotated by means of the motors 9, and, consequently, the swing levers 2 are caused to swing by the lever angle changing means. Thereby, the nip pressure between the plate cylinder 3 and each of the ink form rollers 1 is adjusted (contact pressure adjustment means). It is publicly known, from Japanese Utility Model Application Publication No. H1-171642 and the like, that the control rods 8 are rotated manually.

Next, it is preferable that the mechanism for adjusting the nip pressure between the plate cylinder and the blanket cylinder have the configuration shown in FIG. 17, for example. In this configuration, an end shaft 3A, which is provided at an end of the plate cylinder (a first rotor) 3, is pivotally and rotatably supported with an inner bearing 10 and an outer bearing 11, which are eccentrically provided, in a bearing hole 12. Moreover, a rod 13a of a cylinder 13 is pivotally attached to a flange portion of the inner bearing 10. Accordingly, when the rod 13a is moved forward, the plate cylinder 3 is attached to a blanket cylinder (a second rotor) 17, and when the rod 13a is moved backward, the plate cylinder 3 is detached from the blanket cylinder 17. An engagement projection 10b having an engagement surface 10a is provided on the flange portion of the inner bearing 10 in a protruding manner. Moreover, the frame is provided with a cam-shaped abutment portion 14, which is eccentrically provided, and on which the engagement surface 10a is abutted, and a motor 18 is attached to an unillustrated cam shaft of the abutting portion 14. Accordingly, when the plate cylinder 3 comes in contact with the blanket cylinder 17 by causing the rod 13a to move forward, the engagement surface 10a abuts on the abutment portion 14, and pressing portions 15 and 16 are thereby formed.

With this configuration, the cam shaft of the abutment portion 14 is rotated by means of the motor 18, and the position of the engagement projection 10b of the inner bearing 10 is thereby adjusted, the engagement projection 10b being abutted on the abutment portion 14. Consequently, a nip pressure between the plate cylinder 3 and the blanket cylinder 17 is adjusted (contact pressure adjustment means). It is publicly known, from Japanese Patent Application Publication No. 2002-1904 and the like, that the cam shaft of the abutment portion 14 is manually rotated.

Next, it is preferable that the mechanism for adjusting the printing pressure between the blanket cylinder and the impression cylinder have the configuration shown in FIG. 18, for example. In this configuration, two end shafts 21 of the blanket cylinder (a first rotor) 17, which is disposed between the plate cylinder 3 and an impression cylinder (a second rotor) 20, are pivotally supported by an eccentric bearing 22. The eccentric bearing 22 is driven by means of a motor 24 through a link mechanism 23, and is thereby caused to rotate forward, so that the blanket cylinder 17 can be in an engaged state, or is thereby caused to rotate backward, so that the blanket cylinder 17 can be in a disengaged state.

With this configuration, the eccentric bearing 22 is driven and rotated by means of the single motor 24. Thereby, the gap between the blanket cylinder 17 and the impression cylinder 20 is changed. Consequently, a printing pressure between the blanket cylinder 17 and the impression cylinder 20 is adjusted (printing pressure adjustment means). It is publicly known, from Japanese Utility Model Application Publication No. H6-32030 and the like, that the gap between the blanket cylinder 17 and the impression cylinder 20 is changed so as to accommodate the thickness of paper (a print member) W.

The drive of each of the motors 9, 18 and 24 is controlled by a control device (control means) 30 to be described below.

As shown in FIGS. 1(a) to 1(c), in the control device 30, a CPU 31, a RAM 32, a ROM 33, and input/output (I/O) devices 34 to 38 and 55 are connected through a bus 39. Moreover, memories M1 to M10 are connected to the bus 39. In the memory M1, an ink color ICm of a printing unit M is stored. In the memory M2, a count value M is stored. In the memory M3, a value of a counter for measuring the current position of a line-width measuring camera in the vertical directions is stored. In the memory M4, the current position of the line-width measuring camera in the vertical directions is stored. In the memory M5, the position of a line portion, to be measured by the line-width measuring camera, in the vertical directions is stored. In the memory M6, a value of the counter for measuring the current position of the line-width measuring camera in the horizontal directions is stored. In the memory M7, the current position of the line-width measuring camera in the horizontal directions is stored. In the memory M8, the position of the line portion, to be measured by the line-width measuring camera, in the horizontal directions is stored. In the memory M9, the total number Mmax of printing units is stored. In the frame memory M10, a binary image signal is stored.

Furthermore, memories M11 to M21 are also connected to the bus 39. In the memory M11, a count value Y is stored. In the memory M12, a count value X is stored. In the memory M13, a count value C for line-width measurement is stored. In the memory M14, the total number DPXmax of pixels detected in the horizontal directions of the line-width measuring camera is stored. In the memory M15, a line-width count value XCy of a line in the X directions is stored. In the memory M16, the total number DPYmax of pixels detected in the vertical directions of the line-width measuring camera is stored. In the memory M17, the maximum line-width count value XCmax of the line in the X directions is stored. In the memory M18, a line width LW is stored. In the memory M19, a reference line width LWF is stored. In the memory M20, a line width difference LWD is stored. In the M21, a conversion table between a line width difference and a compensation amount for the nip pressure between the plate cylinder and each of the ink form rollers is stored.

Furthermore, memories M22 to M30 are also connected to the bus 39. In the memory M22, a compensation amount of the nip pressure between the plate cylinder and each of the ink form rollers is stored. In the memory M23, a conversion table between a line width difference and a compensation amount of the nip pressure between the plate cylinder and the blanket cylinder is stored. In the memory M24, a compensation amount of the nip pressure between the plate cylinder and the blanket cylinder is stored. In the memory M25, a conversion table between a line width difference and the compensation amount of the printing pressure between the blanket cylinder and the impression cylinder is stored. In the memory M26, a compensation amount of the printing pressure between the blanket cylinder and the impression cylinder is stored. In the memory M27, an output of an A/D converter connected to a potentiometer for a motor for adjusting the nip pressure between the plate cylinder and each of the ink form rollers is stored. In the memory M28, a current nip pressure between the plate cylinder and the ink form rollers is stored. In the memory M29, a target nip pressure between the plate cylinder and each of the ink form rollers is stored. In the memory M30, a target output of the A/D converter connected to the potentiometer for the motor for adjusting the nip pressure between the plate cylinder and each of the ink form rollers is stored.

Furthermore, memories M31 to M38 are also connected to the bus 39. In the memory M31, an output of an A/D converter connected to a potentiometer for a motor for adjusting the nip pressure between the plate cylinder and the blanket cylinder is stored. In the memory M32, a current nip pressure between the plate cylinder and the blanket cylinder is stored. In the memory M33, a target nip pressure between the plate cylinder and the blanket cylinder is stored. In the memory M34, a target output of the A/D converter connected to the potentiometer for the motor for adjusting the nip pressure between the plate cylinder and the blanket cylinder is stored. In the memory M35, an output of an A/D converter connected to a potentiometer for a motor for adjusting the printing pressure between the blanket cylinder and the impression cylinder is stored. In the memory M36, the current printing pressure between the blanket cylinder and the impression cylinder is stored. In the memory M37, a target printing pressure between the blanket cylinder and the impression cylinder is stored. In the memory M38, a target output of the A/D converter connected to the potentiometer for the motor for adjusting the printing pressure between the blanket cylinder and the impression cylinder is stored.

An input device 40 such as a keyboard, a display device 41 such as a CRT or a display, and an output device 42 such as a printer or a floppy disk (registered trademark) drive are connected to the I/O device 34. A line-width measuring camera (width measurement means) 44 for line-width measurement is connected to the I/O device 35 through a binary OP amplifier 43.

A motor 57 for vertical movement for line-width measurement is connected to the I/O device 55 through a motor driver 56 for vertical movement for line-width measurement. Moreover, a rotary encoder 59 for the motor for vertical movement for line-width measurement is also connected to the I/O device 55 through a counter 58 for measuring the current position of the line-width measuring camera in the vertical directions, the rotary encoder 59 being connected to and driven by the motor 57. Furthermore, a detector 60 for detecting the home position of the line-width measuring camera in the vertical directions is also connected to the I/O device 55.

In addition, a motor 62 for horizontal movement for line-width measurement is also connected to the I/O device 55 through a motor driver 61 for horizontal movement for line-width measurement. Moreover, a rotary encoder 64 for the motor for horizontal movement for line-width measurement is also connected to the I/O device 55 through a counter 63 for measuring the current position of the line-width measuring camera in the horizontal directions, the rotary encoder 64 being connected to and driven by the motor 62. Furthermore, a detector 65 for detecting the home position of the line-width measuring camera in the horizontal directions is also connected to the I/O device 55.

A motor 9 for adjusting the nip pressure between the plate cylinder and each of the ink form rollers is connected to the I/O device 36 through a motor driver 45 for adjusting the nip pressure between the plate cylinder and each of the ink form rollers. Moreover, a potentiometer 47 for the motor for adjusting the nip pressure between the plate cylinder and each of the ink form rollers is also connected to the I/O device 36 through an A/D convertor 46, the potentiometer 47 being connected to and driven by the motor 9.

A motor 18 for adjusting the nip pressure between the plate cylinder and the blanket cylinder is connected to the I/O device 37 through a motor driver 48 for adjusting the nip pressure between the plate cylinder and the blanket cylinder. Moreover, a potentiometer 50 for the motor for adjusting the nip pressure between the plate cylinder and the blanket cylinder is also connected to the I/O device 37 through an A/D converter 49, the potentiometer 50 being connected to and driven by the motor 18.

A motor 24 for adjusting the printing pressure between the blanket cylinder and the impression cylinder is connected to the I/O device 38 through a motor driver 51 for adjusting the printing pressure between the blanket cylinder and the impression cylinder. Moreover, a potentiometer 53 for the motor for adjusting the printing pressure between the blanket cylinder and the impression cylinder is also connected to the I/O device 38 through an A/D converter 52, the potentiometer 53 being connected to and driven by the motor 24.

The I/O devices 36 to 38 are configured as described above in a printing unit of the first color, and are configured in the same way also in printing units of the second to fourth colors. Accordingly, overlapping description is omitted herein.

In the first embodiment, the control device 30 is configured to be capable of automatically adjusting the nip pressure between the plate cylinder 3 and each of the ink form rollers 1, the nip pressure between the plate cylinder 3 and the blanket cylinder 17, and the printing pressure between the blanket cylinder 17 and the impression cylinder 20, on the basis of a measurement result obtained by the line-width measuring camera 44 serving as width measurement means for measuring the maximum width of a line portion printed on the paper W.

The line-width measuring camera 44 is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 19(a) to 19(c), the line-width measuring camera 44 can directly measure the maximum width of the line portion (the region indicated by hatching in each of FIGS. 19(a) to 19(c)) printed on the paper (print member) W placed on the main body of the checking apparatus. In FIGS. 19(a) to 19(c), LWF denotes a reference line width.

The control operation of the control device 30 configured as described above will be described below in detail on the basis of the operation flowcharts shown in FIGS. 2(a) to 2(d), FIGS. 3(a) to 3(d), FIGS. 4(a) to 4(d), and FIGS. 5(a) to 5(d).

In Step P1, it is determined whether or not the ink color ICm of the printing unit M has been inputted. When the determination in Step P1 is YES, in Step P2, the ink color ICm of the printing unit M is read, and is then stored in the memory M1. Thereafter, in Step P3, it is determined whether or not a printing unit selection switch has been turned on. When the determination in Step P1 is NO, the process proceeds directly to Step P3.

When the determination in Step P3 is YES, in Step P4, the selected printing unit number M is stored in the memory M2. Thereafter, in Step P5, it is determined whether or not a switch for selecting the adjustment of the nip pressure between the plate cylinder and each of the ink form rollers has been turned on. When the determination in Step P3 is NO, the process proceeds directly to Step P5.

When the determination in Step P5 is YES, it is determined, in Step P6, whether or not a pressure adjustment completion switch has been turned on. When the determination in Step P6 is YES, the process proceeds to Step P17. Then, in Step P17, it is determined whether or not a switch for selecting the adjustment of the nip pressure between the plate cylinder and the blanket cylinder has been turned on. When the determination in Step P5 is NO, the process proceeds directly to Step P17.

When the determination in Step P6 is NO, it is determined, in Step P7, whether or not an up button has been turned on. When the determination in Step P7 is YES, in Step P8, the selected printing unit number M is read from the memory M2. Thereafter, in Step P9, a normal rotation instruction is outputted to the motor driver 45 for adjusting the nip pressure between the plate cylinder and each of the ink form rollers of the printing unit M.

When the up button is turned off in Step P10, in Step P11, the output of the normal rotation instruction to the motor driver 45 for adjusting the nip pressure between the plate cylinder and each of the ink form rollers of the printing unit M is stopped. Thereafter, in Step P12, it is determined whether or not a down button has been turned on. When the determination in Step P7 is NO, the process proceeds directly to Step P12.

When the determination in Step P12 is YES, in Step P13, the selected printing unit number M is read from the memory M2. Thereafter, in Step P14, a reverse rotation instruction is outputted to the motor driver 45 for adjusting the nip pressure between the plate cylinder and each of the ink form rollers of the printing unit M. When the determination in Step P12 is NO, the process returns to Step P6.

When the down button is turned off in Step P15, in Step P16, the output of the reverse rotation instruction to the motor driver 45 for adjusting the nip pressure between the plate cylinder and each of the ink form rollers of the printing unit M is stopped. Thereafter, the process returns to Step P6.

When the determination in Step P17 is YES, it is determined, in Step P18, whether or not a pressure adjustment completion switch has been turned on. When the determination in Step P18 is YES, the process proceeds to Step P29. Then, in Step P29, it is determined whether or not a switch for selecting the adjustment of the printing pressure between the blanket cylinder and the impression cylinder has been turned on. When the determination in Step P17 is NO, the process proceeds directly to Step P29.

When the determination in Step P18 is NO, it is determined, in Step P19, whether or not an up button has been turned on. When the determination in Step P19 is YES, in Step P20, the selected printing unit number M is read from the memory M2. Thereafter, in Step P21, a normal rotation instruction is outputted to the motor driver 48 for adjusting the nip pressure between the plate cylinder and blanket cylinder of the printing unit M.

When the up button is turned off in Step P22, in Step P23, the output of the normal rotation instruction to the motor driver 48 for adjusting the nip pressure between the plate cylinder and the blanket cylinder of the printing unit M is stopped. Thereafter, in Step P24, it is determined whether or not a down button has been turned on. When the determination in Step P19 is NO, the process proceeds directly to Step P24.

When the determination in Step P24 is YES, in Step P25, the selected printing unit number M is read from the memory M2. Thereafter, in Step P26, a reverse rotation instruction is outputted to the motor driver 48 for adjusting the nip pressure between the plate cylinder and the blanket cylinder of the printing unit M. When the determination in Step P24 is NO, the process returns to Step P18.

When the down button is turned off in Step P27, in Step P28, the output of the reverse rotation instruction to the motor driver 48 for adjusting the nip pressure between the plate cylinder and the blanket cylinder of the printing unit M is stopped. Thereafter, the process returns to Step P18.

When the determination in Step P29 is YES, it is determined, in Step P30, whether or not a pressure adjustment completion switch has been turned on. When the determination in Step P30 is YES, the process proceeds to Step P41. Then, in Step P41, it is determined whether or not a line-width measurement switch has been turned on. When the determination in Step P29 is NO, the process proceeds directly to Step P41.

When the determination in Step P30 is NO, it is determined, in Step P31, whether or not an up button has been turned on. When the determination in Step P31 is YES, in Step P32, the selected printing unit number M is read from the memory M2. Thereafter, in Step P33, a normal rotation instruction is outputted to the motor driver 51 for adjusting the printing pressure between the blanket cylinder and the impression cylinder of the printing unit M.

When the up button is turned off in Step P34, in Step P35, the output of the normal rotation instruction to the motor driver 51 for adjusting the printing pressure between the blanket cylinder and the impression cylinder of the printing unit M is stopped. Thereafter, in Step P36, it is determined whether or not a down button has been turned on. When the determination in Step P31 is NO, the process proceeds directly to Step P36.

When the determination in Step P36 is YES, in Step P37, the selected printing unit number M is read from the memory M2. Thereafter, in Step P38, a reverse rotation instruction is outputted to the motor driver 51 for adjusting the printing pressure between the blanket cylinder and the impression cylinder of the printing unit M. When the determination in Step P36 is NO, the process returns to Step P30.

When the down button is turned off in Step P39, in Step P40, the output of the reverse rotation instruction to the motor driver 51 for adjusting the printing pressure between the blanket cylinder and the impression cylinder of the printing unit M is stopped. Thereafter, the process returns to Step P30.

In Step P41, it is determined whether or not a line-width measurement switch has been turned on. When the determination in Step P41 is YES, 1 is written in the count value M in Step P42. On the other hand, when the determination in Step P41 is NO, the process returns to Step P1.

In Step P43, the value of the counter for measuring the current position of the line-width measuring camera in the vertical directions is read, and is then stored in the memory M3. Thereafter, in Step P44, the current position of the line-width measuring camera 44 in the vertical directions is calculated from the read value of the counter for measuring the current position of the line-width measuring camera in the vertical directions, and is then stored in the memory M4.

In Step P45, the position of the line portion in the ink color ICm, to be measured by the line-width measuring camera, in the vertical directions is read from the memory M5. Thereafter, in Step P46, it is determined whether or not the current position of the line-width measuring camera 44 in the vertical directions is equal to the position of the line portion in the ink color ICm, to be measured by the line-width measuring camera, in the vertical directions. When the determination in Step P46 is YES, the process proceeds to Step P60. On the other hand, when the determination in Step P46 is NO, it is determined, in Step P47, whether or not the current position of the line-width measuring camera 44 in the vertical directions is lower than the position of the line portion in the ink color ICm, to be measured by the line-width measuring camera, in the vertical directions.

When the determination in Step P47 is YES, in Step P48, a normal rotation instruction is outputted to the motor driver for vertical movement for line-width measurement. Thereafter, in Step P49, the value of the counter for measuring the current position of the line-width measuring camera in the vertical directions is read, and is then stored in the memory M3.

In Step P50, the current position of the line-width measuring camera 44 in the vertical directions is calculated from the read value of the counter for measuring the current position of the line-width measuring camera in the vertical directions, and is then stored in the memory M4. Thereafter, in Step P51, the position of the line portion in the ink color ICm, to be measured by the line-width measuring camera, in the vertical directions is read from the memory M5.

In Step P52, it is determined whether or not the current position of the line-width measuring camera 44 in the vertical directions is equal to the position of the line portion in the ink color ICm, to be measured by the line-width measuring camera, in the vertical directions. When the determination in Step P52 is YES, in Step P53, the output of the normal rotation instruction to the motor driver for vertical movement for line-width measurement is stopped. Thereafter, the process proceeds to Step P60. On the other hand, when the determination in Step P52 is NO, the process returns to Step P49.

When the determination in Step P47 is NO, in Step P54, a reverse rotation instruction is outputted to the motor driver for vertical movement for line-width measurement. Thereafter, in Step P55, the value of the counter for measuring the current position of the line-width measuring camera in the vertical directions is read, and is then stored in the memory M3.

In Step P56, the current position of the line-width measuring camera 44 in the vertical directions is calculated from the read value of the counter for measuring the current position of the line-width measuring camera in the vertical directions, and is then stored in the memory M4. Thereafter, in Step P57, the position of the line portion in the ink color ICm, to be measured by the line-width measuring camera, in the vertical directions is read from the memory M5.

In Step P58, it is determined whether or not the current position of the line-width measuring camera 44 in the vertical directions is equal to the position of the line portion in the ink color ICm, to be measured by the line-width measuring camera, in the vertical directions. When the determination in Step P58 is YES, in Step P59, the output of the reverse rotation instruction to the motor driver for vertical movement for line-width measurement is stopped. Thereafter, the process proceeds to Step P60. On the other hand, when the determination in Step P58 is NO, the process returns to Step P55.

In Step P60, the value of the counter for measuring the current position of the line-width measuring camera in the horizontal directions is read, and is then stored in the memory M6. Thereafter, in Step P61, the current position of the line-width measuring camera 44 in the horizontal directions is calculated from the read value of the counter for measuring the current position of the line-width measuring camera in the horizontal directions, and is then stored in the memory M7.

In Step P62, the position of the line portion in the ink color ICm, to be measured by the line-width measuring camera, in the horizontal directions is read from the memory M8. Thereafter, in Step P63, it is determined whether or not the current position of the line-width measuring camera 44 in the horizontal directions is equal to the position of the line portion in the ink color ICm, to be measured by the line-width measuring camera, in the horizontal directions. When the determination in Step P63 is YES, the process proceeds to Step P77. On the other hand, when the determination in Step P63 is NO, it is determined, in Step P64, whether or not the current position of the line-width measuring camera 44 in the horizontal directions is smaller than the position of the line portion in the ink color ICm, to be measured by the line-width measuring camera, in the horizontal directions.

When the determination in Step P64 is YES, in Step P65 a normal rotation instruction is outputted to the motor driver for horizontal movement for line-width measurement. Thereafter, in Step P66, the value of the counter for measuring the current position of the line-width measuring camera in the horizontal directions is read, and is then stored in the memory M6.

In Step P67, the current position of the line-width measuring camera 44 in the horizontal directions is calculated from the read value of the counter for measuring the current position of the line-width measuring camera in the horizontal directions, and is then stored in the memory M7. Thereafter, in Step P68, the position of the line portion in the ink color ICm, to be measured by the line-width measuring camera, in the horizontal directions is read from the memory M8.

In Step P69, it is determined whether or not the current position of the line-width measuring camera 44 in the horizontal directions is equal to the position of the line portion in the ink color ICm, to be measured by the line-width measuring camera, in the horizontal directions. When the determination in Step P69 is YES, in Step P70, the output of the normal rotation instruction to the motor driver for horizontal movement for line-width measurement is stopped. Thereafter, the process proceeds to Step P77. On the other hand, when the determination in Step P69 is NO, the process returns to Step P66.

When the determination in Step P64 is NO, in Step P71, a reverse rotation instruction is outputted to the motor driver for horizontal movement for line-width measurement. Thereafter, in Step P72, the value of the counter for measuring the current position of the line-width measuring camera in the horizontal directions is read, and is then stored in the memory M6.

In Step P73, the current position of the line-width measuring camera 44 in the horizontal directions is calculated from the read value of the counter for measuring the current position of the line-width measuring camera in the horizontal directions, and is then stored in the memory M7. Thereafter, in Step P74, the position of the line portion in the ink color ICm, to be measured by the line-width measuring camera, in the horizontal directions is read from the memory M8.

In Step P75, it is determined whether or not the current position of the line-width measuring camera 44 in the horizontal directions is equal to the position of the line portion in the ink color ICm, to be measured by the line-width measuring camera, in the horizontal directions. When the determination in Step P75 is YES, in Step P76, the output of the reverse rotation instruction to the motor driver for horizontal movement for line-width measurement is stopped. Thereafter, the process proceeds to Step P77. On the other hand, when the determination in Step P75 is NO, the process returns to Step P72.

In Step P77, a measurement signal is outputted to the line-width measuring camera 44. Thereafter, in Step P78, a binary image signal is received from the line-width measuring camera 44, and is then stored in the address location for the ink color ICm, in the frame memory M10.

In Step P79, the count value M is incremented by 1, and is then overwritten with the resultant value, in the memory M2. Thereafter, in Step P80, the total number Mmax of the printing units is read from the memory M9. Then, in Step P81, it is determined whether or not the count value M is larger than the total number Mmax of the printing units.

When the determination in Step P81 is YES, in Step P82, a reverse rotation instruction is outputted to the motor driver for horizontal movement for line-width measurement. On the other hand, when the determination in Step P81 is NO, the process returns to Step P43.

When an output of the detector for detecting the home position of the line-width measuring camera 44 in the horizontal directions is turned on in Step P83, in Step P84, the output of the reverse rotation instruction to the motor driver for horizontal movement for line-width measurement is stopped. Thereafter, in Step P85, a reverse rotation instruction is outputted to the motor driver for vertical movement for line-width measurement.

When an output of the detector for detecting the home position of the line-width measuring camera 44 in the vertical directions is turned on in Step P86, the output of the reverse rotation instruction to the motor driver for vertical movement for line-width measurement is stopped in Step P87.

Through the above-described steps, the binary image signal of the line portion of each ink color ICm is received from the line-width measuring camera 44.

Next, in Step P88, 1 is written in the count value M. In Step P89, 1 is written in the count value Y. In Step P90, 1 is written in the count value X. Thereafter, in Step P91, 0 is written in the memory M13 for storing a count value C for line-width measurement.

In Step P92, the ink color ICm of the printing unit M is read. Then, in Step P93, an image data Ixy of the address (X,Y) for the ink color ICm is read from the frame memory M10. Thereafter, in Step P94, it is determined whether or not the image data Ixy is 1.

When the determination in Step P94 is YES, in Step P95, the count value C for line-width measurement is read. On the other hand, when the determination in Step P94 is NO, the process proceeds to Step P97. In Step P96, the count value C for line-width measurement is incremented by 1, and is then overwritten with the resultant value, in the memory M13 for storing the count value C for line-width measurement. Thereafter, in Step P97, the count value X is incremented by 1, and is then overwritten with the resultant value, in the memory M12.

In Step P98, the total number DPXmax of the pixels detected in the horizontal directions of the line-width measuring camera is read from the memory M14. Thereafter, in Step P99, it is determined whether or not the count value X is larger than the total number DPXmax of the pixels detected in the horizontal directions of the line-width measuring camera. When the determination in Step 99 is YES, in Step P100, the value is read from the memory M13 for storing the count value C for line-width measurement. On the other hand, when the determination in Step 99 is NO, the process returns to Step P92.

In Step P101, the Yth address location in the memory M15 for storing the line-width count value XCy of the line in the X directions is overwritten with the count value C for line-width measurement. Thereafter, in Step P102, the count value Y is incremented by 1, and is then overwritten with the resultant value, in the memory M11.

In Step P103, the total number DPYmax of the pixels detected in the vertical directions of the line-width measuring camera is read from the memory M16. Thereafter, in Step P104, it is determined whether or not the count value Y is larger than the total number DPYmax of the pixels detected in the vertical directions of the line-width measuring camera. When the determination in Step P104 is YES, in Step P105, 2 is written in the count value Y. On the other hand, when the determination in Step P104 is NO, the process returns to Step P90.

Through the above-described steps, the pixel numbers corresponding to the widths of the lines in the horizontal directions (X directions) are obtained, the lines being lined in the vertical directions (Y directions).

In Step P106, the value of the first address location in the memory M15 for storing the line-width count value XCy of the line in each X directions is read. Thereafter, in Step P107, the value XC1 of the first address location in the memory M15 for storing the line-width count value XCy of the line in each X directions is written in the memory M17 for storing the maximum line-width count value XCmax of the line in the X directions.

In Step P108, the max line-width count value XCmax of the line in the X directions is read. In Step P109, the value of the Yth address location in the memory M15 for storing the line-width count value of the line in each X directions is read. Thereafter, in Step P110, it is determined whether or not the value of the Yth address location in the memory for storing the line-width count value of the line in the X directions is larger than the maximum line-width count value XCmax of the line in the X directions.

When the determination in Step P110 is YES, in Step P111, the memory M17 for storing the maximum line-width count value XCmax of the line in each X directions is overwritten with the value of the Yth address location, in the memory M15 for storing the line-width count value of the line in the X directions. Then, in Step P112, the count value Y is incremented by 1, and is then overwritten with the resultant value, in the memory M11. On the other hand, when the determination in Step P110 is NO, the process proceeds directly to Step P112.

In Step P113, the total number DPYmax of the pixels detected in the vertical directions of the measuring camera is read from the memory M16. Thereafter, in Step P114, it is determined whether or not the count value Y is larger than the total number DPYmax of the pixels detected in the vertical directions of the measuring camera. When the determination in Step P114 is YES, in Step P115 the maximum line-width count value XCmax of the line in the X directions is read from the memory M17. On the other hand, when the determination in Step P114 is NO, the process returns to Step P108.

Through the above-described steps, the number of pixels corresponding to the maximum line width of the line in the horizontal directions (X directions) is obtained.

In Step P116, the line width LW is calculated from the maximum line-width count value XCmax of the line in the X directions, and is then stored in the memory M18. Thereafter, in Step P117, the reference line width LWF is read from the memory M19. Then, in Step P118, the line width difference LWD is calculated by subtracting the reference line width LWF from the line width LW, and is then stored in the memory M20.

In Step P119, the ink color ICm of the printing unit M is read from the memory M1. In Step P120, the conversion table between the line-width difference of the ink color ICm and a compensation amount of the nip pressure between the plate cylinder and each of the ink form rollers is read from the memory M21. Thereafter, in Step P121, the compensation amount of the nip pressure between the plate cylinder and each of the ink form rollers is obtained from the line width difference LWD by using the conversion table between the line-width difference of the ink color ICm and a compensation amount of the nip pressure between the plate cylinder and each of the ink form rollers, and is then stored in the address location for the printing unit M in the memory M22.

In Step P122, the conversion table between the line width difference of the ink color ICm and a compensation amount of the nip pressure between the plate cylinder and the blanket cylinder is read from the memory M23. Thereafter, in Step P123, the compensation amount of the nip pressure between the plate cylinder and the blanket cylinder is obtained from the line width difference LWD by using the conversion table between the line width difference of the ink color ICm and a compensation amount of the nip pressure between the plate cylinder and the blanket cylinder, and is then stored in the address location for the printing unit M in the memory M24.

In Step P124, the conversion table between the line width difference of the ink color ICm and a compensation amount of the printing pressure between the blanket cylinder and the impression cylinder is read from the memory M25. Thereafter, in Step P125, the compensation amount of the printing pressure between the blanket cylinder and the impression cylinder is obtained from the line width difference LWD by using the conversion table between the line width difference of the ink color ICm and a compensation amount of the printing pressure between the blanket cylinder and the impression cylinder, and is then stored in the address location for the printing unit M in the memory M26.

In Step P126, an output of the A/D convertor 46 connected to the potentiometer 47 for the motor for adjusting the nip pressure between the plate cylinder and each of the ink form rollers of the printing unit M is read, and is then stored in the address location for the printing unit M in the memory M27. Thereafter, in Step P127, the current nip pressure between the plate cylinder and each of the ink form rollers of the printing unit M is calculated from the output of the A/D convertor connected to the potentiometer for the motor for adjusting the nip pressure between the plate cylinder and each of the ink form rollers of the printing unit M, and is then stored in the address location for the printing unit M in the memory M28.

In Step P128, the compensation amount of the nip pressure between the plate cylinder and each of the ink form rollers of the printing unit M is read from the memory M22. Thereafter, in Step P129, it is determined whether the compensation amount of the nip pressure between the plate cylinder and each of the ink form rollers of the printing unit M is not 0. When the determination in Step P129 is NO, it is determined, in Step P130, whether or not the compensation amount of the nip pressure between the plate cylinder and each of the ink form rollers of the printing unit M is larger than 0. On the other hand, when the determination in Step P129 is YES, the process proceeds to Step P143.

When the determination in Step P130 is YES, in Step P131, the compensation amount of the nip pressure between the plate cylinder and each of the ink form rollers of the printing unit M is added to the current nip pressure between the plate cylinder and each of the ink form rollers of the printing unit M. Thereby, the target nip pressure between the plate cylinder and each of the ink form rollers of the printing unit M is calculated, and is then stored in the address location for the printing unit M in the memory M29. Thereafter, in Step P132, the target output of the A/D convertor connected to the potentiometer for the motor for adjusting the nip pressure between the plate cylinder and each of the ink form rollers of the printing unit M is calculated from the target nip pressure between the plate cylinder and each of the ink form rollers of the printing unit M, and is then stored in the address location for the printing unit M in the memory M30.

In Step P133, a normal rotation instruction is outputted to the motor driver 45 for adjusting the nip pressure between the plate cylinder and each of the ink form rollers of the printing unit M. Thereafter, in Step P134, the output of the A/D convertor 46 connected to the potentiometer 47 for the motor for adjusting the nip pressure between the plate cylinder and each of the ink form rollers of the printing unit M is read, and is then stored in the address location for the printing unit M in the memory M27.

In Step P135, it is determined whether or not the output of the A/D convertor connected to the potentiometer for the motor for adjusting the nip pressure between the plate cylinder and each of the ink form rollers of the printing unit M is equal to the target output of the A/D convertor connected to the potentiometer for the motor for adjusting the nip pressure between the plate cylinder and each of the ink form rollers of the printing unit M. When the determination in Step P135 is YES, in Step P136, the output of the normal rotation instruction to the motor driver 45 for adjusting the nip pressure between the plate cylinder and each of the ink form rollers of the printing unit M is stopped. Thereafter, the process proceeds to Step P143. On the other hand, when the determination in Step P135 is NO, the process returns to Step P134.

When the determination in Step P130 is NO, on the other hand, in Step P137, the compensation amount of the nip pressure between the plate cylinder and each of the ink form rollers of the printing unit M is added to the current nip pressure between the plate cylinder and each of the ink form rollers of the printing unit M. Thereby, the target nip pressure between the plate cylinder and each of the ink form rollers of the printing unit M is calculated, and is then stored in the address location for the printing unit M in the memory M29. Thereafter, in Step P138, the target output of the A/D convertor connected to the potentiometer for the motor for adjusting the nip pressure between the plate cylinder and each of the ink form rollers of the printing unit M is calculated from the target nip pressure between the plate cylinder and each of the ink form rollers of the printing unit M, and is then stored in the address location for the printing unit M in the memory M30.

In Step P139, a reverse rotation instruction is outputted to the motor driver 45 for adjusting the nip pressure between the plate cylinder and each of the ink form rollers of the printing unit M. Thereafter, in Step P140, the output of the A/D convertor 46 connected to the potentiometer 47 for the motor for adjusting the nip pressure between the plate cylinder and each of the ink form rollers of the printing unit M is read, and is then stored in the address location for the printing unit M in the memory M27.

In Step P141, it is determined whether or not the output of the A/D convertor connected to the potentiometer for the motor for adjusting the nip pressure between the plate cylinder and each of the ink form rollers of the printing unit M is equal to the target output of the A/D convertor connected to the potentiometer for the motor for adjusting the nip pressure between the plate cylinder and each of the ink form rollers of the printing unit M. When the determination in Step P141 is YES, in Step P142, the output of the reverse rotation instruction to the motor driver 45 for adjusting the nip pressure between the plate cylinder and each of the ink form rollers of the printing unit M is stopped. Thereafter, the process proceeds to Step P143. On the other hand, when the determination in Step P141 is NO, the process returns to Step P140.

In Step P143, an output of the A/D converter 49 connected to the potentiometer 50 for the motor for adjusting the nip pressure between the plate cylinder and the blanket cylinder of the printing unit M is read, and is then stored in the address location for the printing unit M of the memory M31. Thereafter, in Step P144, the current nip pressure between the plate cylinder and the blanket cylinder of the printing unit M is calculated from the output of the A/D convertor connected to the potentiometer for the motor for adjusting the nip pressure between the plate cylinder and the blanket cylinder of the printing unit M, and is then stored in the address location for the printing unit M in the memory M32.

In Step P145, the compensation amount of the nip pressure between the plate cylinder and the blanket cylinder of the printing unit M is read from the memory M24. Thereafter, in Step P146, it is determined whether the compensation amount of the nip pressure between the plate cylinder and the blanket cylinder of the printing unit M is not 0. When the determination in Step P146 is NO, it is determined, in Step P147, whether or not the compensation amount of the nip pressure between the plate cylinder and the blanket cylinder of the printing unit M is larger than 0. When the determination in step P146 is YES, the process proceeds to Step P160.

When the determination in Step P147 is YES, in Step P148, the compensation amount of the nip pressure between the plate cylinder and the blanket cylinder of the printing unit M is added to the current nip pressure between the plate cylinder and the blanket cylinder of the printing unit M. Thereby, the target nip pressure between the plate cylinder and the blanket cylinder of the printing unit M is calculated, and is then stored in the address location for the printing unit M in the memory M33. Thereafter, in Step P149, the target output of the A/D convertor connected to the potentiometer for the motor for adjusting the nip pressure between the plate cylinder and the blanket cylinder of the printing unit M is calculated from the target nip pressure between the plate cylinder and the blanket cylinder of the printing unit M, and is then stored in the address location for the printing unit M in the memory M34.

In Step P150, a normal rotation instruction is outputted to the motor driver 48 for adjusting the nip pressure between the plate cylinder and the blanket cylinder of the printing unit M. Thereafter, in Step P151, the output of the A/D convertor 49 connected to the potentiometer 50 for the motor for adjusting the nip pressure between the plate cylinder and the blanket cylinder of the printing unit M is read, and is then stored in the address location for the printing unit M in the memory M31.

In Step P152, it is determined whether or not the output of the A/D convertor connected to the potentiometer for the motor for adjusting the nip pressure between the plate cylinder and the blanket cylinder of the printing unit M is equal to the target output of the A/D convertor connected to the potentiometer for the motor for adjusting the nip pressure between the plate cylinder and the blanket cylinder of the printing unit M. When the determination in Step P152 is YES, in Step P153, the output of the normal rotation instruction to the motor driver 48 for adjusting the nip pressure between the plate cylinder and the blanket cylinder of the printing unit M is stopped. Thereafter, the process proceeds to Step P160. On the other hand, when the determination in Step P152 is NO, the process returns to Step P151.

When the determination in Step P147 is NO, on the other hand, in Step P154, the compensation amount of the nip pressure between the plate cylinder and the blanket cylinder of the printing unit M is added to the current nip pressure between the plate cylinder and the blanket cylinder of the printing unit M. Thereby, the target nip pressure between the plate cylinder and the blanket cylinder of the printing unit M is calculated, and is then stored in the address location for the printing unit M in the memory M33. Thereafter, in Step P155, the target output of the A/D convertor connected to the potentiometer for the motor for adjusting the nip pressure between the plate cylinder and the blanket cylinder of the printing unit M is calculated from the target nip pressure between the plate cylinder and the blanket cylinder of the printing unit M, and is then stored in the address location for the printing unit M in the memory M34.

In Step P156, a reverse rotation instruction is outputted to the motor driver 48 for adjusting the nip pressure between the plate cylinder and the blanket cylinder of the printing unit M. Thereafter, in Step P157, the output of the A/D convertor 49 connected to the potentiometer 50 for the motor for adjusting the nip pressure between the plate cylinder and the blanket cylinder of the printing unit M is read, and is then stored in the address location for the printing unit M in the memory M31.

In Step P158, it is determined whether or not the output of the A/D convertor connected to the potentiometer for the motor for adjusting the nip pressure between the plate cylinder and the blanket cylinder of the printing unit M is equal to the target output of the A/D convertor connected to the potentiometer for the motor for adjusting the nip pressure between the plate cylinder and the blanket cylinder of the printing unit M. When the determination in Step P158 is YES, in Step P159, the output of the reverse rotation instruction to the motor driver 48 for adjusting the nip pressure between the plate cylinder and the blanket cylinder of the printing unit M is stopped. Thereafter, the process proceeds to Step P160. On the other hand, when the determination in Step P158 is NO, the process returns to Step P157.

In Step P160, an output of the A/D converter 52 connected to the potentiometer 53 for the motor for adjusting the printing pressure between the blanket cylinder and the impression cylinder of the printing unit M is read, and is then stored in the address location for the printing unit M of the memory M35. Thereafter, in Step P161, the current printing pressure between the blanket cylinder and the impression cylinder of the printing unit M is calculated from the output of the A/D convertor connected to the potentiometer for the motor for adjusting the printing pressure between the blanket cylinder and the impression cylinder of the printing unit M, and is then stored in the address location for the printing unit M in the memory M36.

In Step P162, the compensation amount of the printing pressure between the blanket cylinder and the impression cylinder of the printing unit M is read from the memory M26. Thereafter, in Step P163, it is determined whether the compensation amount of the printing pressure between the blanket cylinder and the impression cylinder of the printing unit M is not 0. When the determination in Step P163 is NO, it is determined, in Step P164, whether or not the compensation amount of the printing pressure between the blanket cylinder and the impression cylinder of the printing unit M is larger than 0. When the determination in Step P163 is YES, the process proceeds to Step P177.

When the determination in Step P164 is YES, in Step P165, the compensation amount of the printing pressure between the blanket cylinder and the impression cylinder of the printing unit M is added to the current printing pressure between the blanket cylinder and the impression cylinder of the printing unit M. Thereby, the target printing pressure between the blanket cylinder and the impression cylinder of the printing unit M is calculated, and is then stored in the address location for the printing unit M in the memory M37. Thereafter, in Step P166, the target output of the A/D convertor connected to the potentiometer for the motor for adjusting the printing pressure between the blanket cylinder and the impression cylinder of the printing unit M is calculated from the target printing pressure between the blanket cylinder and the impression cylinder of the printing unit M, and is then stored in the address location for the printing unit M in the memory M38.

In Step P167, a normal rotation instruction is outputted to the motor driver 51 for adjusting the printing pressure between the blanket cylinder and the impression cylinder of the printing unit M. Thereafter, in Step P168, the output of the A/D convertor 52 connected to the potentiometer 53 for the motor for adjusting the printing pressure between the blanket cylinder and the impression cylinder of the printing unit M is read, and is then stored in the address location for the printing unit M in the memory M35.

In Step P169, it is determined whether or not the output of the A/D convertor connected to the potentiometer for the motor for adjusting the printing pressure between the blanket cylinder and the impression cylinder of the printing unit M is equal to the target output of the A/D convertor connected to the potentiometer for the motor for adjusting the printing pressure between the blanket cylinder and the impression cylinder of the printing unit M. When the determination in Step P169 is YES, in Step P170, the output of the normal rotation instruction to the motor driver 51 for adjusting the printing pressure between the blanket cylinder and the impression cylinder of the printing unit M is stopped. Thereafter, the process proceeds to Step P177. On the other hand, when the determination in Step P169 is NO, the process returns to Step P168.

When the determination in Step P164 is NO, on the other hand, in Step P171, the compensation amount of the printing pressure between the blanket cylinder and the impression cylinder of the printing unit M is added to the current printing pressure between the blanket cylinder and the impression cylinder of the printing unit M. Thereby, the target printing pressure between the blanket cylinder and the impression cylinder of the printing unit M is calculated, and is then stored in the address location for the printing unit M in the memory M37. Thereafter, in Step P172, the target output of the A/D convertor connected to the potentiometer for the motor for adjusting the printing pressure between the blanket cylinder and the impression cylinder of the printing unit M is calculated from the target printing pressure between the blanket cylinder and the impression cylinder of the printing unit M, and is then stored in the address location for the printing unit M in the memory M38.

In Step P173, a reverse rotation instruction is outputted to the motor driver 51 for adjusting the printing pressure between the blanket cylinder and the impression cylinder of the printing unit M. Thereafter, in Step P174, the output of the A/D convertor 52 connected to the potentiometer 53 for the motor for adjusting the printing pressure between the blanket cylinder and the impression cylinder of the printing unit M is read, and is then stored in the address location for the printing unit M in the memory M35.

In Step P175, it is determined whether or not the output of the A/D convertor connected to the potentiometer for the motor for adjusting the printing pressure between the blanket cylinder and the impression cylinder of the printing unit M is equal to the target output of the A/D convertor connected to the potentiometer for the motor for adjusting the printing pressure between the blanket cylinder and the impression cylinder of the printing unit M. When the determination in Step P175 is YES, in Step P176, the output of the reverse rotation instruction to the motor driver 51 for adjusting the printing pressure between the blanket cylinder and the impression cylinder of the printing unit M is stopped. Thereafter, the process proceeds to Step P177. On the other hand, when the determination in Step P175 is NO, the process returns to Step P174.

In Step P177, the count value M is incremented by 1, and then is overwritten with the resultant value in the memory M2. Thereafter, in Step P178, the total number Mmax of the printing units is read from the memory M9. In Step P179, it is determined whether or not the count value M is larger than the total number Mmax of the printing units. When the determination in Step P179 is YES, the process returns to Step P1. On the other hand, when the determination in Step P179 is NO, the process returns to Step P89. Thereafter, this process is repeated.

As described above, in the first embodiment, the maximum width of the printed line portion is measured by the line-width measuring camera 44, and the control device 30 controls the drive of each of the motors 9, 18, and 24 on the basis of the measuring result, to automatically adjust the nip pressure between the plate cylinder and each of the ink form rollers, the nip pressure between the plate cylinder and the blanket cylinder, and the printing pressure between the blanket cylinder and the impression cylinder. With this configuration, it is possible to reduce the burden of the operator, and also to reduce the amount of waste paper to be produced, by preventing errors in manual adjustment.

### Second Embodiment

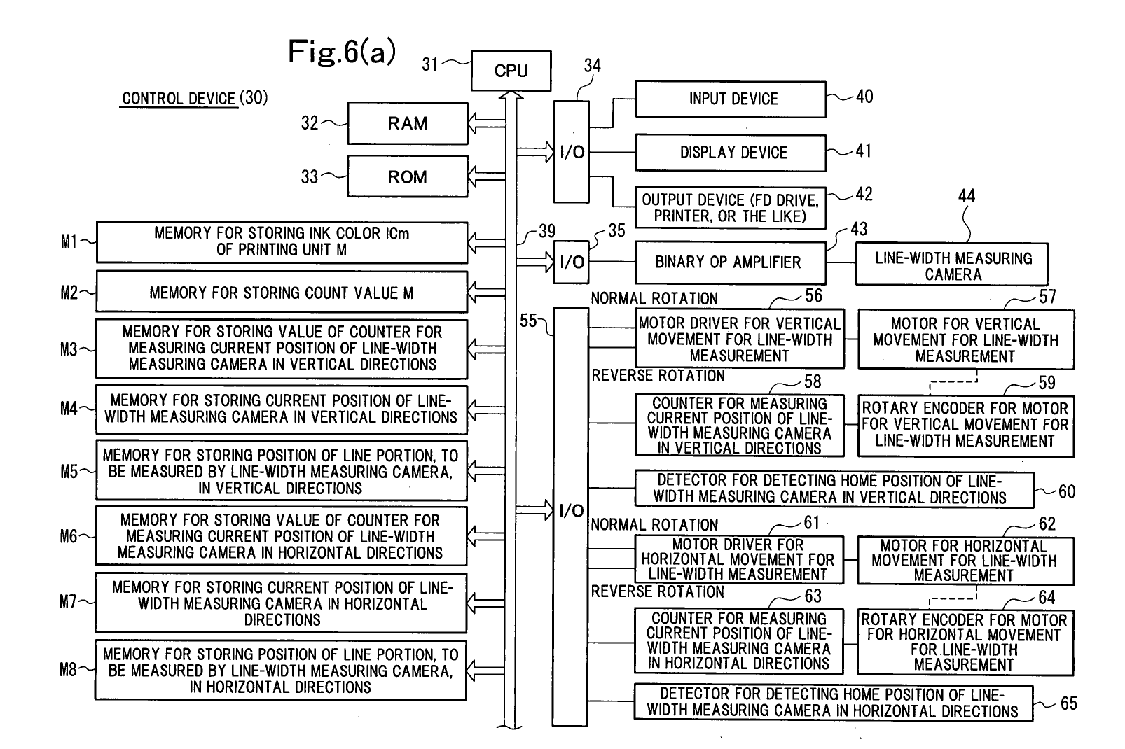

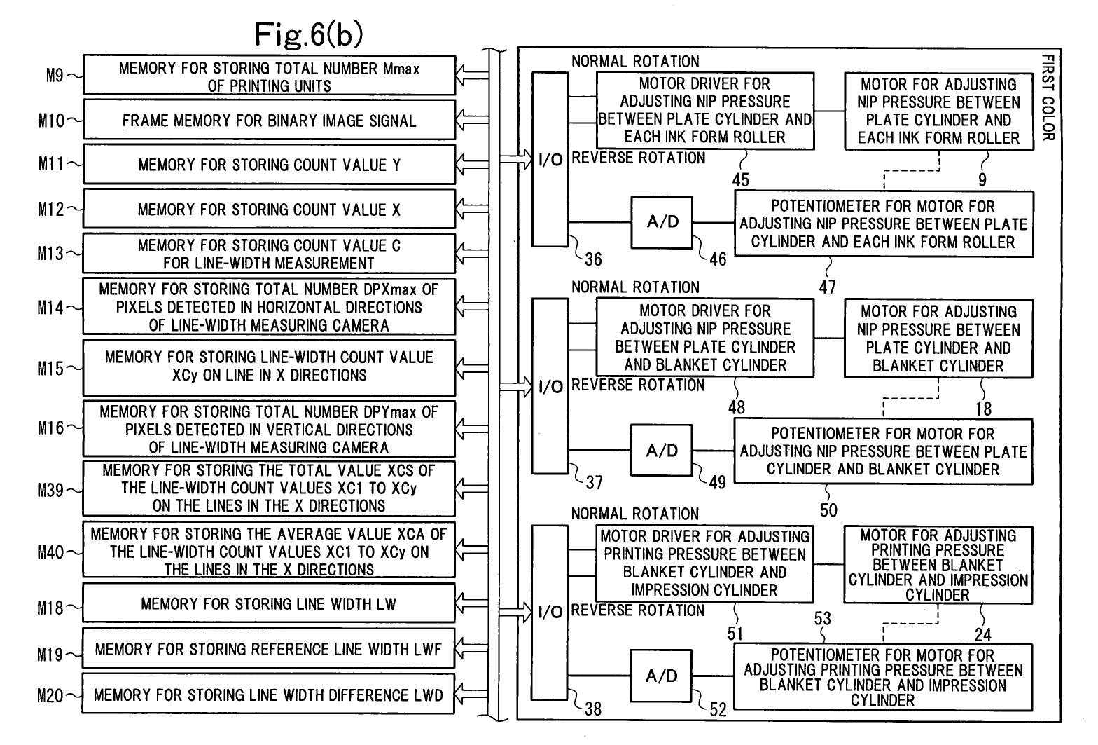

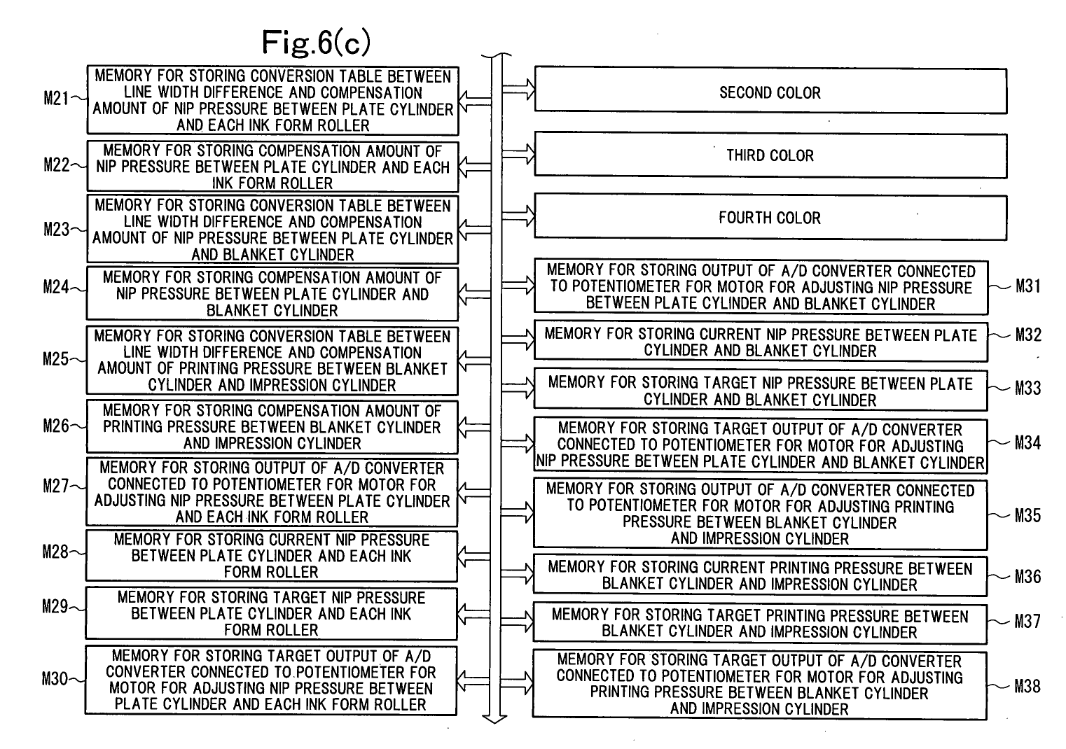

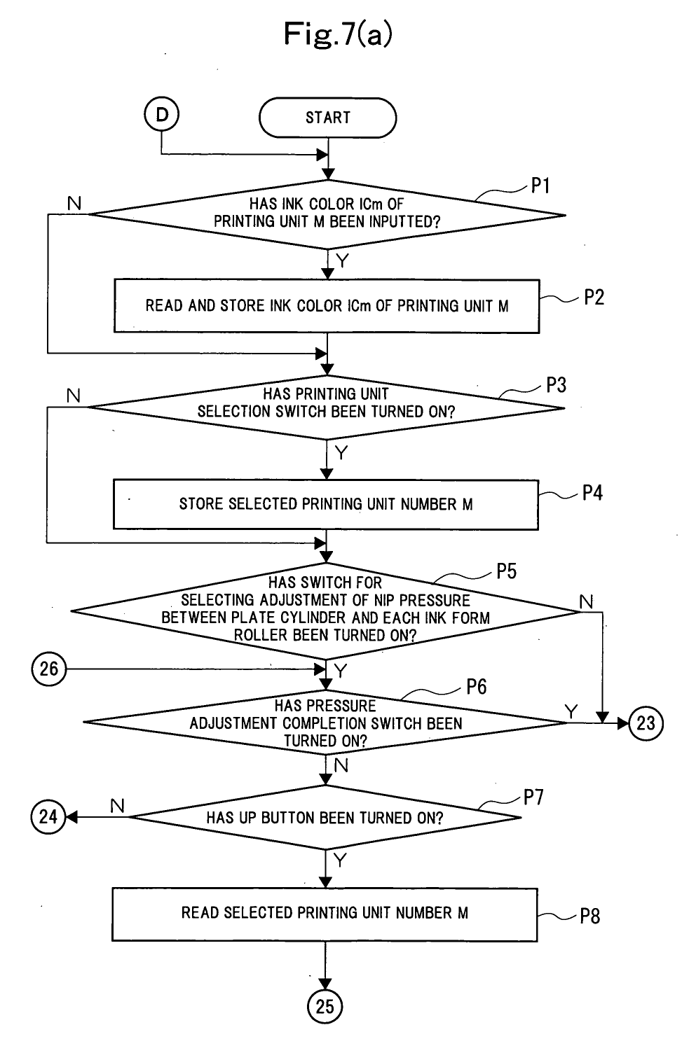

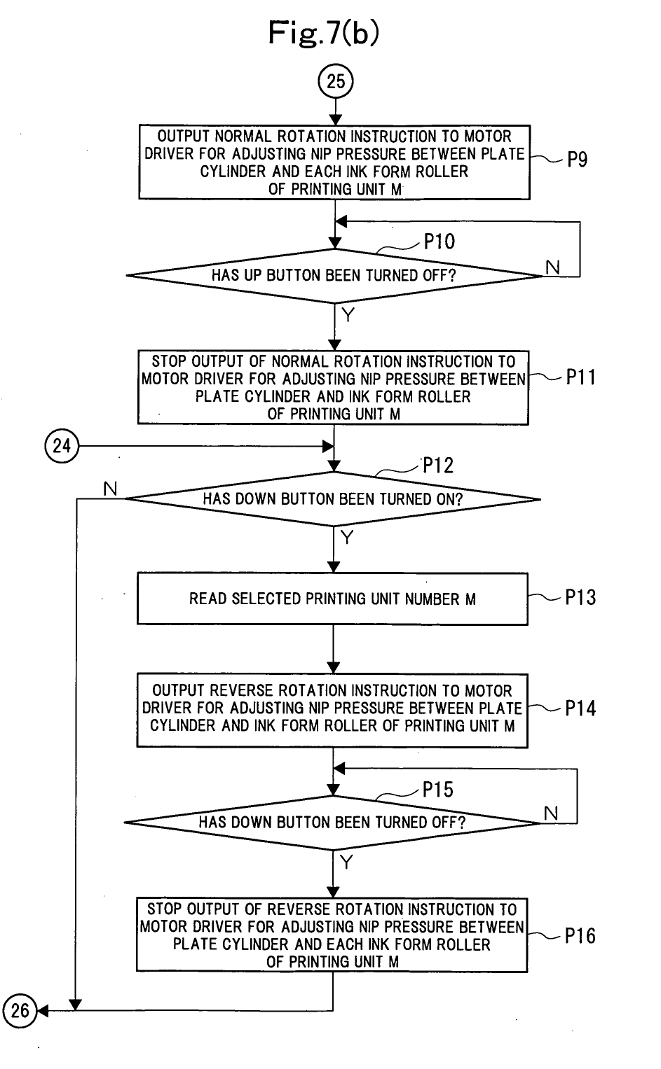

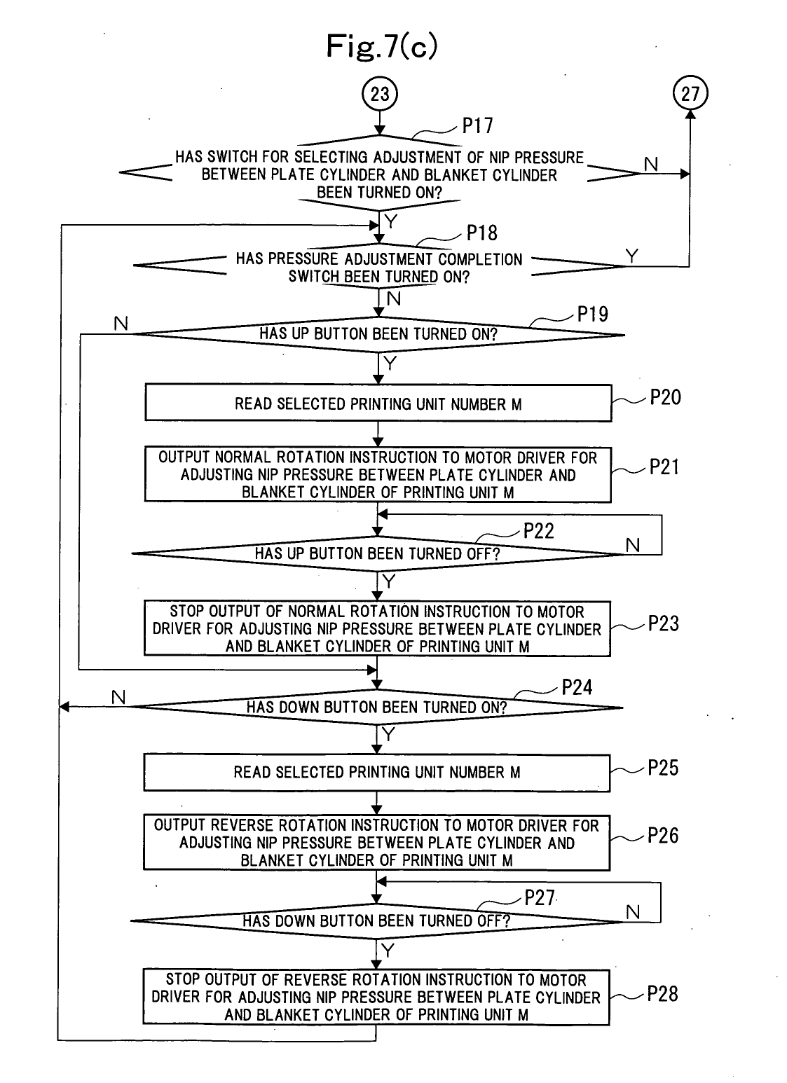

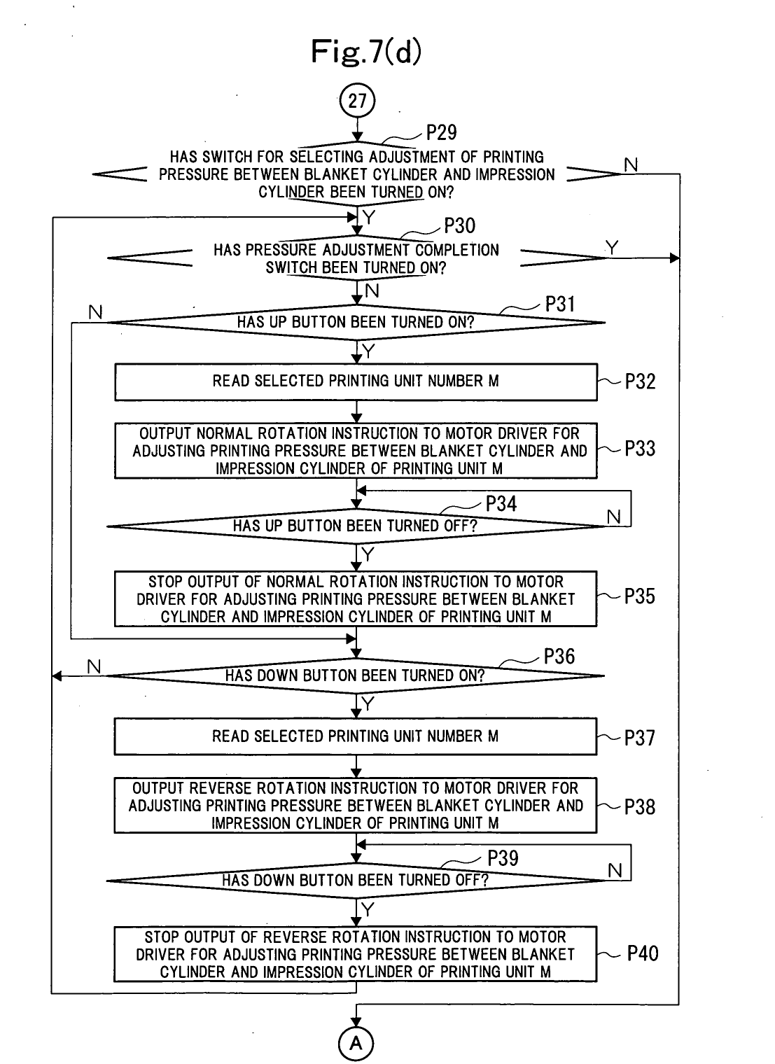

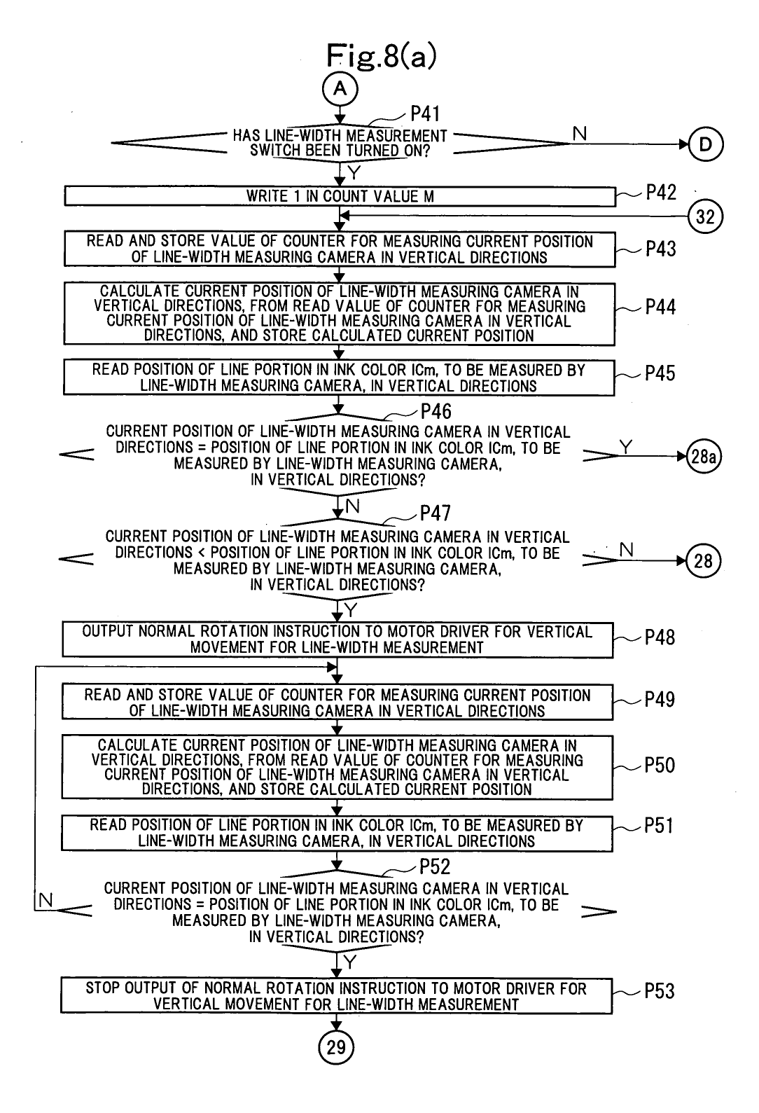

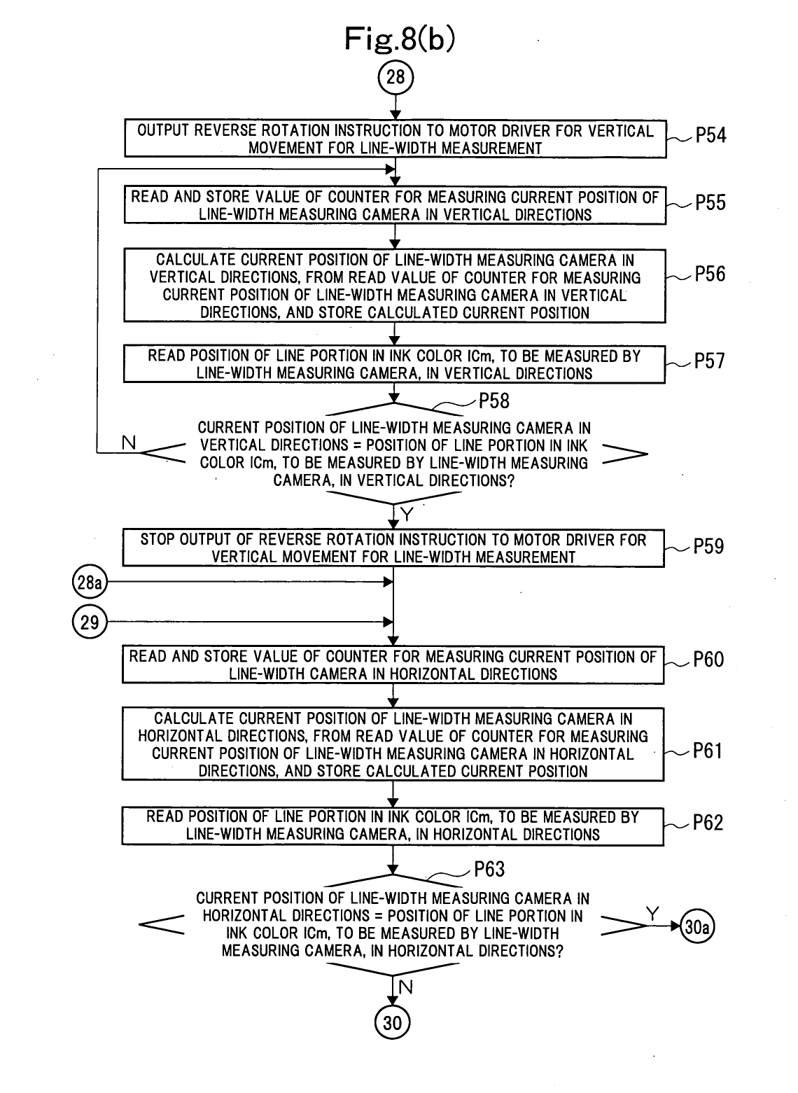

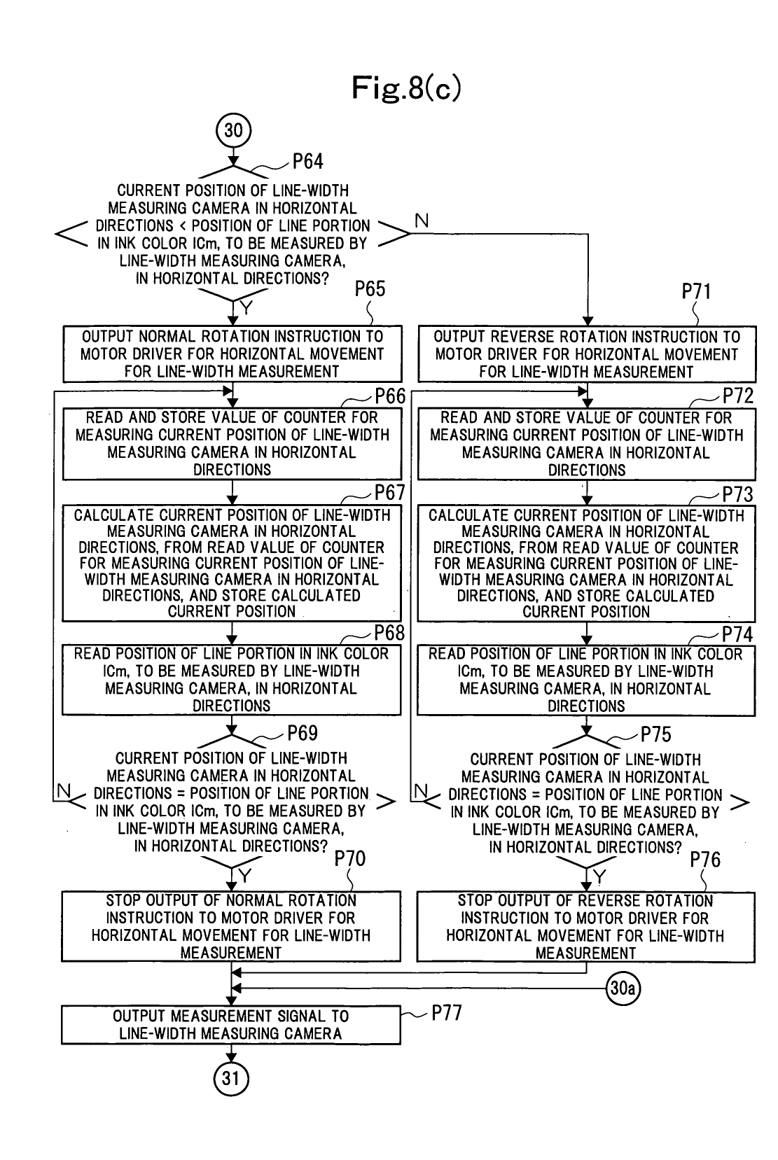

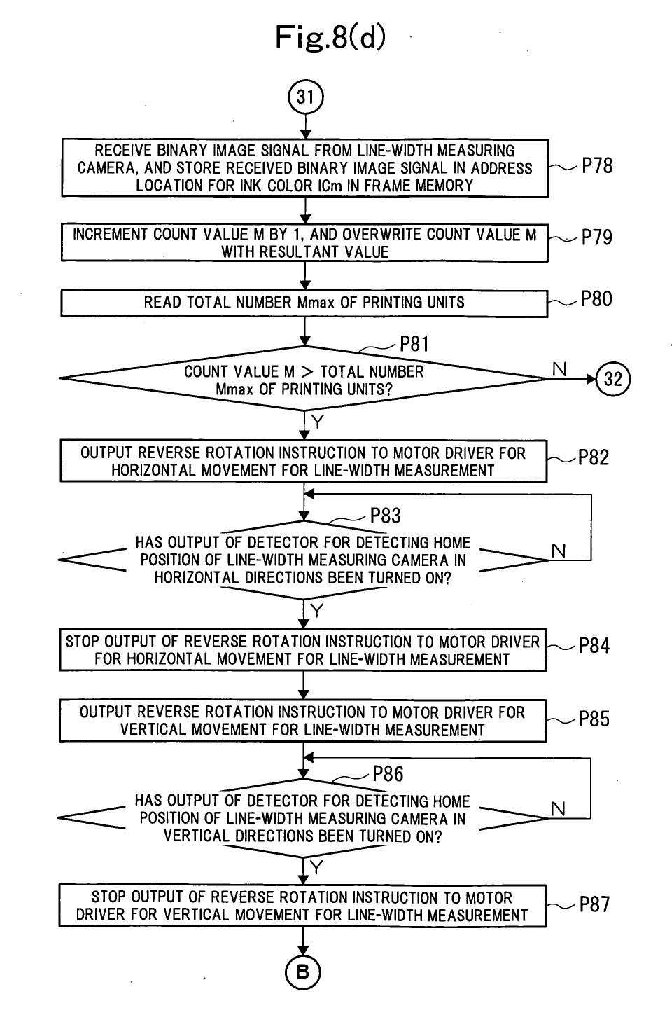

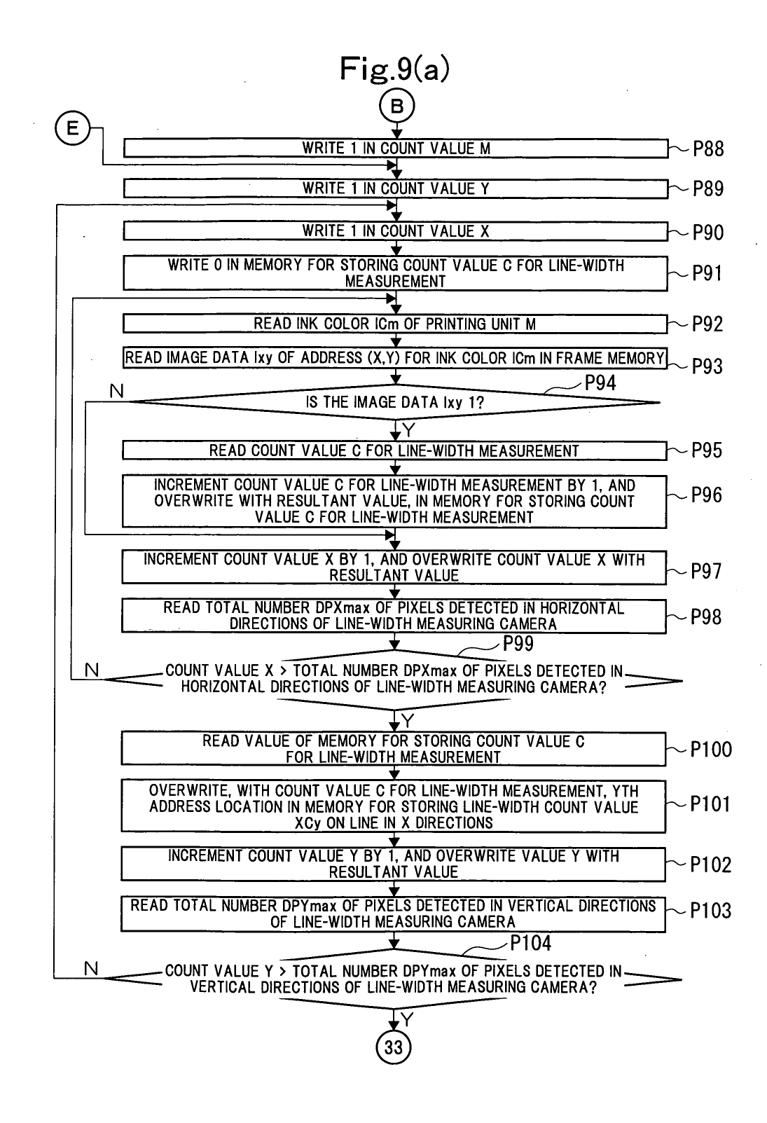

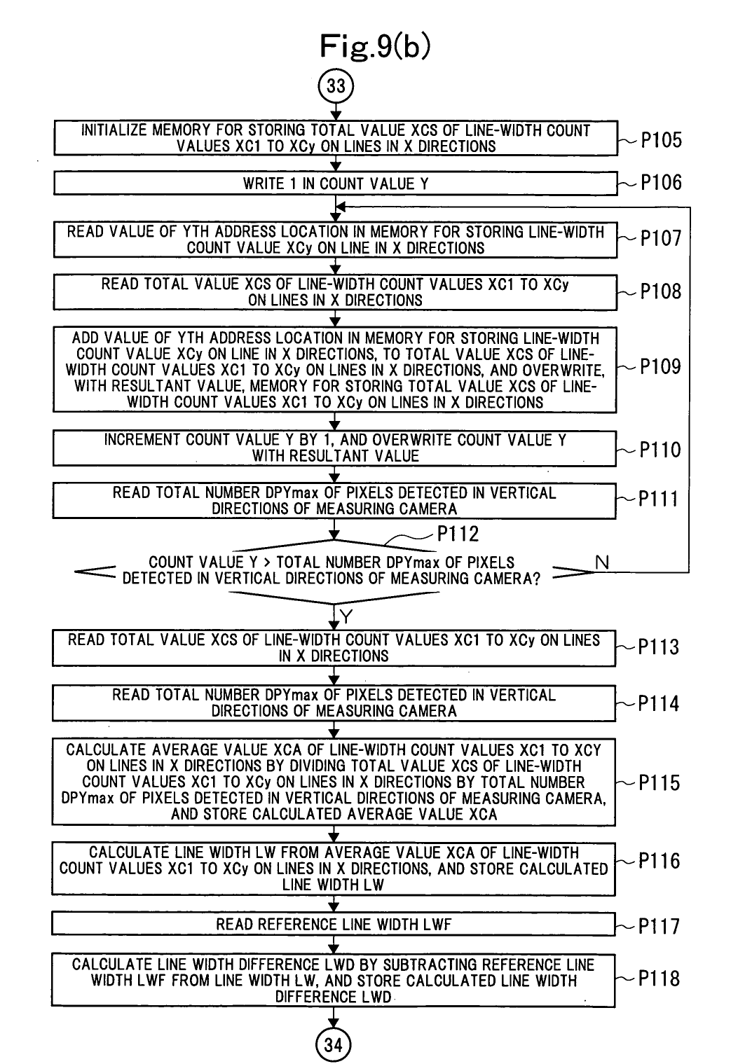

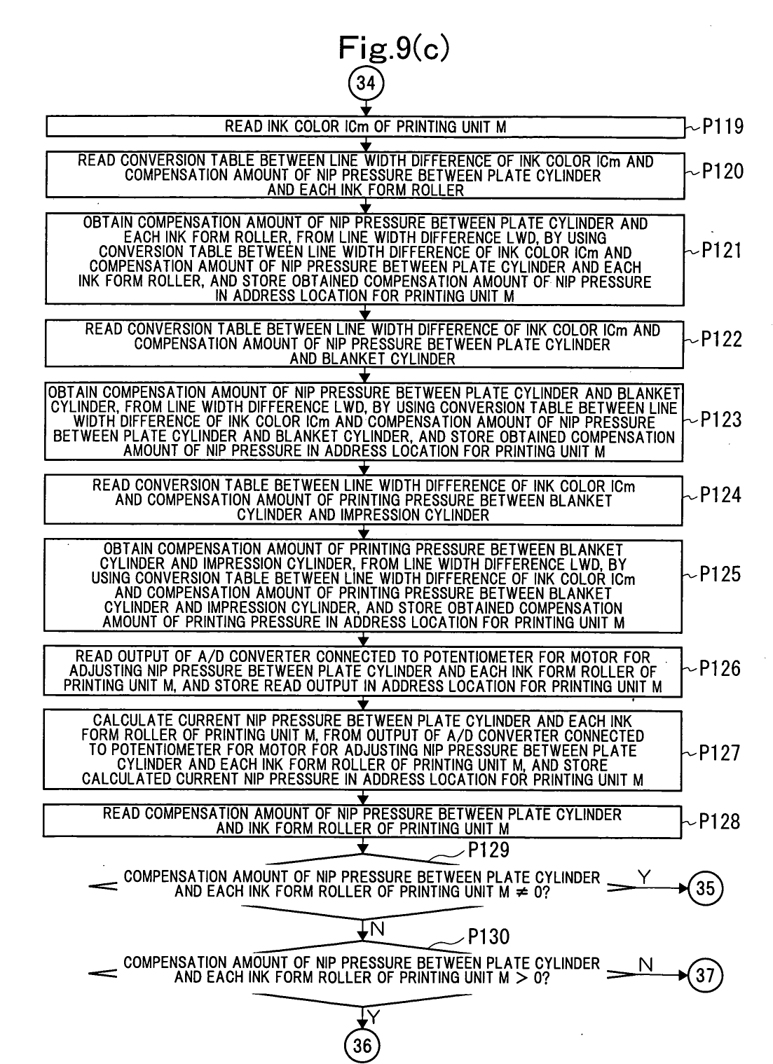

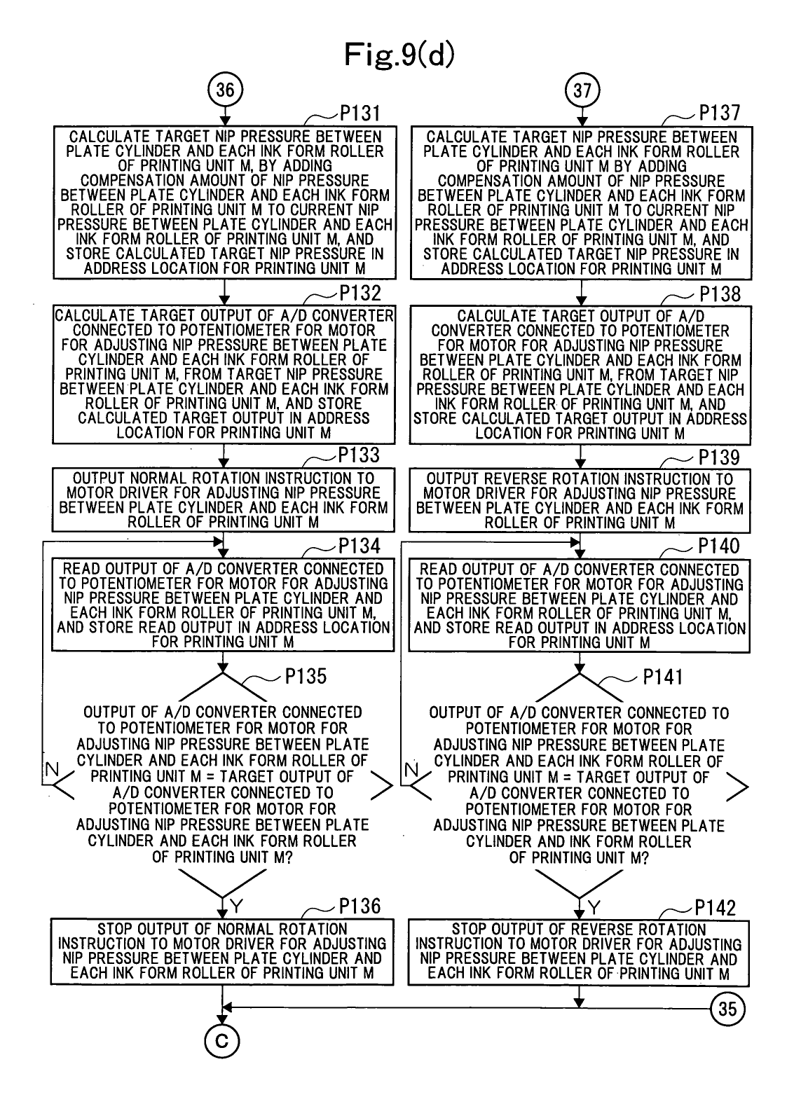

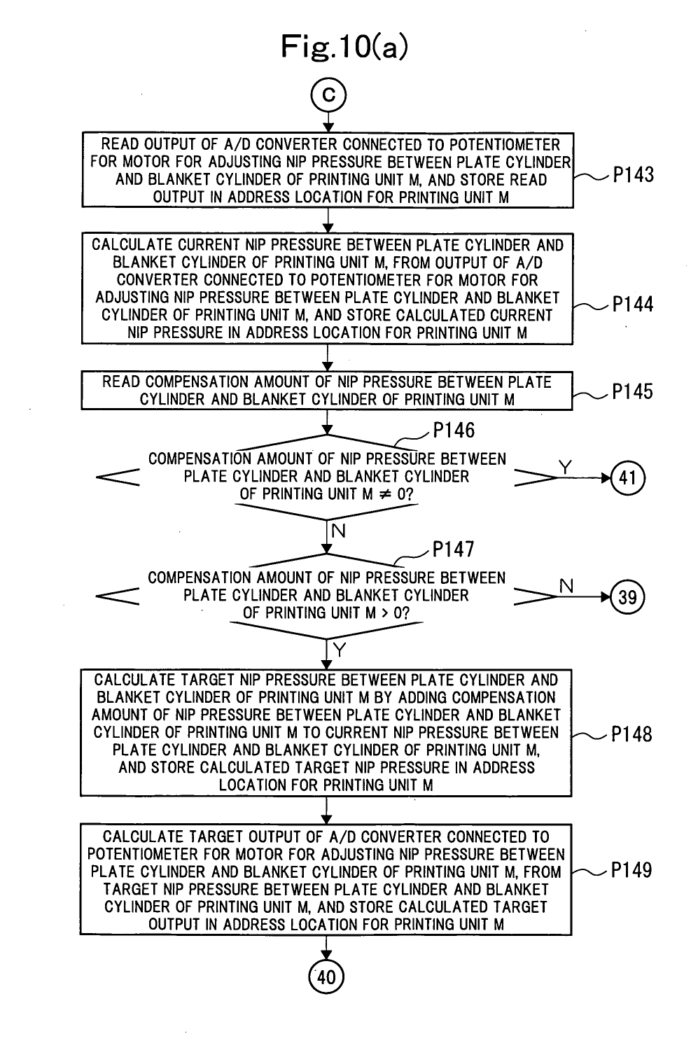

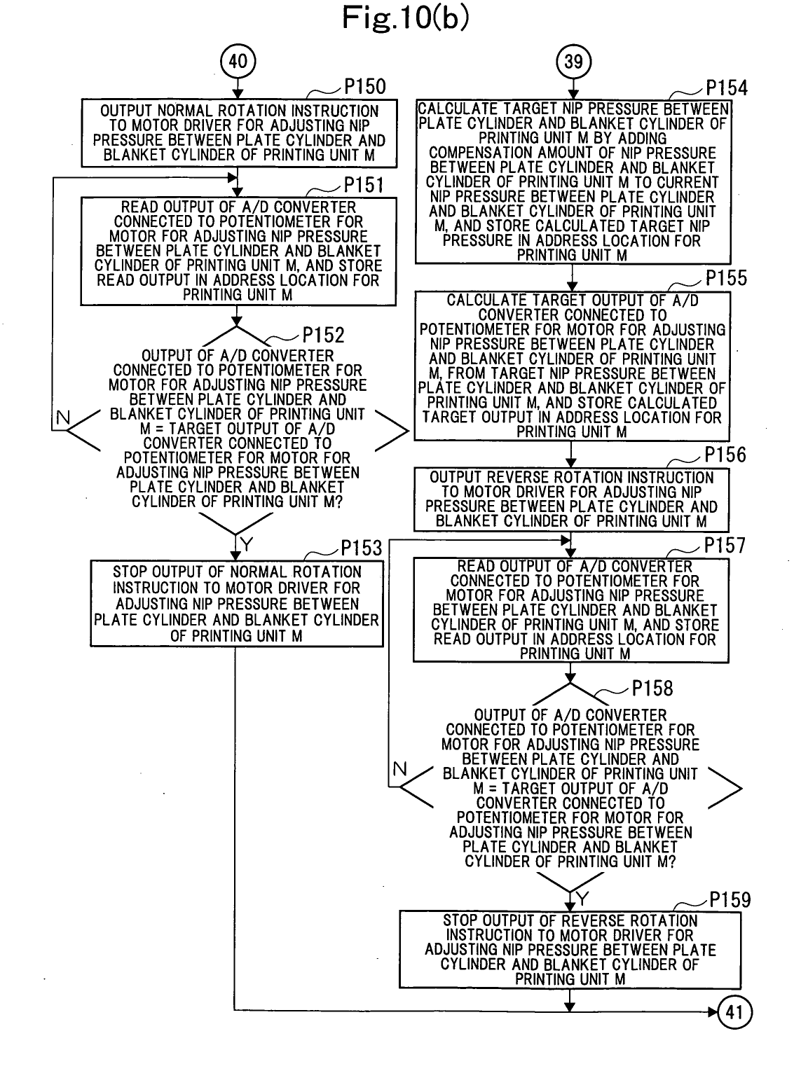

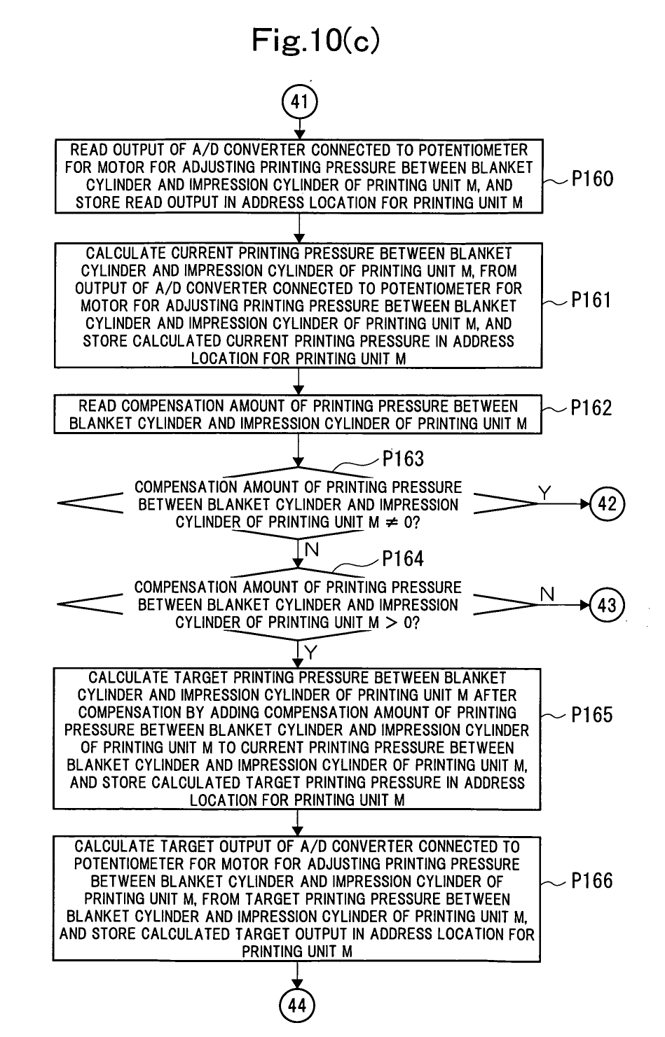

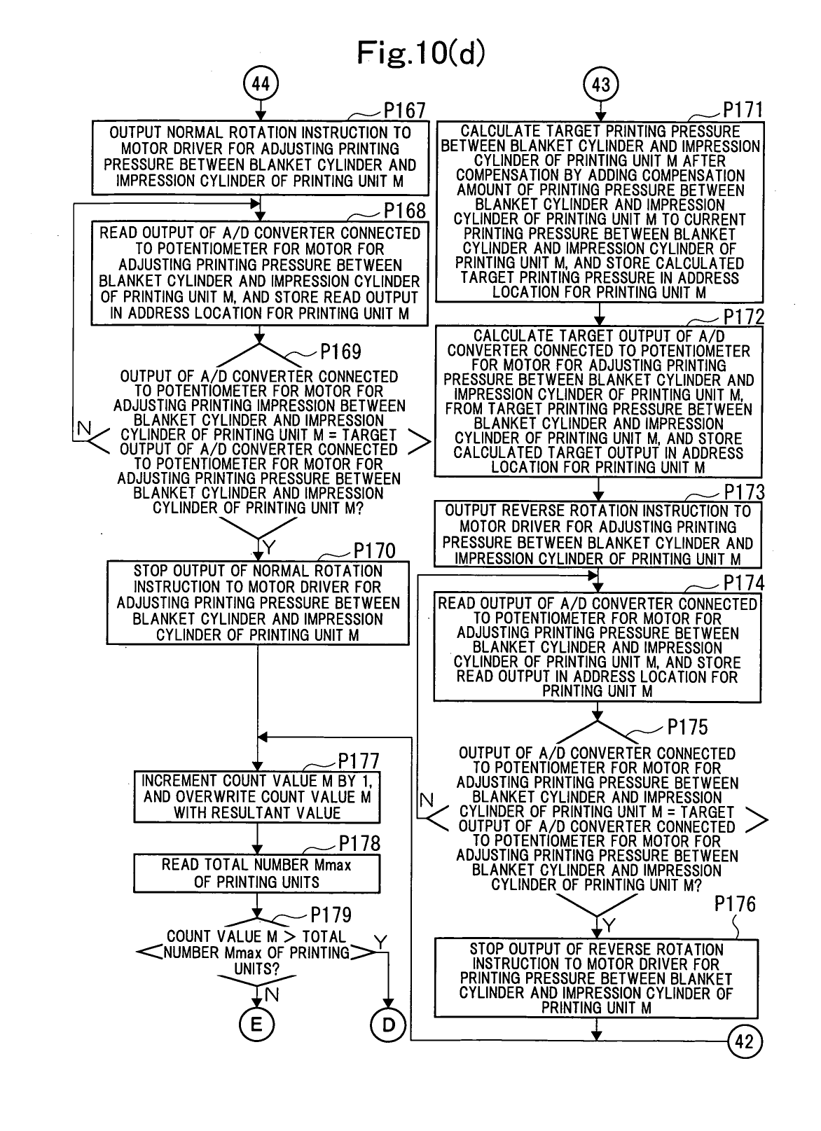

FIGS. 6(a) to 6(c) are control block diagrams of a control device showing a second embodiment of the present invention. FIGS. 7(a) to 7(d), FIGS. 8(a) to 8(d), FIGS. 9(a) to 9(d), and FIGS. 10(a) to 10(d) are operation flowcharts of the control device.

The second embodiment is an example in which the control device 30 according to the first embodiment automatically adjusts the nip pressure between the plate cylinder and each of the ink form rollers, the nip pressure between the plate cylinder and the blanket cylinder, and the printing pressure between the blanket cylinder and the impression cylinder, on the basis of the mean width of the printed line portion, instead of the maximum width of the line portion.

As shown in FIGS. 6(a) to 6(c), in the control device 30, a CPU 31, a RAM 32, a ROM 33, and input/output (I/O) devices 34 to 38 and 55 are connected through a bus 39. Moreover, memories M1 to M10 are connected to the bus 39. In the memory M1, an ink color ICm of a printing unit M is stored. In the memory M2, a count value M is stored. In the memory M3, a value of a counter for measuring the current position of a line-width measuring camera in the vertical directions is stored. In the memory M4, the current position of the line-width measuring camera in the vertical directions is stored. In the memory M5, the position of a line portion, to be measured by the line-width measuring camera, in the vertical directions is stored. In the memory M6, a value of the counter for measuring the current position of the line-width measuring camera in the horizontal directions is stored. In the memory M7, the current position of the line-width measuring camera in the horizontal directions is stored. In the memory M8, the position of the line portion, to be measured by the line-width measuring camera, in the horizontal directions is stored. In the memory M9, the total number Mmax of printing units is stored. In the frame memory M10, a binary image signal is stored.

Furthermore, memories M11 to M16, M39 and M40, and M18 to M21 are also connected to the bus 39. In the memory M11, a count value Y is stored. In the memory M12, a count value X is stored. In the memory M13, a count value C for line-width measurement is stored. In the memory M14, the total number DPXmax of pixels detected in the horizontal directions of the line-width measuring camera is stored. In the memory M15, a line-width count value XCy of a line in the X directions is stored. In the memory M16, the total number DPYmax of pixels detected in the vertical directions of the line-width measuring camera is stored. In the memory M39, the total value XCS of the line-width count values XC1 to XCy on the lines in the X directions is stored. In the memory M40, the average value XCA of the line-width count values XC1 to XCy on the lines in the X directions is stored. In the memory M18, a line width LW is stored. In the memory M19, a reference line width LWF is stored. In the memory M20, a line width difference LWD is stored. In the memory M21, a conversion table between a line width difference and a compensation amount for the nip pressure between the plate cylinder and each of the ink form rollers is stored.

Furthermore, memories M22 to M30 are also connected to the bus 39. In the memory M22, a compensation amount of the nip pressure between the plate cylinder and each of the ink form rollers is stored. In the memory M23, a conversion table between a line width difference and a compensation amount of the nip pressure between the plate cylinder and the blanket cylinder is stored. In the memory M24, a compensation amount of the nip pressure between the plate cylinder and the blanket cylinder is stored. In the memory M25, a conversion table between a line width difference and the compensation amount of the printing pressure between the blanket cylinder and the impression cylinder is stored. In the memory M26, a compensation amount of the printing pressure between the blanket cylinder and the impression cylinder is stored. In the memory M27, an output of an A/D converter connected to a potentiometer for a motor for adjusting the nip pressure between the plate cylinder and each of the ink form rollers is stored. In the memory M28, a current nip pressure between the plate cylinder and the ink form rollers is stored. In the memory M29, a target nip pressure between the plate cylinder and each of the ink form rollers is stored. In the memory M30, a target output of the A/D converter connected to the potentiometer for the motor for adjusting the nip pressure between the plate cylinder and each of the ink form rollers is stored.

Furthermore, memories M31 to M38 are also connected to the bus 39. In the memory M31, an output of an A/D converter connected to a potentiometer for a motor for adjusting the nip pressure between the plate cylinder and the blanket cylinder is stored. In the memory M32, a current nip pressure between the plate cylinder and the blanket cylinder is stored. In the memory M33, a target nip pressure between the plate cylinder and the blanket cylinder is stored. In the memory M34, a target output of the A/D converter connected to the potentiometer for the motor for adjusting the nip pressure between the plate cylinder and the blanket cylinder is stored. In the memory M35, an output of an A/D converter connected to a potentiometer for a motor for adjusting the printing pressure between the blanket cylinder and the impression cylinder is stored. In the memory M36, a current printing pressure between the blanket cylinder and the impression cylinder is stored. In the memory M37, a target printing pressure between the blanket cylinder and the impression cylinder is stored. In the memory M38, a target output of the A/D converter connected to the potentiometer for the motor for adjusting the printing pressure between the blanket cylinder and the impression cylinder is stored.

An input device 40 such as a keyboard, a display device 41 such as a CRT or a display, and an output device 42 such as a printer or a floppy disk (registered trademark) drive are connected to the I/O device 34. A line-width measuring camera (width measurement means) 44 for line-width measurement is connected to the I/O device 35 through a binary OP amplifier 43.

A motor 57 for vertical movement for line-width measurement is connected to the I/O device 55 through a motor driver 56 for vertical movement for line-width measurement. Moreover, a rotary encoder 59 for the motor for vertical movement for line-width measurement is also connected to the I/O device 55 through a counter 58 for measuring the current position of the line-width measuring camera in the vertical directions, the rotary encoder 59 being connected to and driven by the motor 57. Furthermore, a detector 60 for detecting the home position of the line-width measuring camera in the vertical directions is also connected to the I/O device 55.

In addition, a motor 62 for horizontal movement for line-width measurement is also connected to the I/O device 55 through a motor driver 61 for horizontal movement for line-width measurement. Moreover, a rotary encoder 64 for the motor for horizontal movement for line-width measurement is also connected to the I/O device 55 through a counter 63 for measuring the current position of the line-width measuring camera in the horizontal directions, the rotary encoder 64 being connected to and driven by the motor 62. Furthermore, a detector 65 for detecting the home position of the line-width measuring camera in the horizontal directions is also connected to the I/O device 55.

A motor 9 for adjusting the nip pressure between the plate cylinder and each of the ink form rollers is connected to the I/O device 36 through a motor driver 45 for adjusting the nip pressure between the plate cylinder and each of the ink form rollers. Moreover, a potentiometer 47 for the motor for adjusting the nip pressure between the plate cylinder and each of the ink form rollers is also connected to the I/O device 36 through an A/D convertor 46, the potentiometer 47 being connected to and driven by the motor 9.

A motor 18 for adjusting the nip pressure between the plate cylinder and the blanket cylinder is connected to the I/O device 37 through a motor driver 48 for adjusting the nip pressure between the plate cylinder and the blanket cylinder. Moreover, a potentiometer 50 for the motor for adjusting the nip pressure between the plate cylinder and the blanket cylinder is also connected to the I/O device 37 through an A/D converter 49, the potentiometer 50 being connected to and driven by the motor 18.

A motor 24 for adjusting the printing pressure between the blanket cylinder and the impression cylinder is connected to the I/O device 38 through a motor driver 51 for adjusting the printing pressure between the blanket cylinder and the impression cylinder. Moreover, a potentiometer 53 for the motor for adjusting the printing pressure between the blanket cylinder and the impression cylinder is also connected to the I/O device 38 through an A/D converter 52, the potentiometer 53 being connected to and driven by the motor 24.

The I/O devices 36 to 38 are configured as described above in a printing unit of the first color, and are configured in the same way also in printing units of the second to fourth colors. Accordingly, overlapping description is omitted herein.

In the second embodiment, the control device 30 is configured to be capable of automatically adjusting the nip pressure between the plate cylinder 3 and each of the ink form rollers 1, the nip pressure between the plate cylinder 3 and the blanket cylinder 17, and the printing pressure between the blanket cylinder 17 and the impression cylinder 20, on the basis of a measurement result obtained by the line-width measuring camera 44 serving as width measurement means for measuring the average width of a line portion printed on the paper W.

The line-width measuring camera 44 is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 19(a) to 19(c), the line-width measuring camera 44 can directly measure the average width of the line portion (the region indicated by hatching in each of FIGS. 19(a) to 19(c)) printed on the paper (print member) W placed on the main body of the checking apparatus. In FIGS. 19(a) to 19(c), LWF denotes a reference line width.

The control operation of the control device 30 configured as described above will be described below in detail on the basis of the operation flowcharts shown in FIGS. 7(a) to 7(d), FIGS. 8(a) to 8(d), FIGS. 9(a) to 9(d), and FIGS. 10(a) to 10(d).

In Step P1, it is determined whether or not the ink color ICm of the printing unit M has been inputted. When the determination in Step P1 is YES, in Step P2, the ink color ICm of the printing unit M is read, and is then stored in the memory M1. Thereafter, in Step P3, it is determined whether or not a printing unit selection switch has been turned on. When the determination in Step P1 is NO, the process proceeds directly to Step P3.

When the determination in Step P3 is YES, in Step P4, the selected printing unit number M is stored in the memory M2. Thereafter, in Step P5, it is determined whether or not a switch for selecting the adjustment of the nip pressure between the plate cylinder and each of the ink form rollers has been turned on. When the determination in Step P3 is NO, the process proceeds directly to Step P5.

When the determination in Step P5 is YES, it is determined, in Step P6, whether or not a pressure adjustment completion switch has been turned on. When the determination in Step P6 is YES, the process proceeds to Step P17. Then, in Step P17, it is determined whether or not a switch for selecting the adjustment of the nip pressure between the plate cylinder and the blanket cylinder has been turned on. When the determination in Step P5 is NO, the process proceeds directly to Step P17.

When the determination in Step P6 is NO, it is determined, in Step P7, whether or not an up button has been turned on. When the determination in Step P7 is YES, in Step P8, the selected printing unit number M is read from the memory M2. Thereafter, in Step P9, a normal rotation instruction is outputted to the motor driver 45 for adjusting the nip pressure between the plate cylinder and each of the ink form rollers of the printing unit M.

When the up button is turned off in Step P10, in Step P1, the output of the normal rotation instruction to the motor driver 45 for adjusting the nip pressure between the plate cylinder and each of the ink form rollers of the printing unit M is stopped. Thereafter, in Step P12, it is determined whether or not a down button has been turned on. When the determination in Step P7 is NO, the process proceeds directly to Step P12.

When the determination in Step P12 is YES, in Step P13, the selected printing unit number M is read from the memory M2. Thereafter, in Step P14, a reverse rotation instruction is outputted to the motor driver 45 for adjusting the nip pressure between the plate cylinder and each of the ink form rollers of the printing unit M. When the determination in Step P12 is NO, the process returns to Step P6.

When the down button is turned off in Step P15, in Step P16, the output of the reverse rotation instruction to the motor driver 45 for adjusting the nip pressure between the plate cylinder and each of the ink form rollers of the printing unit M is stopped. Thereafter, the process returns to Step P6.

When the determination in Step P17 is YES, it is determined, in Step P18, whether or not a pressure adjustment completion switch has been turned on. When the determination in Step P18 is YES, the process proceeds to Step P29. Then, in Step P29, it is determined whether or not a switch for selecting the adjustment of the printing pressure between the blanket cylinder and the impression cylinder has been turned on. When the determination in Step P17 is NO, the process proceeds directly to Step P29.

When the determination in Step P18 is NO, it is determined, in Step P19, whether or not an up button has been turned on. When the determination in Step P19 is YES, in Step P20, the selected printing unit number M is read from the memory M2. Thereafter, in Step P21, a normal rotation instruction is outputted to the motor driver 48 for adjusting the nip pressure between the plate cylinder and the blanket cylinder of the printing unit M.

When the up button is turned off in Step P22, in Step P23, the output of the normal rotation instruction to the motor driver 48 for adjusting the nip pressure between the plate cylinder and the blanket cylinder of the printing unit M is stopped. Thereafter, in Step P24, it is determined whether or not a down button has been turned on. When the determination in Step P19 is NO, the process proceeds directly to Step P24.

When the determination in Step P24 is YES, in Step P25, the selected printing unit number M is read from the memory M2. Thereafter, in Step P26, a reverse rotation instruction is outputted to the motor driver 48 for adjusting the nip pressure between the plate cylinder and the blanket cylinder of the printing unit M. When the determination in Step P24 is NO, the process returns to Step P18.

When the down button is turned off in Step P27, in Step P28, the output of the reverse rotation instruction to the motor driver 48 for adjusting the nip pressure between the plate cylinder and the blanket cylinder of the printing unit M is stopped. Thereafter, the process returns to Step P18.

When the determination in Step P29 is YES, it is determined, in Step P30, whether or not a pressure adjustment completion switch has been turned on. When the determination in Step P29 is YES, the process proceeds to Step P41. Then, in Step P41, it is determined whether or not a line-width measurement switch has been turned on. When the determination in Step P29 is NO, the process proceeds directly to Step P41.

When the determination in Step P30 is NO, it is determined, in Step P31, whether or not an up button has been turned on. When the determination in Step P31 is YES, in Step P32, the selected printing unit number M is read from the memory M2. Thereafter, in Step P33, a normal rotation instruction is outputted to the motor driver 51 for adjusting the printing pressure between the blanket cylinder and the impression cylinder of the printing unit M.

When the up button is turned off in Step P34, in Step P35, the output of the normal rotation instruction to the motor driver 51 for adjusting the printing pressure between the blanket cylinder and the impression cylinder of the printing unit M is stopped. Thereafter, in Step P36, it is determined whether or not a down button has been turned on. When the determination in Step P31 is NO, the process proceeds directly to Step P36.

When the determination in Step P36 is YES, in Step P37, the selected printing unit number M is read from the memory M2. Thereafter, in Step P38, a reverse rotation instruction is outputted to the motor driver 51 for adjusting the printing pressure between the blanket cylinder and the impression cylinder of the printing unit M. When the determination in Step P36 is NO, the process returns to Step P30.

When the down button is turned off in Step P39, the output of the reverse rotation instruction to the motor driver 51 for adjusting the printing pressure between the blanket cylinder and the impression cylinder of the printing unit M is stopped in Step P40. Thereafter, the process returns to Step P30.

In Step P41, it is determined whether or not a line-width measurement switch has been turned on. When the determination in Step P41 is YES, 1 is written in the count value M in Step P42. On the other hand, when the determination in Step P41 is NO, the process returns to Step P1.

In Step P43, the value of the counter for measuring the current position of the line-width measuring camera in the vertical directions is read, and is then stored in the memory M3. Thereafter, in Step P44, the current position of the line-width measuring camera 44 in the vertical directions is calculated from the read value of the counter for measuring the current position of the line-width measuring camera in the vertical directions, and is then stored in the memory M4.

In Step P45, the position of the line portion in the ink color ICm, to be measured by the line-width measuring camera, in the vertical directions is read from the memory M5. Thereafter, in Step P46, it is determined whether or not the current position of the line-width measuring camera 44 in the vertical directions is equal to the position of the line portion in the ink color ICm, to be measured by the line-width measuring camera, in the vertical directions. When the determination in Step P46 is YES, the process proceeds to Step P60. On the other hand, when the determination in Step P46 is NO, it is determined, in Step P47, whether or not the current position of the line-width measuring camera 44 in the vertical directions is lower than the position of the line portion in the ink color ICm, to be measured by the line-width measuring camera, in the vertical directions.

When the determination in Step P47 is YES, in Step P48, a normal rotation instruction is outputted to the motor driver for vertical movement for line-width measurement. Thereafter, in Step P49, the value of the counter for measuring the current position of the line-width measuring camera in the vertical directions is read, and is then stored in the memory M3.

In Step P50, the current position of the line-width measuring camera 44 in the vertical directions is calculated from the read value of the counter for measuring the current position of the line-width measuring camera in the vertical directions, and is then stored in the memory M4. Thereafter, in Step P51, the position of the line portion in the ink color ICm, to be measured by the line-width measuring camera, in the vertical directions is read from the memory M5.

In Step P52, it is determined whether or not the current position of the line-width measuring camera 44 in the vertical directions is equal to the position of the line portion in the ink color ICm, to be measured by the line-width measuring camera, in the vertical directions. When the determination in Step P52 is YES, in Step P53, the output of the normal rotation instruction to the motor driver for vertical movement for line-width measurement is stopped. Thereafter, the process proceeds to Step P60. On the other hand, when the determination in Step P52 is NO, the process returns to Step P49.

When the determination in Step P47 is NO, in Step P54, a reverse rotation instruction is outputted to the motor driver for vertical movement for line-width measurement. Thereafter, in Step P55, the value of the counter for measuring the current position of the line-width measuring camera in the vertical directions is read, and is then stored in the memory M3.

In Step P56, the current position of the line-width measuring camera 44 in the vertical directions is calculated from the read value of the counter for measuring the current position of the line-width measuring camera in the vertical directions, and is then stored in the memory M4. Thereafter, in Step P57, the position of the line portion in the ink color ICm, to be measured by the line-width measuring camera, in the vertical directions is read from the memory M5.

In Step P58, it is determined whether or not the current position of the line-width measuring camera 44 in the vertical directions is equal to the position of the line portion in the ink color ICm, to be measured by the line-width measuring camera, in the vertical directions. When the determination in Step P58 is YES, in Step P59, the output of the reverse rotation instruction to the motor driver for vertical movement for line-width measurement is stopped. Thereafter, the process proceeds to Step P60. On the other hand, when the determination in Step P58 is NO, the process returns to Step P55.

In Step P60, the value of the counter for measuring the current position of the line-width measuring camera in the horizontal directions is read, and is then stored in the memory M6. Thereafter, in Step P61, the current position of the line-width measuring camera 44 in the horizontal directions is calculated from the read value of the counter for measuring the current position of the line-width measuring camera in the horizontal directions, and is then stored in the memory M7.

In Step P62, the position of the line portion in the ink color ICm, to be measured by the line-width measuring camera, in the horizontal directions is read from the memory M8. Thereafter, in Step P63, it is determined whether or not the current position of the line-width measuring camera 44 in the horizontal directions is equal to the position of the line portion in the ink color ICm, to be measured by the line-width measuring camera, in the horizontal directions. When the determination in Step P63 is YES, the process proceeds to Step P77. On the other hand, when the determination in Step P63 is NO, it is determined, in Step P64, whether or not the current position of the line-width measuring camera 44 in the horizontal directions is smaller than the position of the line portion in the ink color ICm, to be measured by the line-width measuring camera, in the horizontal directions.

When the determination in Step P64 is YES, in Step P65, a normal rotation instruction is outputted to the motor driver for horizontal movement for line-width measurement. Thereafter, in Step P66, the value of the counter for measuring the current position of the line-width measuring camera in the horizontal directions is read, and is then stored in the memory M6.

In Step P67, the current position of the line-width measuring camera 44 in the horizontal directions is calculated from the read value of the counter for measuring the current position of the line-width measuring camera in the horizontal directions, and is then stored in the memory M7. Thereafter, in Step P68, the position of the line portion in the ink color ICm, to be measured by the line-width measuring camera, in the horizontal directions is read from the memory M8.

In Step P69, it is determined whether or not the current position of the line-width measuring camera 44 in the horizontal directions is equal to the position of the line portion in the ink color ICm, to be measured by the line-width measuring camera, in the horizontal directions. When the determination in Step P69 is YES, in Step P70, the output of the normal rotation instruction to the motor driver for horizontal movement for line-width measurement is stopped. Thereafter, the process proceeds to Step P77. On the other hand, when the determination in Step P69 is NO, the process returns to Step P66.

When the determination in Step P64 is NO, in Step P71, a reverse rotation instruction is outputted to the motor driver for horizontal movement for line-width measurement. Thereafter, in Step P72, the value of the counter for measuring the current position of the line-width measuring camera in the horizontal directions is read, and is then stored in the memory M6.

In Step P73, the current position of the line-width measuring camera 44 in the horizontal directions is calculated from the read value of the counter for measuring the current position of the line-width measuring camera in the horizontal directions, and is then stored in the memory M7. Thereafter, in Step P74, the position of the line portion in the ink color ICm, to be measured by the line-width measuring camera, in the horizontal directions is read from the memory M8.

In Step P75, it is determined whether or not the current position of the line-width measuring camera 44 in the horizontal directions is equal to the position of the line portion in the ink color ICm, to be measured by the line-width measuring camera, in the horizontal directions. When the determination in Step P75 is YES, in Step P76, the output of the reverse rotation instruction to the motor driver for horizontal movement for line-width measurement is stopped. Thereafter, the process proceeds to Step P77. On the other hand, when the determination in Step P75 is NO, the process returns to Step P72.

In Step P77, a measurement signal is outputted to the line-width measuring camera 44. Thereafter, in Step P78, a binary image signal is received from the line-width measuring camera 44, and is then stored in the address location for the ink color ICm, in the frame memory M10.

In Step P79, the count value M is incremented by 1, and is then overwritten with the resultant value in the memory M2. Thereafter, in Step P80, the total number Mmax of the printing units is read from the memory M9. Then, in Step P81, it is determined whether or not the count value M is larger than the total number Mmax of the printing units.

When the determination in Step P81 is YES, in Step P82, a reverse rotation instruction is outputted to the motor driver for horizontal movement for line-width measurement. On the other hand, when the determination in Step P81 is NO, the process returns to Step P43.

Through the above-described steps, the binary image signal of the line portion of each ink color ICm is received from the line-width measuring camera 44.

Next, when an output of the detector for detecting the home position of the line-width measuring camera 44 in the horizontal directions is turned on in Step P83, in Step P84, the output of the reverse rotation instruction to the motor driver for horizontal movement for line-width measurement is stopped. Thereafter, in Step P85, a reverse rotation instruction is outputted to the motor driver for vertical movement for line-width measurement.

When an output of the detector for detecting the home position of the line-width measuring camera 44 in the vertical directions is turned on in Step P86, the output of the reverse rotation instruction to the motor driver for vertical movement for line-width measurement is stopped in Step P87.

Next, in Step P88, 1 is written in the count value M. In Step P89, 1 is written in the count value Y. In Step P90, 1 is written in the count value X. Thereafter, in Step P91, 0 is written in the memory M13 for storing a count value C for line-width measurement.

In Step P92, the ink color ICm of the printing unit M is read. Then, in Step P93, an image data Ixy of the address (X,Y) for the ink color ICm is read from the frame memory M10. Thereafter, in Step P94, it is determined whether or not the image data Ixy is 1.

When the determination in Step P94 is YES, in Step P95, the count value C for line-width measurement is read. On the other hand, when the determination in Step P94 is NO, the process proceeds to Step P97. In Step P96, the count value C for line-width measurement is incremented by 1, and is then overwritten with the resultant value, in the memory M13 for storing the count value C for line-width measurement. Thereafter, in Step P97, the count value X is incremented by 1, and is then overwritten with the resultant value, in the memory M12.

In Step P98, the total number DPXmax of the pixels detected in the horizontal directions of the line-width measuring camera is read from the memory M14. Thereafter, in Step P99, it is determined whether or not the count value X is larger than the total number DPXmax of the pixels detected in the horizontal directions of the line-width measuring camera. When the determination in Step 99 is YES, in Step P100, the value is read from the memory M13 for storing the count value C for line-width measurement. On the other hand, when the determination in Step 99 is NO, the process returns to Step P92.

In Step P101, the Yth address location in the memory M15 for storing the line-width count value XCy of the line in the X directions is overwritten with the count value C for line-width measurement. Thereafter, in Step P102, the count value Y is incremented by 1, and is then overwritten with the resultant value, in the memory M11.

In Step P103, the total number DPYmax of the pixels detected in the vertical directions of the line-width measuring camera is read from the memory M16. Thereafter, in Step P104, it is determined whether or not the count value Y is larger than the total number DPYmax of the pixels detected in the vertical directions of the line-width measuring camera. When the determination in Step P104 is YES, in Step P105, the memory M39 for storing the total value XCS of the line-width count values XC1 to XCy on the lines in the X directions is initialized. On the other hand, when the determination in Step P104 is NO, the process returns to Step P90.

Through the above-described steps, the pixel numbers corresponding to the widths of the lines in the horizontal directions (X directions) are obtained, the lines being lined in the vertical directions (Y directions).

In Step P106, 1 is written in the count value Y. Then, in Step P107, the value of the Yth address location in the memory M15 for storing the line-width count values XCy of the line in the X directions is read. Thereafter, in Step P108, the total value XCS of the line-width count values XC1 to XCy on the lines in the X directions is read.

In Step P109, the value of the Yth address location in the memory M15 for storing the line-width count values XCy of the line in the X directions is added to the total value XCS of the line-width count values XC1 to XCy on the lines in the X directions. Then, the memory M39 for storing the total value XCS of the line-width count values XC1 to XCy on the lines in the X directions is overwritten with the resultant value. Thereafter, in Step P110, the count value Y is incremented by 1, and is then overwritten with the resultant value in the memory M11.

In Step P111, the total number DPYmax of the pixels detected in the vertical directions of the measuring camera is read. Thereafter, in Step P112, it is determined whether or not the count value Y is larger than the total number DPYmax of the pixels detected in the vertical directions of the measuring camera. When the determination in Step P112 is YES, in Step P113, the total value XCS of the line-width count values XC1 to XCy on the lines in the X directions is read. ON the other hand, when the determination in Step P112 is NO, the process returns to Step P107.

In Step P114, the total number DPYmax of the pixels detected in the vertical directions of the measuring camera is read. Thereafter, in Step P115, the total value XCS of the line-width count values XC1 to XCy on the lines in the X directions is divided by the total number DPYmax of the pixels detected in the vertical directions of the measuring camera. Thereby, the average value XCA of the line-width count values XC1 to XCy on the lines in the X directions is calculated, and is then stored in the memory M40.

Through the above-described steps, the number of pixels corresponding to the average line width of the line in the horizontal directions (X directions) is obtained.

In Step P116, the line width LW is calculated from the average value XCA of the line-width count values XC1 to XCy on the lines in the X directions, and is then stored in the memory M18. Thereafter, in Step P117, the reference line width LWF is read from the memory M19. Then, in Step P118, the line width difference LWD is calculated by subtracting the reference line width LWF from the line width LW, and is then stored in the memory M20.

In Step P119, the ink color ICm of the printing unit M is read from the memory M1. In Step P120, the conversion table between the line-width difference of the ink color ICm and a compensation amount of the nip pressure between the plate cylinder and each of the ink form rollers is read from the memory M21. Thereafter, in Step P121, the compensation amount of the nip pressure between the plate cylinder and each of the ink form rollers is obtained from the line width difference LWD by using the conversion table between the line-width difference of the ink color ICm and a compensation amount of the nip pressure between the plate cylinder and each of the ink form rollers, and is then stored in the address location for the printing unit M in the memory M22.

In Step P122, the conversion table between the line width difference of the ink color ICm and a compensation amount of the nip pressure between the plate cylinder and the blanket cylinder is read from the memory M23. Thereafter, in Step P123, the compensation amount of the nip pressure between the plate cylinder and the blanket cylinder is obtained from the line width difference LWD by using the conversion table between the line width difference of the ink color ICm and a compensation amount of the nip pressure between the plate cylinder and the blanket cylinder, and is then stored in the address location for the printing unit M in the memory M24.

In Step P124, the conversion table between the line width difference of the ink color ICm and a compensation amount of the printing pressure between the blanket cylinder and the impression cylinder is read from the memory M25. Thereafter, in Step P125, the compensation amount of the printing pressure between the blanket cylinder and the impression cylinder is obtained from the line width difference LWD by using the conversion table between the line width difference of the ink color ICm and a compensation amount of the printing pressure between the blanket cylinder and the impression cylinder, and is then stored in the address location for the printing unit M in the memory M26.

In Step P126, an output of the A/D convertor 46 connected to the potentiometer 47 for the motor for adjusting the nip pressure between the plate cylinder and each of the ink form rollers of the printing unit M is read, and is then stored in the address location for the printing unit M in the memory M27. Thereafter, in Step P127, the current nip pressure between the plate cylinder and each of the ink form rollers of the printing unit M is calculated from the output of the A/D convertor connected to the potentiometer for the motor for adjusting the nip pressure between the plate cylinder and each of the ink form rollers of the printing unit M, and is then stored in the address location for the printing unit M in the memory M28.

In Step P128, the compensation amount of the nip pressure between the plate cylinder and each of the ink form rollers of the printing unit M is read from the memory M22. Thereafter, in Step P129, it is determined whether the compensation amount of the nip pressure between the plate cylinder and each of the ink form rollers of the printing unit M is not 0. When the determination in Step P129 is NO, it is determined, in Step P130, whether or not the compensation amount of the nip pressure between the plate cylinder and each of the ink form rollers of the printing unit M is larger than 0. On the other hand, when the determination in Step P129 is YES, the process proceeds to Step P143.

When the determination in Step P130 is YES, in Step P131, the compensation amount of the nip pressure between the plate cylinder and each of the ink form rollers of the printing unit M is added to the current nip pressure between the plate cylinder and each of the ink form rollers of the printing unit M. Thereby, the target nip pressure between the plate cylinder and each of the ink form rollers of the printing unit M is calculated, and is then stored in the address location for the printing unit M in the memory M29. Thereafter, in Step P132, the target output of the A/D convertor connected to the potentiometer for the motor for adjusting the nip pressure between the plate cylinder and each of the ink form rollers of the printing unit M is calculated from the target nip pressure between the plate cylinder and each of the ink form rollers of the printing unit M, and is then stored in the address location for the printing unit M in the memory M30.

In Step P133, a normal rotation instruction is outputted to the motor driver 45 for adjusting the nip pressure between the plate cylinder and each of the ink form rollers of the printing unit M. Thereafter, in Step P134, the output of the A/D convertor 46 connected to the potentiometer 47 for the motor for adjusting the nip pressure between the plate cylinder and each of the ink form rollers of the printing unit M is read, and is then stored in the address location for the printing unit M in the memory M27.

In Step P135, it is determined whether or not the output of the A/D convertor connected to the potentiometer for the motor for adjusting the nip pressure between the plate cylinder and each of the ink form rollers of the printing unit M is equal to the target output of the A/D convertor connected to the potentiometer for the motor for adjusting the nip pressure between the plate cylinder and each of the ink form rollers of the printing unit M. When the determination in Step P135 is YES, in Step P136, the output of the normal rotation instruction to the motor driver 45 for adjusting the nip pressure between the plate cylinder and each of the ink form rollers of the printing unit M is stopped. Thereafter, the process proceeds to Step P143. On the other hand, when the determination in Step P135 is NO, the process returns to Step P134.

When the determination in Step P130 is NO, on the other hand, in Step P137, the compensation amount of the nip pressure between the plate cylinder and each of the ink form rollers of the printing unit M is added to the current nip pressure between the plate cylinder and each of the ink form rollers of the printing unit M. Thereby, the target nip pressure between the plate cylinder and each of the ink form rollers of the printing unit M is calculated, and is then stored in the address location for the printing unit M in the memory M29. Thereafter, in Step P138, the target output of the A/D convertor connected to the potentiometer for the motor for adjusting the nip pressure between the plate cylinder and each of the ink form rollers of the printing unit M is calculated from the target nip pressure between the plate cylinder and each of the ink form rollers of the printing unit M, and is then stored in the address location for the printing unit M in the memory M30.

In Step P139, a reverse rotation instruction is outputted to the motor driver 45 for adjusting the nip pressure between the plate cylinder and each of the ink form rollers of the printing unit M. Thereafter, in Step P140, the output of the A/D convertor 46 connected to the potentiometer 47 for the motor for adjusting the nip pressure between the plate cylinder and each of the ink form rollers of the printing unit M is read, and is then stored in the address location for the printing unit M in the memory M27.

In Step P141, it is determined whether or not the output of the A/D convertor connected to the potentiometer for the motor for adjusting the nip pressure between the plate cylinder and each of the ink form rollers of the printing unit M is equal to the target output of the A/D convertor connected to the potentiometer for the motor for adjusting the nip pressure between the plate cylinder and each of the ink form rollers of the printing unit M. When the determination in Step P141 is YES, in Step P142, the output of the reverse rotation instruction to the motor driver 45 for adjusting the nip pressure between the plate cylinder and each of the ink form rollers of the printing unit M is stopped. Thereafter, the process proceeds to Step P143. On the other hand, when the determination in Step P141 is NO, the process returns to Step P140.

In Step P143, an output of the A/D converter 49 connected to the potentiometer 50 for the motor for adjusting the nip pressure between the plate cylinder and the blanket cylinder of the printing unit M is read, and is then stored in the address location for the printing unit M of the memory M31. Thereafter, in Step P144, the current nip pressure between the plate cylinder and the blanket cylinder of the printing unit M is calculated from the output of the A/D convertor connected to the potentiometer for the motor for adjusting the nip pressure between the plate cylinder and the blanket cylinder of the printing unit M, and is then stored in the address location for the printing unit M in the memory M32.

In Step P145, the compensation amount of the nip pressure between the plate cylinder and the blanket cylinder of the printing unit M is read from the memory M24. Thereafter, in Step P146, it is determined whether the compensation amount of the nip pressure between the plate cylinder and the blanket cylinder of the printing unit M is not 0. When the determination in Step P146 is NO, it is determined, in Step P147, whether or not the compensation amount of the nip pressure between the plate cylinder and the blanket cylinder of the printing unit M is larger than 0. When the determination in step P146 is YES, the process proceeds to Step P160.

When the determination in Step P147 is YES, in Step P148, the compensation amount of the nip pressure between the plate cylinder and the blanket cylinder of the printing unit M is added to the current nip pressure between the plate cylinder and the blanket cylinder of the printing unit M. Thereby, the target nip pressure between the plate cylinder and the blanket cylinder of the printing unit M is calculated, and is then stored in the address location for the printing unit M in the memory M33. Thereafter, in Step P149, the target output of the A/D convertor connected to the potentiometer for the motor for adjusting the nip pressure between the plate cylinder and the blanket cylinder of the printing unit M is calculated from the target nip pressure between the plate cylinder and the blanket cylinder of the printing unit M, and is then stored in the address location for the printing unit M in the memory M34.

In Step P150, a normal rotation instruction is outputted to the motor driver 48 for adjusting the nip pressure between the plate cylinder and the blanket cylinder of the printing unit M. Thereafter, in Step P151, the output of the A/D convertor 49 connected to the potentiometer 50 for the motor for adjusting the nip pressure between the plate cylinder and the blanket cylinder of the printing unit M is read, and is then stored in the address location for the printing unit M in the memory M31.

In Step P152, it is determined whether or not the output of the A/D convertor connected to the potentiometer for the motor for adjusting the nip pressure between the plate cylinder and the blanket cylinder of the printing unit M is equal to the target output of the A/D convertor connected to the potentiometer for the motor for adjusting the nip pressure between the plate cylinder and the blanket cylinder of the printing unit M. When the determination in Step P152 is YES, in Step P153, the output of the normal rotation instruction to the motor driver 48 for adjusting the nip pressure between the plate cylinder and the blanket cylinder of the printing unit M is stopped. Thereafter, the process proceeds to Step P160. On the other hand, when the determination in Step P152 is NO, the process returns to Step P151.

When the determination in Step P147 is NO, on the other hand, in Step P154, the compensation amount of the nip pressure between the plate cylinder and the blanket cylinder of the printing unit M is added to the current nip pressure between the plate cylinder and the blanket cylinder of the printing unit M. Thereby, the target nip pressure between the plate cylinder and the blanket cylinder of the printing unit M is calculated, and is then stored in the address location for the printing unit M in the memory M33. Thereafter, in Step P155, the target output of the A/D convertor connected to the potentiometer for the motor for adjusting the nip pressure between the plate cylinder and the blanket cylinder of the printing unit M is calculated from the target nip pressure between the plate cylinder and the blanket cylinder of the printing unit M, and is then stored in the address location for the printing unit M in the memory M34.

In Step P156, a reverse rotation instruction is outputted to the motor driver 48 for adjusting the nip pressure between the plate cylinder and the blanket cylinder of the printing unit M. Thereafter, in Step P157, the output of the A/D convertor 49 connected to the potentiometer 50 for the motor for adjusting the nip pressure between the plate cylinder and the blanket cylinder of the printing unit M is read, and is then stored in the address location for the printing unit M in the memory M31.

In Step P158, it is determined whether or not the output of the A/D convertor connected to the potentiometer for the motor for adjusting the nip pressure between the plate cylinder and the blanket cylinder of the printing unit M is equal to the target output of the A/D convertor connected to the potentiometer for the motor for adjusting the nip pressure between the plate cylinder and the blanket cylinder of the printing unit M. When the determination in Step P158 is YES, in Step P159, the output of the reverse rotation instruction to the motor driver 48 for adjusting the nip pressure between the plate cylinder and the blanket cylinder of the printing unit M is stopped. Thereafter, the process proceeds to Step P160. On the other hand, when the determination in Step P158 is NO, the process returns to Step P157.

In Step P160, an output of the A/D converter 52 connected to the potentiometer 53 for the motor for adjusting the printing pressure between the blanket cylinder and the impression cylinder of the printing unit M is read, and is then stored in the address location for the printing unit M of the memory M35. Thereafter, in Step P161, the current printing pressure between the blanket cylinder and the impression cylinder of the printing unit M is calculated from the output of the A/D convertor connected to the potentiometer for the motor for adjusting the printing pressure between the blanket cylinder and the impression cylinder of the printing unit M, and is then stored in the address location for the printing unit M in the memory M36.

In Step P162, the compensation amount of the printing pressure between the blanket cylinder and the impression cylinder of the printing unit M is read from the memory M26. Thereafter, in Step P163, it is determined whether the compensation amount of the printing pressure between the blanket cylinder and the impression cylinder of the printing unit M is not 0. When the determination in Step P163 is NO, it is determined, in Step P164, whether or not the compensation amount of the printing pressure between the blanket cylinder and the impression cylinder of the printing unit M is larger than 0. When the determination in Step P163 is YES, the process proceeds to Step P177.

When the determination in Step P164 is YES, in Step P165, the compensation amount of the printing pressure between the blanket cylinder and the impression cylinder of the printing unit M is added to the current printing pressure between the blanket cylinder and the impression cylinder of the printing unit M. Thereby, the target printing pressure between the blanket cylinder and the impression cylinder of the printing unit M is calculated, and is then stored in the address location for the printing unit M in the memory M37. Thereafter, in Step P166, the target output of the A/D convertor connected to the potentiometer for the motor for adjusting the printing pressure between the blanket cylinder and the impression cylinder of the printing unit M is calculated from the target printing pressure between the blanket cylinder and the impression cylinder of the printing unit M, and is then stored in the address location for the printing unit M in the memory M38.

In Step P167, a normal rotation instruction is outputted to the motor driver 51 for adjusting the printing pressure between the blanket cylinder and the impression cylinder of the printing unit M. Thereafter, in Step P168, the output of the A/D convertor 52 connected to the potentiometer 53 for the motor for adjusting the printing pressure between the blanket cylinder and the impression cylinder of the printing unit M is read, and is then stored in the address location for the printing unit M in the memory M35.

In Step P169, it is determined whether or not the output of the A/D convertor connected to the potentiometer for the motor for adjusting the printing pressure between the blanket cylinder and the impression cylinder of the printing unit M is equal to the target output of the A/D convertor connected to the potentiometer for the motor for adjusting the printing pressure between the blanket cylinder and the impression cylinder of the printing unit M. When the determination in Step P169 is YES, in Step P170, the output of the normal rotation instruction to the motor driver 51 for adjusting the printing pressure between the blanket cylinder and the impression cylinder of the printing unit M is stopped. Thereafter, the process proceeds to Step P177. On the other hand, when the determination in Step P169 is NO, the process returns to Step P168.

When the determination in Step P164 is NO, on the other hand, in Step P171, the compensation amount of the printing pressure between the blanket cylinder and the impression cylinder of the printing unit M is added to the current printing pressure between the blanket cylinder and the impression cylinder of the printing unit M. Thereby, the target printing pressure between the blanket cylinder and the impression cylinder of the printing unit M is calculated, and is then stored in the address location for the printing unit M in the memory M37. Thereafter, in Step P172, the target output of the A/D convertor connected to the potentiometer for the motor for adjusting the printing pressure between the blanket cylinder and the impression cylinder of the printing unit M is calculated from the target printing pressure between the blanket cylinder and the impression cylinder of the printing unit M, and is then stored in the address location for the printing unit M in the memory M38.

In Step P173, a reverse rotation instruction is outputted to the motor driver 51 for adjusting the printing pressure between the blanket cylinder and the impression cylinder of the printing unit M. Thereafter, in Step P174, the output of the A/D convertor 52 connected to the potentiometer 53 for the motor for adjusting the printing pressure between the blanket cylinder and the impression cylinder of the printing unit M is read, and is then stored in the address location for the printing unit M in the memory M35.

In Step P175, it is determined whether or not the output of the A/D convertor connected to the potentiometer for the motor for adjusting the printing pressure between the blanket cylinder and the impression cylinder of the printing unit M is equal to the target output of the A/D convertor connected to the potentiometer for the motor for adjusting the printing pressure between the blanket cylinder and the impression cylinder of the printing unit M. When the determination in Step P175 is YES, in Step P176, the output of the reverse rotation instruction to the motor driver 51 for adjusting the printing pressure between the blanket cylinder and the impression cylinder of the printing unit M is stopped. Thereafter, the process proceeds to Step P177. On the other hand, when the determination in Step P175 is NO, the process returns to Step P174.

In Step P177, the count value M is incremented by 1, and then is overwritten with the resultant value in the memory M2. Thereafter, in Step P178, the total number Mmax of the printing units is read from the memory M9. In Step P179, it is determined whether or not the count value M is larger than the total number Mmax of the printing units. When the determination in Step P179 is YES, the process returns to Step P1. On the other hand, when the determination in Step P179 is NO, the process returns to Step P89. Thereafter, this process is repeated.

As described above, in the second embodiment, the average width of the printed line portion is measured by the line-width measuring camera 44, and the control device 30 controls the drive of each of the motors 9, 18 and 24 on the basis of the measuring result, to automatically adjust the nip pressure between the plate cylinder and each of the ink form rollers, the nip pressure between the plate cylinder and the blanket cylinder, and the printing pressure between the blanket cylinder and the impression cylinder. With this configuration, as that of the first embodiment, it is possible to reduce the burden of the operator, and also to reduce the amount of waste paper to be produced, by preventing errors in manual adjustment.

### Third Embodiment

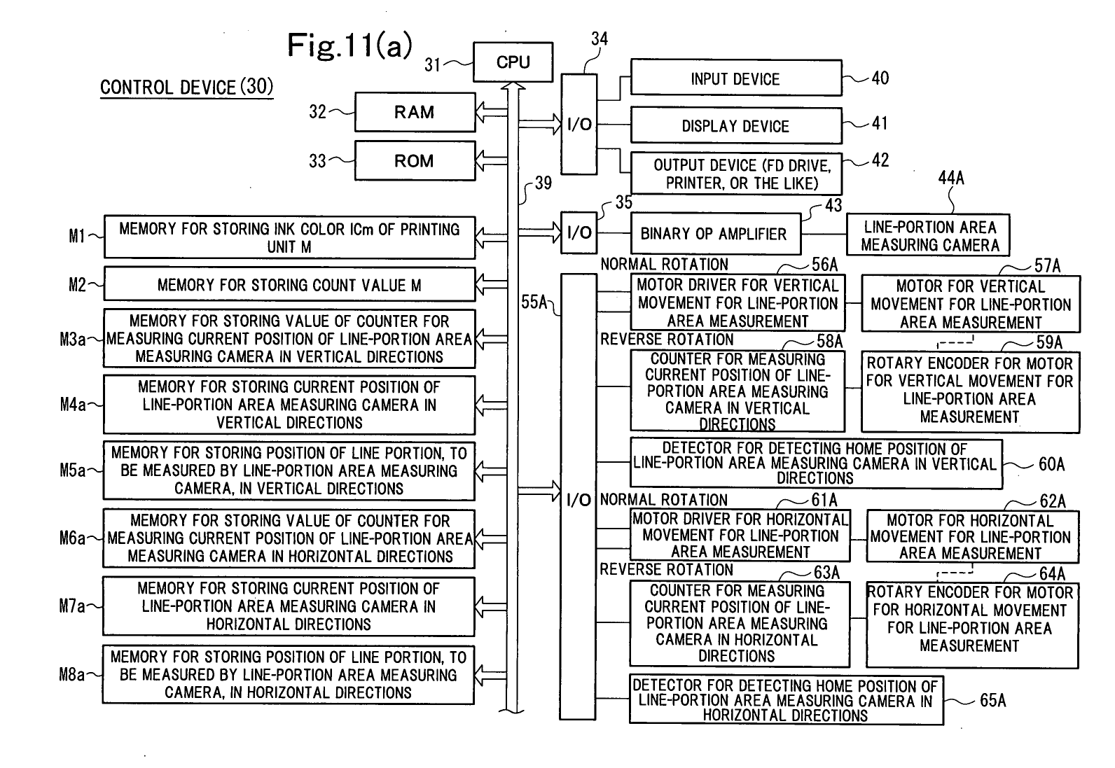

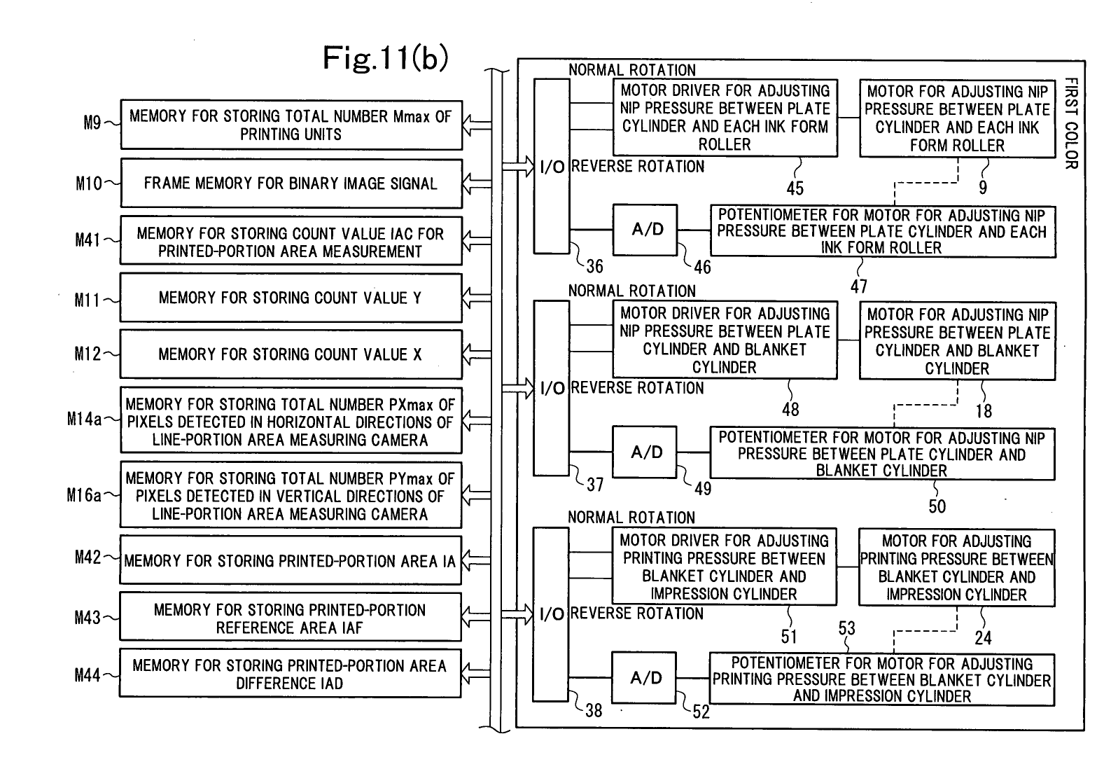

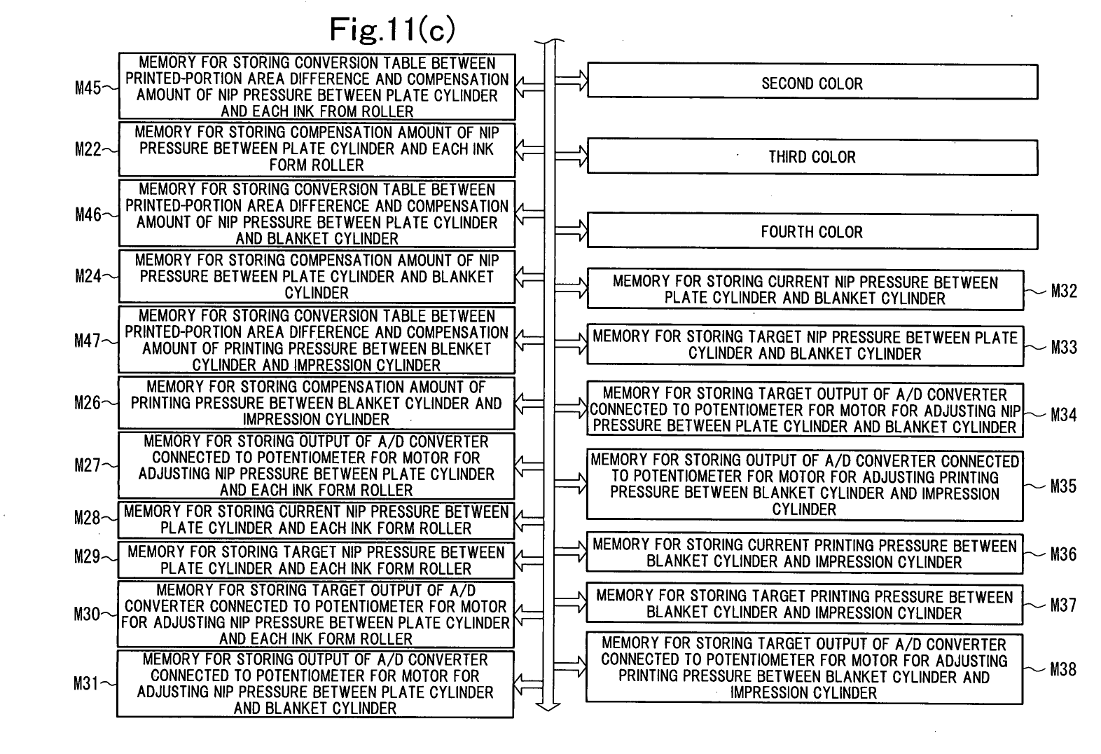

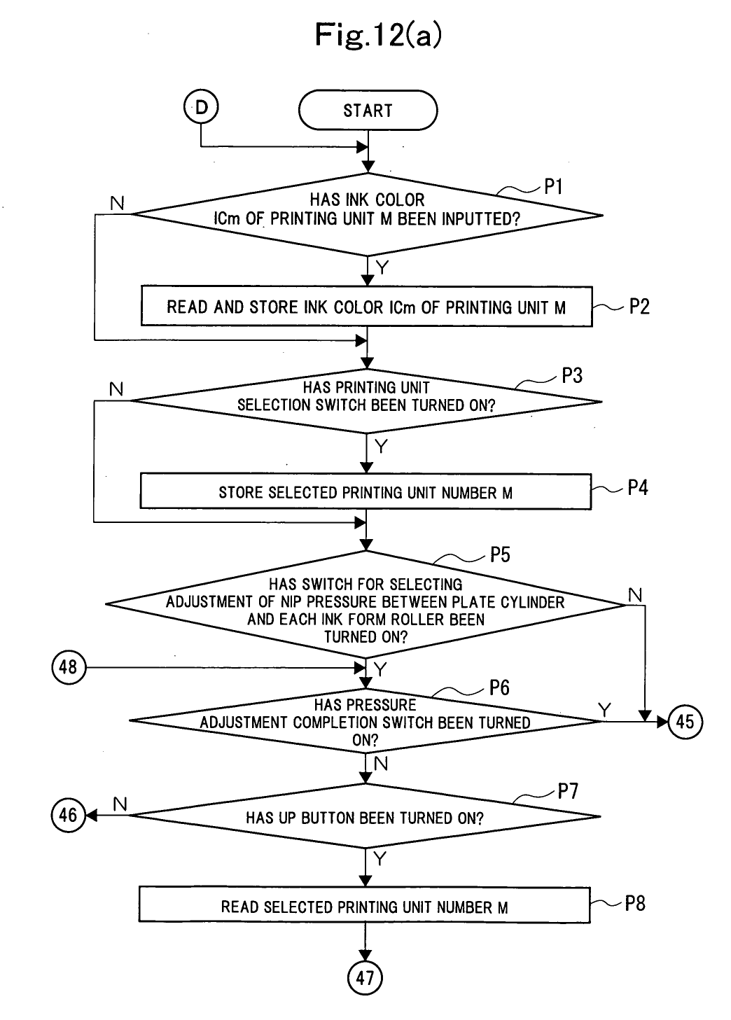

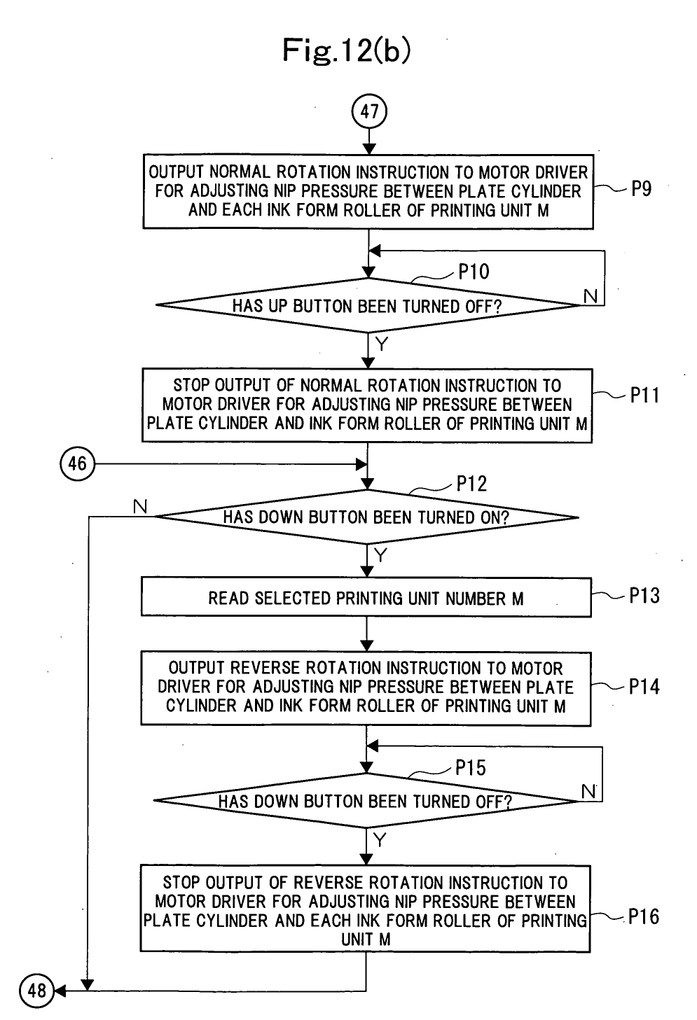

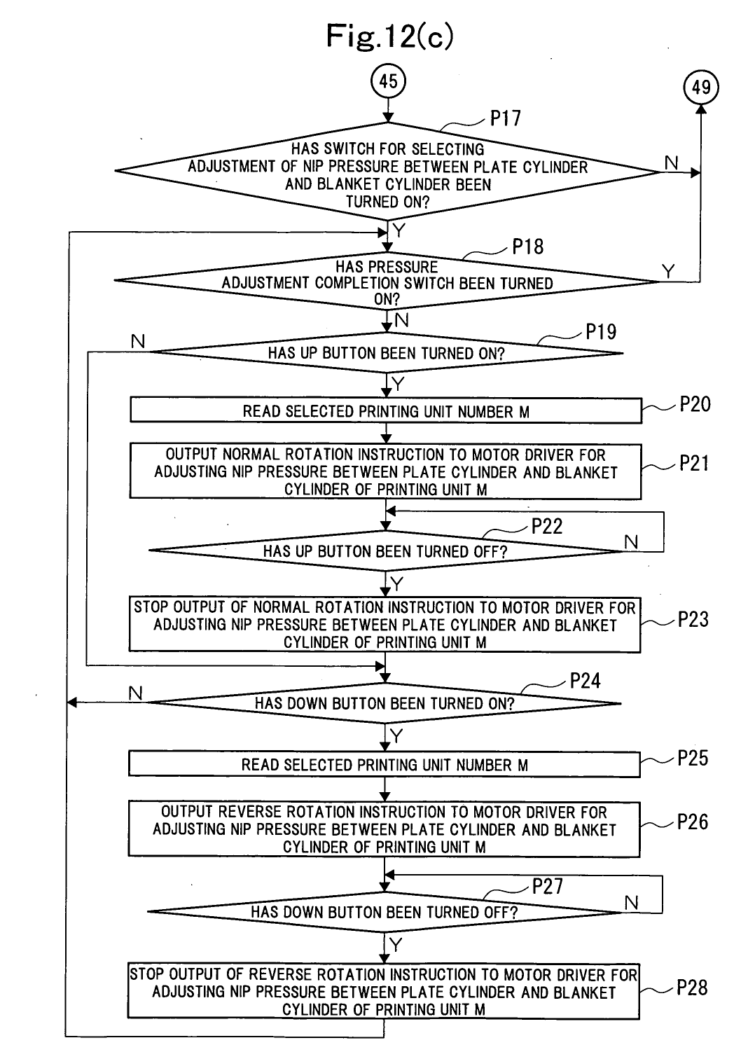

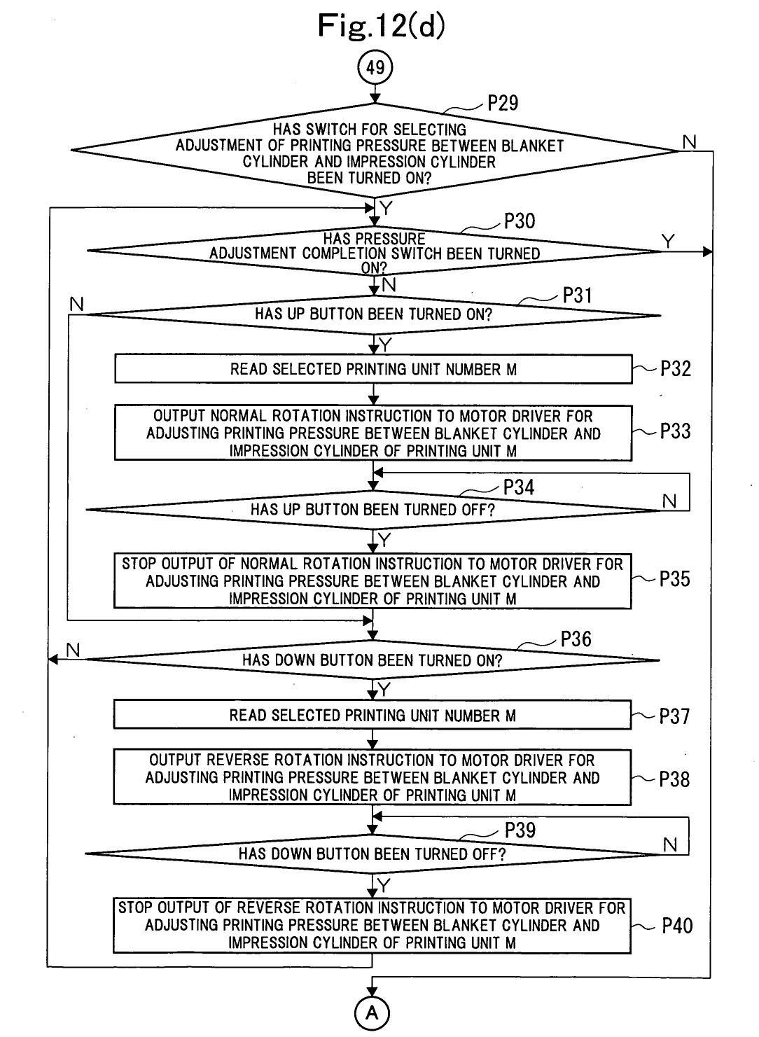

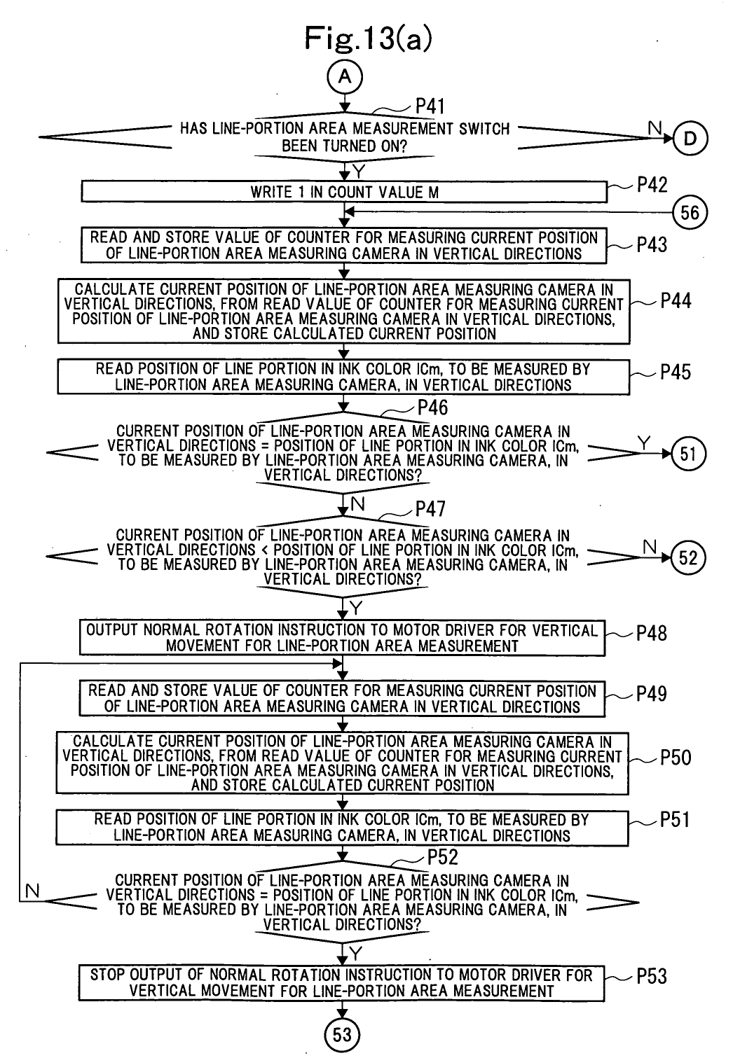

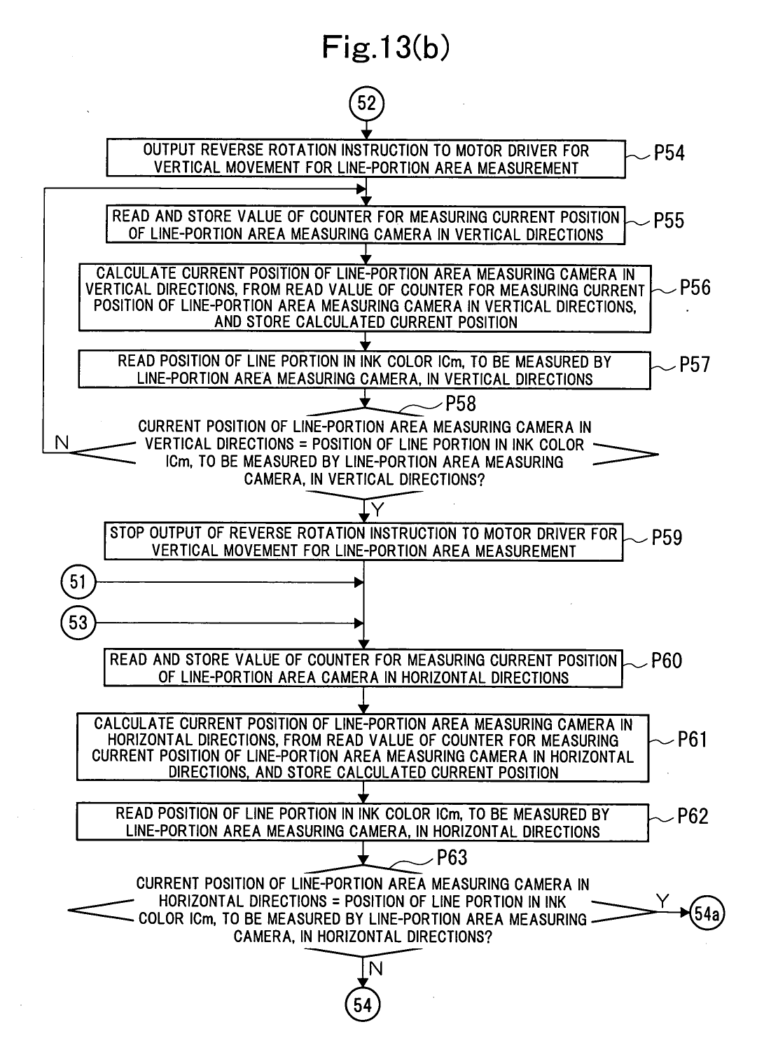

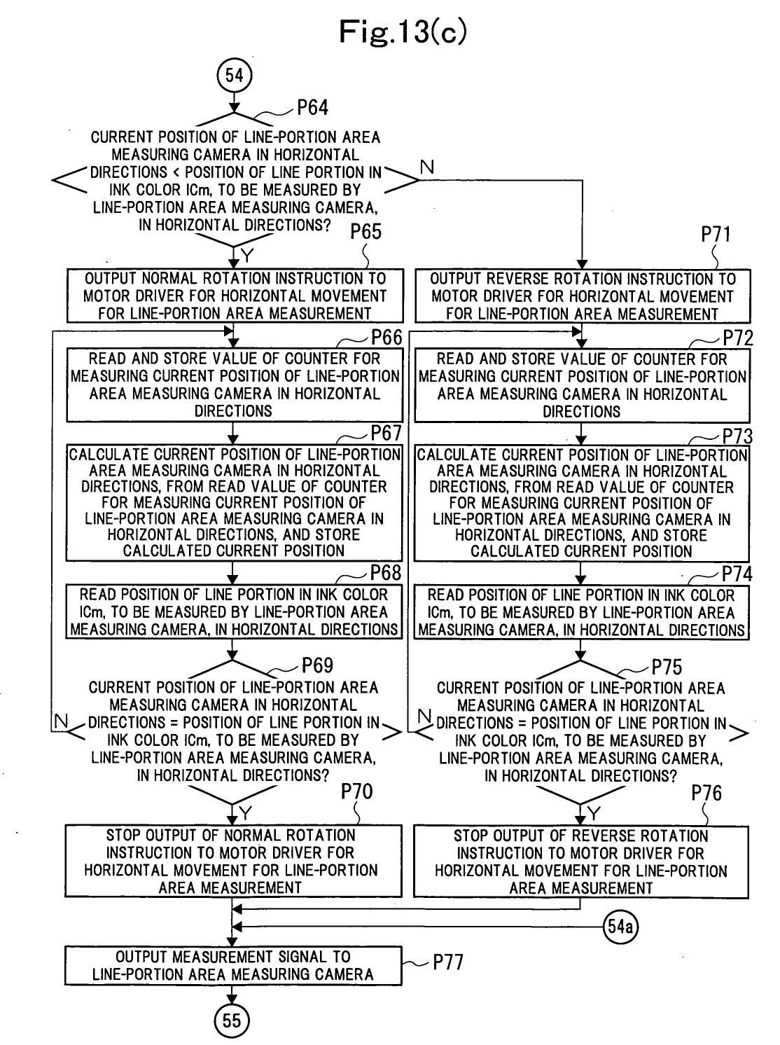

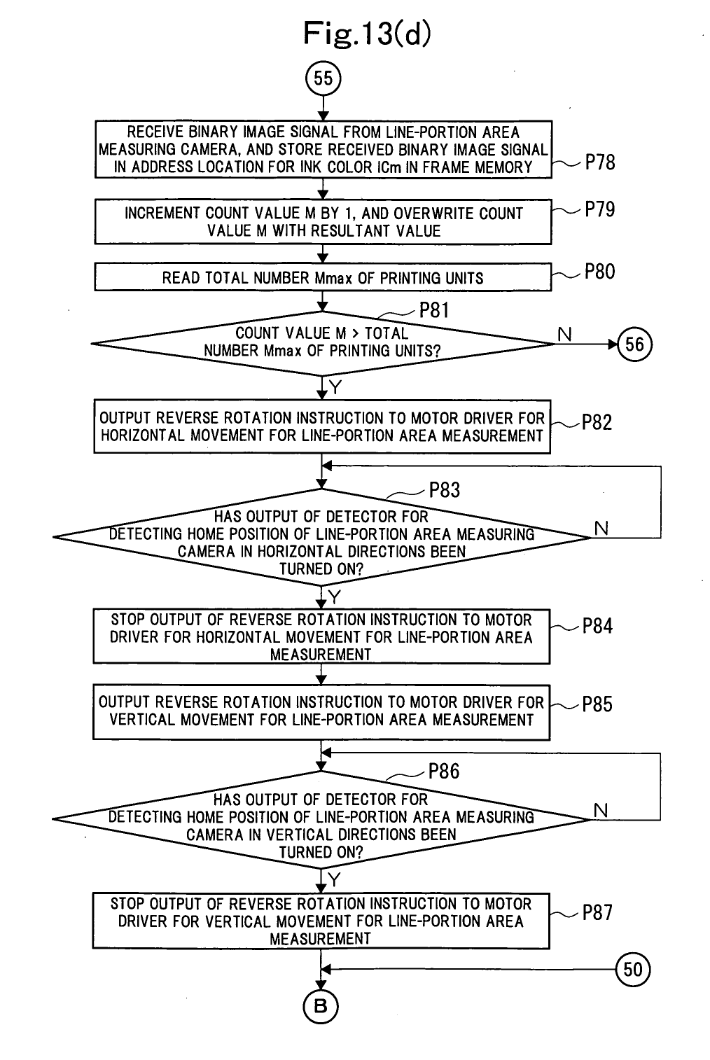

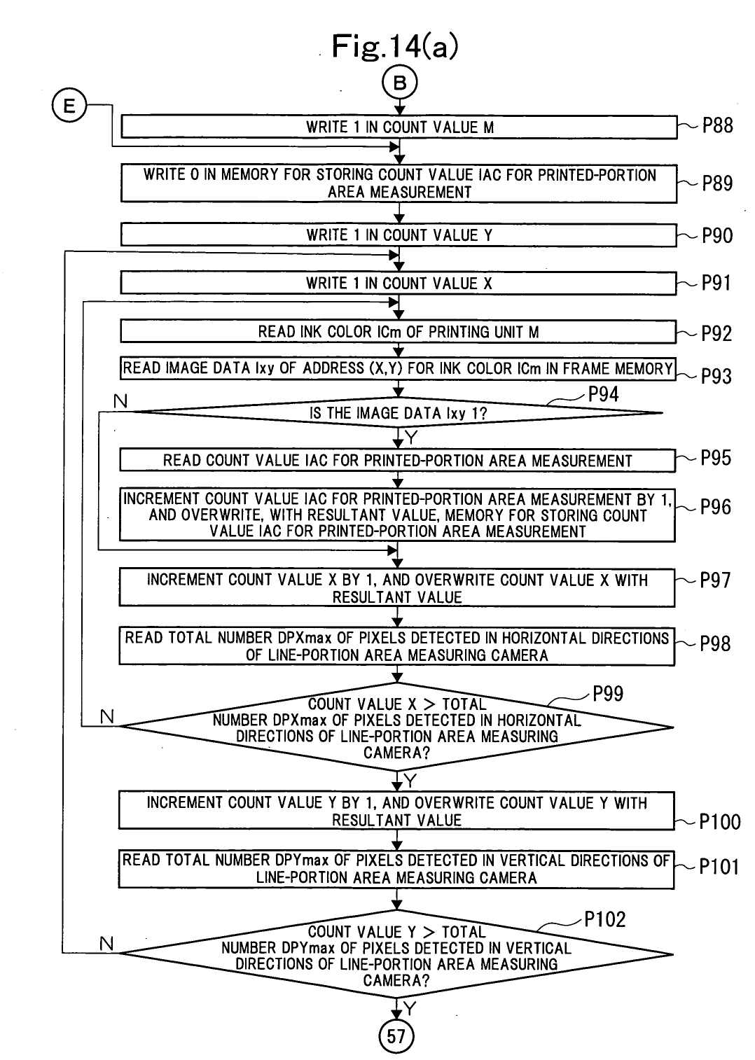

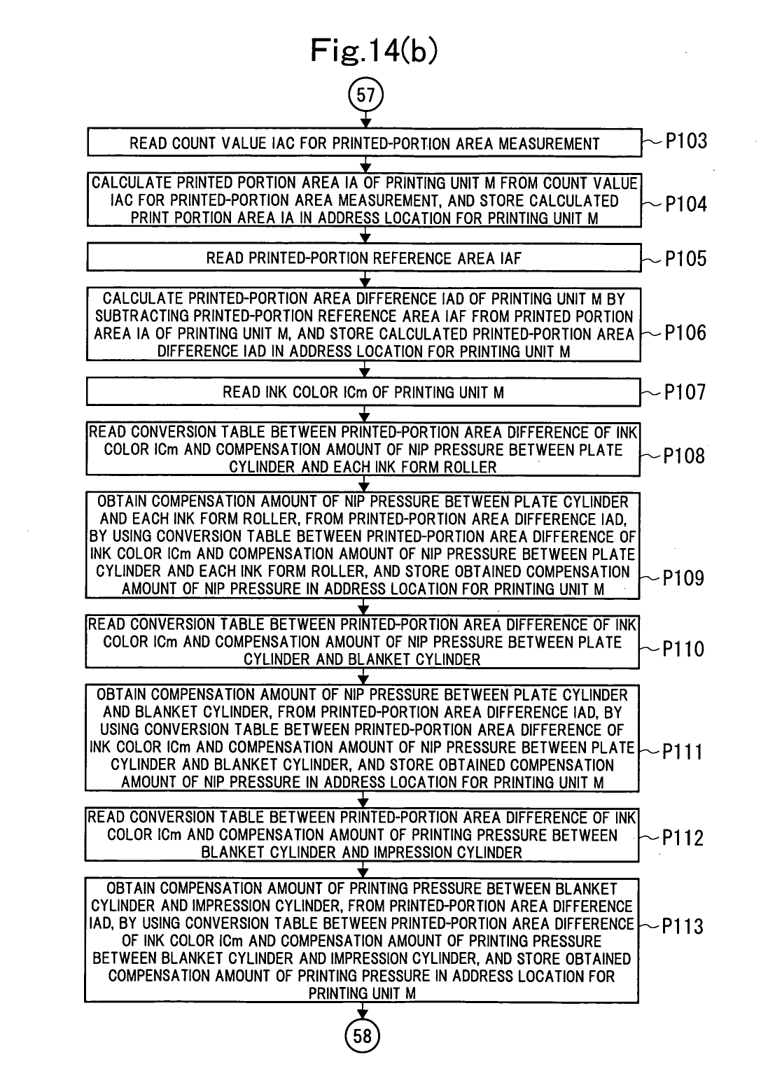

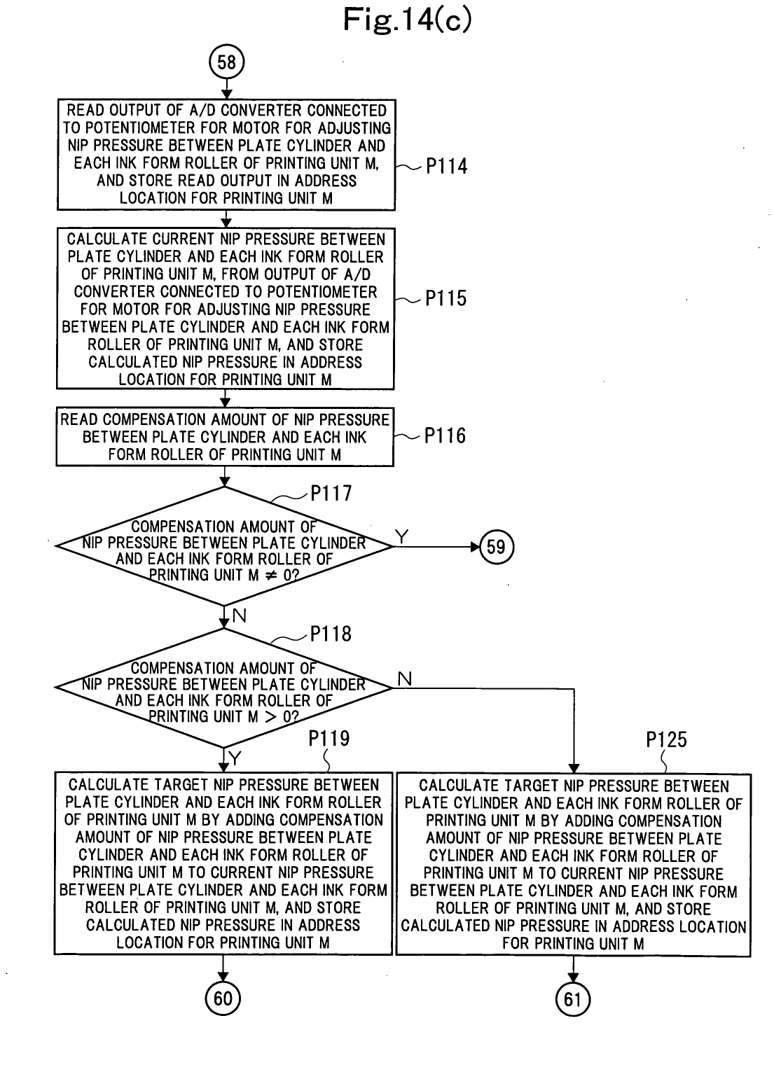

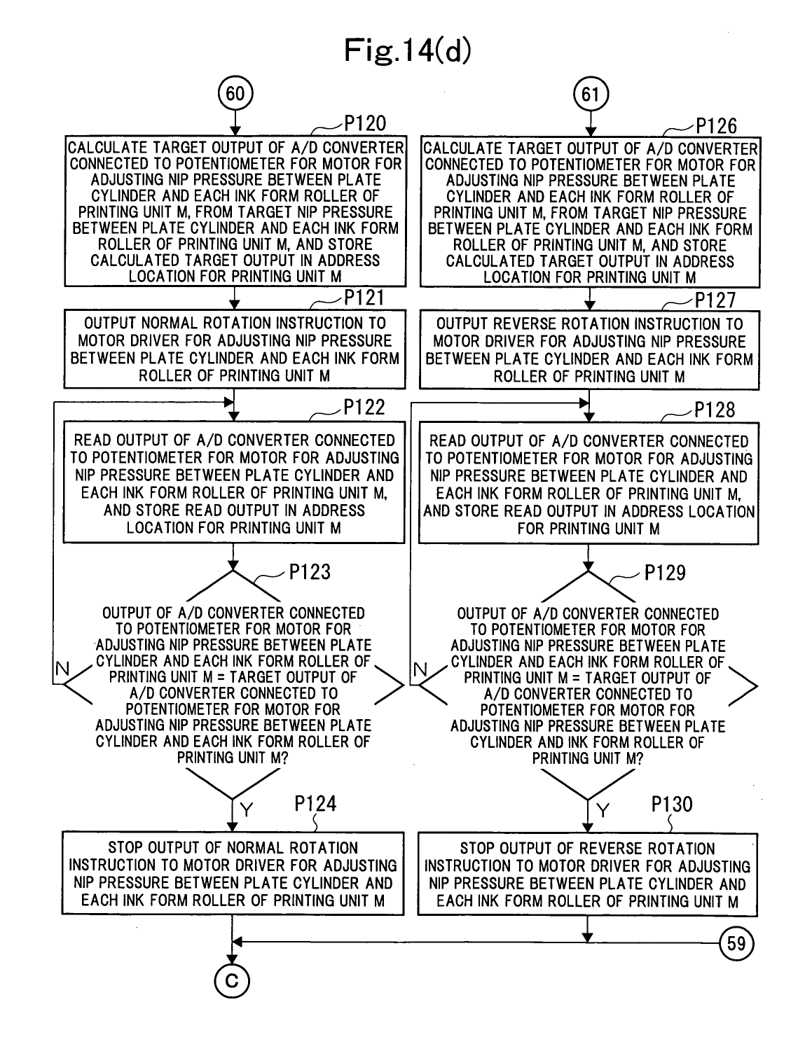

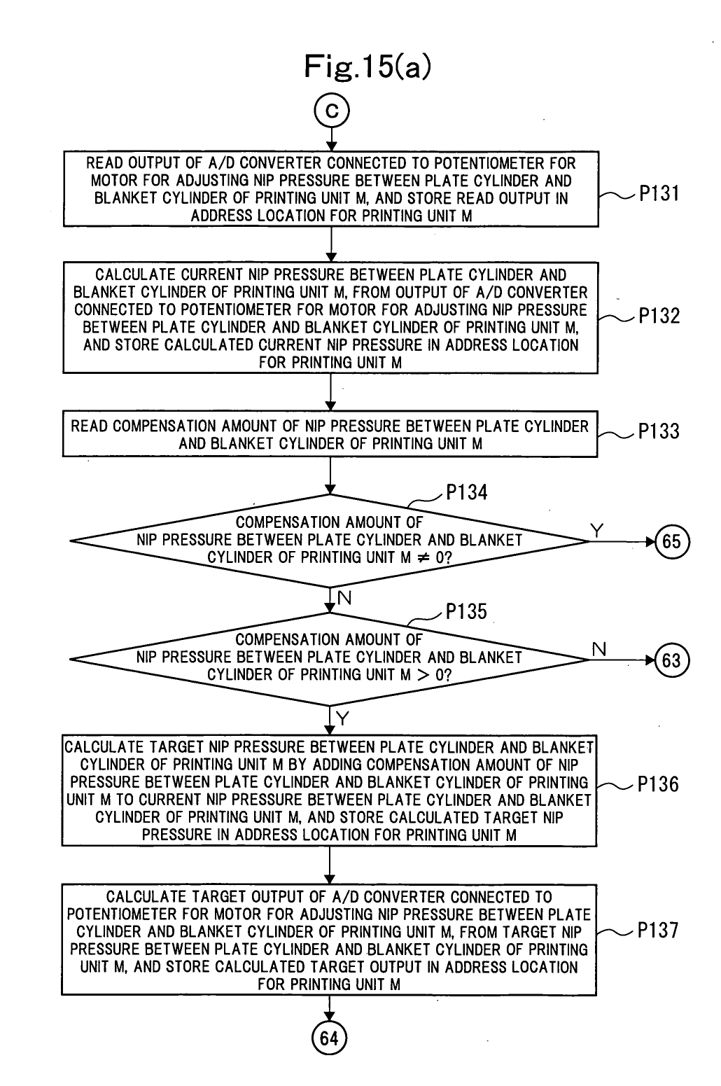

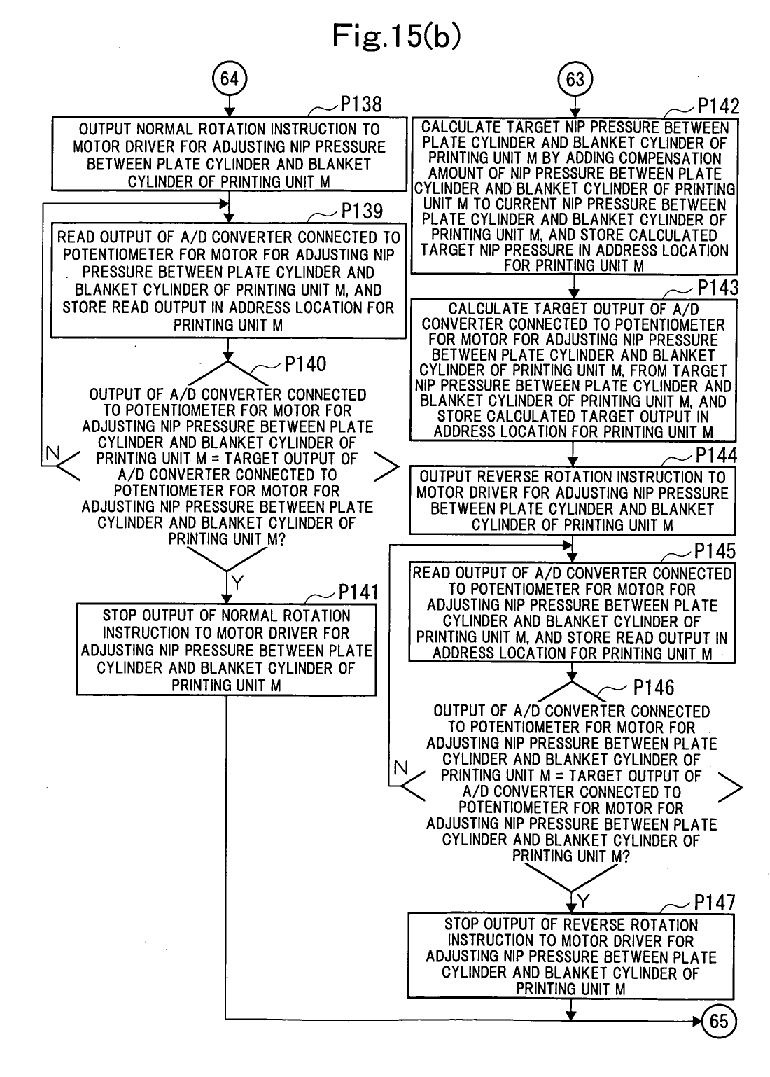

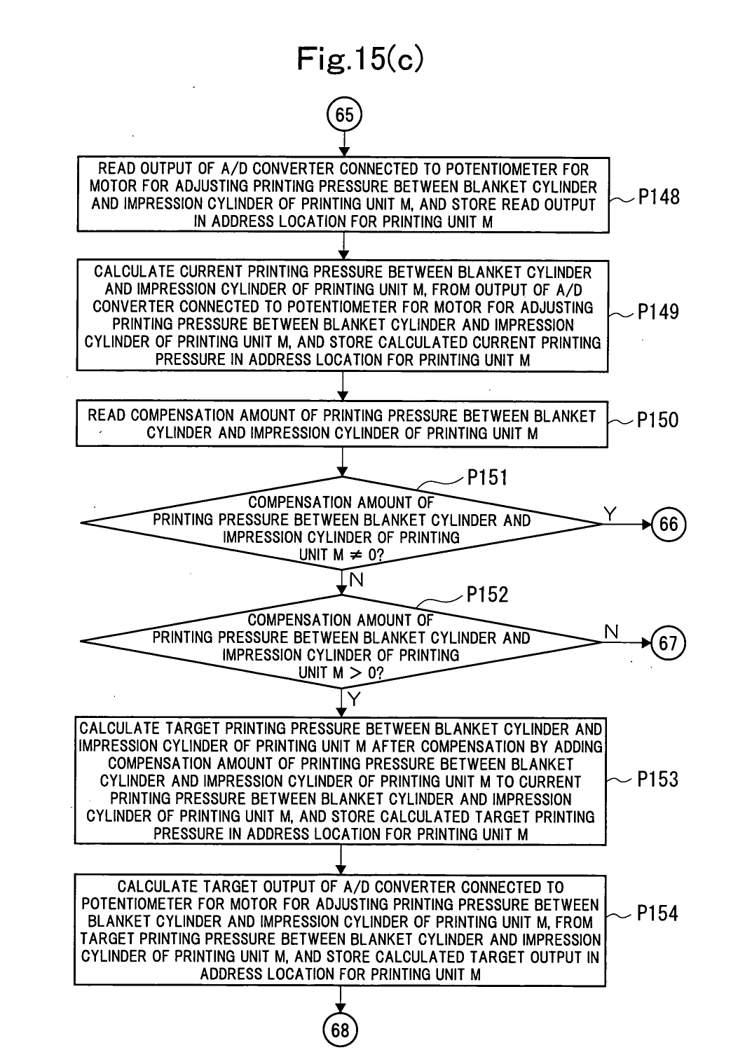

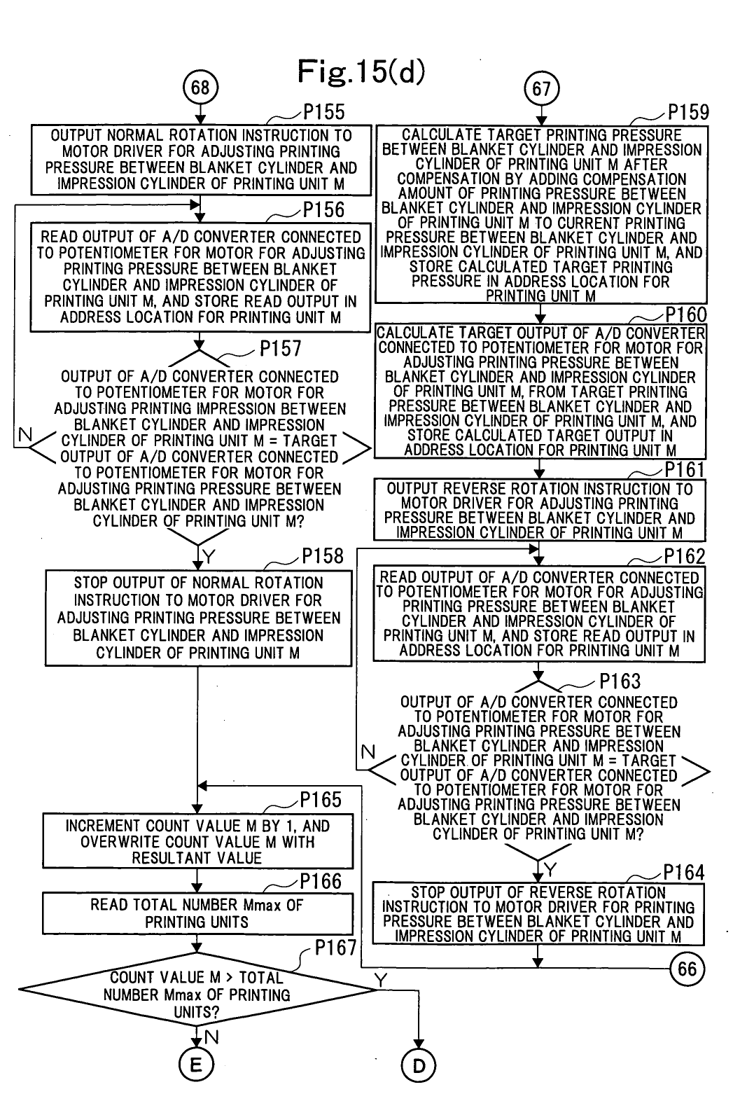

FIGS. 11(a) to 11(c) are control block diagrams of a control device showing a third embodiment of the present invention. FIGS. 12(a) to 12(d), FIGS. 13(a) to 13(d), FIGS. 14(a) to 14(d), and FIGS. 15(a) to 15(d) are operation flowcharts of the control device.

The third embodiment is an example in which the control device 30 according to the first embodiment or the second embodiment automatically adjusts the nip pressure between the plate cylinder and each of the ink form rollers, the nip pressure between the plate cylinder and the blanket cylinder, and the printing pressure between the blanket cylinder and the impression cylinder, on the basis of the area of the printed line portion (printed portion), instead of the maximum width or the mean width of the line portion.

As shown in FIGS. 11(a) to 11(c), in the control device 30, a CPU 31, a RAM 32, a ROM 33, and input/output (I/O) devices 34 to 38 and 55A are connected through a bus 39. Moreover, memories M1, M2, M3a, M4a, M5a, M6a, M7a, M8a, M9, and M10 are connected to the bus 39. In the memory M1, an ink color ICm of a printing unit M is stored. In the memory M2, a count value M is stored. In the memory M3a, a value of a counter for measuring the current position of a line-portion area measuring camera in the vertical directions is stored. In the memory M4a, the current position of the line-portion area measuring camera in the vertical directions is stored. In the memory M5a, the position of a line portion, to be measured by the line-portion area measuring camera, in the vertical directions is stored. In the memory M6a, a value of the counter for measuring the current position of the line-portion area measuring camera in the horizontal directions is stored. In the memory M7a, the current position of the line-portion area measuring camera in the horizontal directions is stored. In the memory M8a, the position of the line portion, to be measured by the line-portion area measuring camera, in the horizontal directions is stored. In the memory M9, the total number Mmax of printing units is stored. In the frame memory M10, a binary image signal is stored.

Moreover, memories M41, M11, M12, M14a, M16a, and M42 to M45 are also connected to the bus 39. In the memory M41, a count value IAC for printed-portion area measurement is stored. In the memory M11, a count value Y is stored. In the memory M12, a count value X is stored. In the memory M14a, the total number DPXmax of pixels detected in the horizontal directions of the line-portion area measuring camera is stored. In the memory M16a, the total number DPYmax of pixels detected in the vertical directions of the line-portion area measuring camera is stored. In the memory M42, a printed portion area IA is stored. In the memory M43, a printed-portion reference area IAF is stored. In the memory M44, a printed-portion area difference IAD is stored. In the memory M45, a conversion table between the printed-portion area difference and a compensation amount of the nip pressure between the plate cylinder and each of the ink form rollers is stored.

Furthermore, memories M22, M46, M24, M47, and M26 to M30 are also connected to the bus 39. In the memory M22, a compensation amount of the nip pressure between the plate cylinder and each of the ink form rollers is stored. In the memory M46, a conversion table between the printed-portion area difference and a compensation amount of the nip pressure between the plate cylinder and the blanket cylinder is stored. In the memory M24, a compensation amount of the nip pressure between the plate cylinder and the blanket cylinder is stored. In the memory M47, a conversion table between a printed-portion area difference and the compensation amount of the printing pressure between the blanket cylinder and the impression cylinder is stored. In the memory M26, a compensation amount of the printing pressure between the blanket cylinder and the impression cylinder is stored. In the memory M27, an output of an A/D converter connected to a potentiometer for a motor for adjusting the nip pressure between the plate cylinder and each of the ink form rollers is stored. In the memory M28, a current nip pressure between the plate cylinder and the ink form rollers is stored. In the memory M29, a target nip pressure between the plate cylinder and each of the ink form rollers is stored. In the memory M30, a target output of the A/D converter connected to the potentiometer for the motor for adjusting the nip pressure between the plate cylinder and each of the ink form rollers is stored.

Furthermore, memories M31 to M38 are also connected to the bus 39. In the memory M31, an output of an A/D converter connected to a potentiometer for a motor for adjusting the nip pressure between the plate cylinder and the blanket cylinder is stored. In the memory M32, a current nip pressure between the plate cylinder and the blanket cylinder is stored. In the memory M33, a target nip pressure between the plate cylinder and the blanket cylinder is stored. In the memory M34, a target output of the A/D converter connected to the potentiometer for the motor for adjusting the nip pressure between the plate cylinder and the blanket cylinder is stored. In the memory M35, an output of an A/D converter connected to a potentiometer for a motor for adjusting the printing pressure between the blanket cylinder and the impression cylinder is stored. In the memory M36, a current printing pressure between the blanket cylinder and the impression cylinder is stored. In the memory M37, a target printing pressure between the blanket cylinder and the impression cylinder is stored. In the memory M38, a target output of the A/D converter connected to the potentiometer for the motor for adjusting the printing pressure between the blanket cylinder and the impression cylinder is stored.

An input device 40 such as a keyboard, a display device 41 such as a CRT or a display, and an output device 42 such as a printer or a floppy disk (registered trademark) drive are connected to the I/O device 34. A line-portion area measuring camera (area measurement means) 44A for line-portion area measurement is connected to the I/O device 35 through a binary OP amplifier 43.

A motor 57A for vertical movement for line-portion area measurement is connected to the I/O device 55A through a motor driver 56A for vertical movement for line-portion area measurement. Moreover, a rotary encoder 59A for the motor for vertical movement for line-portion area measurement is also connected to the I/O device 55A through a counter 58A for measuring the current position of the line-portion area measuring camera in the vertical directions, the rotary encoder 59A being connected to and driven by the motor 57A. Furthermore, a detector 60A for detecting the home position of the line-portion area measuring camera in the vertical directions is also connected to the I/O device 55A.

In addition, a motor 62A for horizontal movement for line-portion area measurement is also connected to the I/O device 55A through a motor driver 61A for horizontal movement for line-portion area measurement. Moreover, a rotary encoder 64A for the motor for horizontal movement for line-portion area measurement is also connected to the I/O device 55A through a counter 63A for measuring the current position of the line-portion area measuring camera in the horizontal directions, the rotary encoder 64A being connected to and driven by the motor 62A. Furthermore, a detector 65A for detecting the home position of the line-portion area measuring camera in the horizontal directions is also connected to the I/O device 55A.

A motor 9 for adjusting the nip pressure between the plate cylinder and each of the ink form rollers is connected to the I/O device 36 through a motor driver 45 for adjusting the nip pressure between the plate cylinder and each of the ink form rollers. Moreover, a potentiometer 47 for the motor for adjusting the nip pressure between the plate cylinder and each of the ink form rollers is also connected to the I/O device 36 through an A/D convertor 46, the potentiometer 47 being connected to and driven by the motor 9.

A motor 18 for adjusting the nip pressure between the plate cylinder and the blanket cylinder is connected to the I/O device 37 through a motor driver 48 for adjusting the nip pressure between the plate cylinder and the blanket cylinder. Moreover, a potentiometer 50 for the motor for adjusting the nip pressure between the plate cylinder and the blanket cylinder is also connected to the I/O device 37 through an A/D converter 49, the potentiometer 50 being connected to and driven by the motor 18.

A motor 24 for adjusting the printing pressure between the blanket cylinder and the impression cylinder is connected to the I/O device 38 through a motor driver 51 for adjusting the printing pressure between the blanket cylinder and the impression cylinder. Moreover, a potentiometer 53 for the motor for adjusting the printing pressure between the blanket cylinder and the impression cylinder is also connected to the I/O device 38 through an A/D converter 52, the potentiometer 53 being connected to and driven by the motor 24.

The I/O devices 36 to 38 are configured as described above in a printing unit of the first color, and are configured in the same way also in printing units of the second to fourth colors. Accordingly, overlapping description is omitted herein.

In the third embodiment, the control device 30 is configured to be capable of automatically adjusting the nip pressure between the plate cylinder 3 and each of the ink form rollers 1, the nip pressure between the plate cylinder 3 and the blanket cylinder 17, and the printing pressure between the blanket cylinder 17 and the impression cylinder 20, on the basis of a measurement result obtained by the line-portion area measuring camera 44A serving as area measurement means for measuring the area of a line portion printed on the paper W.

The line-portion area measuring camera 44A is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 19(a) to 19(c), the line-portion area measuring camera 44A can directly measure the area of the line portion (the region indicated by hatching in each of FIGS. 19(a) to 19(c)) printed on the paper (print member) W placed on the main body of the checking apparatus. In FIGS. 19(a) to 19(c), LWF denotes a reference line width.

The control operation of the control device 30 configured as described above will be described below in detail on the basis of the operation flowcharts shown in FIGS. 12(a) to 12(d), FIGS. 13(a) to 13(d), FIGS. 14(a) to 14(d), and FIGS. 15(a) to 15(d).

In Step P1, it is determined whether or not the ink color ICm of the printing unit M has been inputted. When the determination in Step P1 is YES, in Step P2, the ink color ICm of the printing unit M is read, and is then stored in the memory M1. Thereafter, in Step P3, it is determined whether or not a printing unit selection switch has been turned on. When the determination in Step P1 is NO, the process proceeds directly to Step P3.

When the determination in Step P3 is YES, in Step P4, the selected printing unit number M is stored in the memory M2. Thereafter, in Step P5, it is determined whether or not a switch for selecting the adjustment of the nip pressure between the plate cylinder and each of the ink form rollers has been turned on. When the determination in Step P3 is NO, the process proceeds directly to Step P5.

When the determination in Step P5 is YES, it is determined, in Step P6, whether or not a pressure adjustment completion switch has been turned on. When the determination in Step P6 is YES, the process proceeds to Step P17. Then, in Step P17, it is determined whether or not a switch for selecting the adjustment of the nip pressure between the plate cylinder and the blanket cylinder has been turned on. When the determination in Step P5 is NO, the process proceeds directly to Step P17.

When the determination in Step P6 is NO, it is determined, in Step P7, whether or not an up button has been turned on. When the determination in Step P7 is YES, in Step P8, the selected printing unit number M is read from the memory M2. Thereafter, in Step P9, a normal rotation instruction is outputted to the motor driver 45 for adjusting the nip pressure between the plate cylinder and each of the ink form rollers of the printing unit M.

When the up button is turned off in Step P10, in Step P11, the output of the normal rotation instruction to the motor driver 45 for adjusting the nip pressure between the plate cylinder and each of the ink form rollers of the printing unit M is stopped. Thereafter, in Step P12, it is determined whether or not a down button has been turned on. When the determination in Step P7 is NO, the process proceeds directly to Step P12.

When the determination in Step P12 is YES, in Step P13, the selected printing unit number M is read from the memory M2. Thereafter, in Step P14, a reverse rotation instruction is outputted to the motor driver 45 for adjusting the nip pressure between the plate cylinder and each of the ink form rollers of the printing unit M. When the determination in Step P12 is NO, the process returns to Step P6.

When the down button is turned off in Step P15, in Step P16, the output of the reverse rotation instruction to the motor driver 45 for adjusting the nip pressure between the plate cylinder and each of the ink form rollers of the printing unit M is stopped. Thereafter, the process returns to Step P6.

When the determination in Step P17 is YES, it is determined, in Step P18, whether or not a pressure adjustment completion switch has been turned on. When the determination in Step P18 is YES, the process proceeds to Step P29. Then, in Step P29, it is determined whether or not a switch for selecting the adjustment of the printing pressure between the blanket cylinder and the impression cylinder has been turned on. When the determination in Step P17 is NO, the process proceeds directly to Step P29.

When the determination in Step P18 is NO, it is determined, in Step P19, whether or not an up button has been turned on. When the determination in Step P19 is YES, in Step P20, the selected printing unit number M is read from the memory M2. Thereafter, in Step P21, a normal rotation instruction is outputted to the motor driver 48 for adjusting the nip pressure between the plate cylinder and the blanket cylinder of the printing unit M.

When the up button is turned off in Step P22, in Step P23, the output of the normal rotation instruction to the motor driver 48 for adjusting the nip pressure between the plate cylinder and the blanket cylinder of the printing unit M is stopped. Thereafter, in Step P24, it is determined whether or not a down button has been turned on. When the determination in Step P19 is NO, the process proceeds directly to Step P24.

When the determination in Step P24 is YES, in Step P25, the selected printing unit number M is read from the memory M2. Thereafter, in Step P26, a reverse rotation instruction is outputted to the motor driver 48 for adjusting the nip pressure between the plate cylinder and the blanket cylinder of the printing unit M. When the determination in Step P24 is NO, the process returns to Step P18.

When the down button is turned off in Step P27, in Step P28, the output of the reverse rotation instruction to the motor driver 48 for adjusting the nip pressure between the plate cylinder and the blanket cylinder of the printing unit M is stopped. Thereafter, the process returns to Step P18.

When the determination in Step P29 is YES, it is determined, in Step P30, whether or not a pressure adjustment completion switch has been turned on. When the determination in Step P30 is YES, the process proceeds to Step P41. Then, in Step P41, it is determined whether or not a line-portion area measurement switch has been turned on. When the determination in Step P29 is NO, the process proceeds directly to Step P41.

When the determination in Step P30 is NO, it is determined, in Step P31, whether or not an up button has been turned on. When the determination in Step P31 is YES, in Step P32, the selected printing unit number M is read from the memory M2. Thereafter, in Step P33, a normal rotation instruction is outputted to the motor driver 51 for adjusting the printing pressure between the plate cylinder and the blanket cylinder of the printing unit M.

When the up button is turned off in Step P34, in Step P35, the output of the normal rotation instruction to the motor driver 51 for adjusting the printing pressure between the blanket cylinder and the impression cylinder of the printing unit M is stopped. Thereafter, in Step P36, it is determined whether or not a down button has been turned on. When the determination in Step P31 is NO, the process proceeds directly to Step P36.

When the determination in Step P36 is YES, in Step P37, the selected printing unit number M is read from the memory M2. Thereafter, in Step P38, a reverse rotation instruction is outputted to the motor driver 51 for adjusting the printing pressure between the blanket cylinder and the impression cylinder of the printing unit M. When the determination in Step P36 is NO, the process returns to Step P30.

When the down button is turned off in Step P39, the output of the reverse rotation instruction to the motor driver 51 for adjusting the printing pressure between the blanket cylinder and the impression cylinder of the printing unit M is stopped in Step P40. Thereafter, the process returns to Step P30.

In Step P41, it is determined whether or not a line-portion area measurement switch has been turned on. When the determination in Step P41 is YES, 1 is written in the count value M in Step P42. On the other hand, when the determination in Step P41 is NO, the process returns to Step P1.

In Step P43, the value of the counter for measuring the current position of the line-portion area measuring camera in the vertical directions is read, and is then stored in the memory M3a. Thereafter, in Step P44, the current position of the line-portion area measuring camera 44A in the vertical directions is calculated from the read value of the counter for measuring the current position of the line-portion area measuring camera in the vertical directions, and is then stored in the memory M4a.

In Step P45, the position of the line portion in the ink color ICm, to be measured by the line-portion area measuring camera, in the vertical directions is read from the memory M5a. Thereafter, in Step P46, it is determined whether or not the current position of the line-portion area measuring camera 44A in the vertical directions is equal to the position of the line portion in the ink color ICm, to be measured by the line-portion area measuring camera, in the vertical directions. When the determination in Step P46 is YES, the process proceeds to Step P60. On the other hand, when the determination in Step P46 is NO, it is determined, in Step P47, whether or not the current position of the line-portion area measuring camera 44A in the vertical directions is lower than the position of the line portion in the ink color ICm, to be measured by the line-portion area measuring camera, in the vertical directions.

When the determination in Step P47 is YES, in Step P48, a normal rotation instruction is outputted to the motor driver for vertical movement for line-portion area measurement. Thereafter, in Step P49, the value of the counter for measuring the current position of the line-portion area measuring camera in the vertical directions is read, and is then stored in the memory M3a.

In Step P50, the current position of the line-portion area measuring camera 44A in the vertical directions is calculated from the read value of the counter for measuring the current position of the line-portion area measuring camera in the vertical directions, and is then stored in the memory M4a. Thereafter, in Step P51, the position of the line portion in the ink color ICm, to be measured by the line-portion area measuring camera, in the vertical directions is read from the memory M5a.

In Step P52, it is determined whether or not the current position of the line-portion area measuring camera 44A in the vertical directions is equal to the position of the line portion in the ink color ICm, to be measured by the line-portion area measuring camera, in the vertical directions. When the determination in Step P52 is YES, in Step P53, the output of the normal rotation instruction to the motor driver for vertical movement for line-portion area measurement is stopped. Thereafter, the process proceeds to Step P60. On the other hand, when the determination in Step P52 is NO, the process returns to Step P49.

When the determination in Step P47 is NO, in Step P54, a reverse rotation instruction is outputted to the motor driver for vertical movement for line-portion area measurement. Thereafter, in Step P55, the value of the counter for measuring the current position of the line-portion area measuring camera in the vertical directions is read, and is then stored in the memory M3a.

In Step P56, the current position of the line-portion area measuring camera 44A in the vertical directions is calculated from the read value of the counter for measuring the current position of the line-portion area measuring camera in the vertical directions, and is then stored in the memory M4a. Thereafter, in Step P57, the position of the line portion in the ink color ICm, to be measured by the line-portion area measuring camera, in the vertical directions is read from the memory M5a.

In Step P58, it is determined whether or not the current position of the line-portion area measuring camera 44A in the vertical directions is equal to the position of the line portion in the ink color ICm, to be measured by the line-portion area measuring camera, in the vertical directions. When the determination in Step P58 is YES, in Step P59, the output of the reverse rotation instruction to the motor driver for vertical movement for line-portion area measurement is stopped. Thereafter, the process proceeds to Step P60. On the other hand, when the determination in Step P58 is NO, the process returns to Step P55.

In Step P60, the value of the counter for measuring the current position of the line-portion area measuring camera in the horizontal directions is read, and is then stored in the memory M6a. Thereafter, in Step P61, the current position of the line-portion area measuring camera 44A in the horizontal directions is calculated from the read value of the counter for measuring the current position of the line-portion area measuring camera in the horizontal directions, and is then stored in the memory M7a.

In Step P62, the position of the line portion in the ink color ICm, to be measured by the line-portion area measuring camera, in the horizontal directions is read from the memory M8a. Thereafter, in Step P63, it is determined whether or not the current position of the line-portion area measuring camera 44A in the horizontal directions is equal to the position of the line portion in the ink color ICm, to be measured by the line-portion area measuring camera, in the horizontal directions. When the determination in Step P63 is YES, the process proceeds to Step P77. On the other hand, when the determination in Step P63 is NO, it is determined, in Step P64, whether or not the current position of the line-portion area measuring camera 44A in the horizontal directions is smaller than the position of the line portion in the ink color ICm, to be measured by the line-portion area measuring camera, in the horizontal directions.

When the determination in Step P64 is YES, in Step P65, a normal rotation instruction is outputted to the motor driver for horizontal movement for line-portion area measurement. Thereafter, in Step P66, the value of the counter for measuring the current position of the line-portion area measuring camera in the horizontal directions is read, and is then stored in the memory M6a.

In Step P67, the current position of the line-portion area measuring camera 44A in the horizontal directions is calculated from the read value of the counter for measuring the current position of the line-portion area measuring camera in the horizontal directions, and is then stored in the memory M7a. Thereafter, in Step P68, the position of the line portion in the ink color ICm, to be measured by the line-portion area measuring camera, in the horizontal directions is read from the memory M8a.

In Step P69, it is determined whether or not the current position of the line-portion area measuring camera 44A in the horizontal directions is equal to the position of the line portion in the ink color ICm, to be measured by the line-portion area measuring camera, in the horizontal directions. When the determination in Step P69 is YES, in Step P70, the output of the normal rotation instruction to the motor driver for horizontal movement for line-portion area measurement is stopped. Thereafter, the process proceeds to Step P77. On the other hand, when the determination in Step P69 is NO, the process returns to Step P66.

When the determination in Step P64 is NO, in Step P71, a reverse rotation instruction is outputted to the motor driver for horizontal movement for line-portion area measurement. Thereafter, in Step P72, the value of the counter for measuring the current position of the line-portion area measuring camera in the horizontal directions is read, and is then stored in the memory M6a.

In Step P73, the current position of the line-portion area measuring camera 44A in the horizontal directions is calculated from the read value of the counter for measuring the current position of the line-portion area measuring camera in the horizontal directions, and is then stored in the memory M7a. Thereafter, in Step P74, the position of the line portion in the ink color ICm, to be measured by the line-portion area measuring camera, in the horizontal directions is read from the memory M8a.

In Step P75, it is determined whether or not the current position of the line-portion area measuring camera 44A in the horizontal directions is equal to the position of the line portion in the ink color ICm, to be measured by the line-portion area measuring camera, in the horizontal directions. When the determination in Step P75 is YES, in Step P76, the output of the reverse rotation instruction to the motor driver for horizontal movement for line-portion area measurement is stopped. Thereafter, the process proceeds to Step P77. On the other hand, when the determination in Step P75 is NO, the process returns to Step P72.

In Step P77, a measurement signal is outputted to the line-portion area measuring camera 44A. Thereafter, in Step P78, a binary image signal is received from the line-portion area measuring camera 44A, and is then stored in the address location for the ink color ICm in the frame memory M10.

In Step P79, the count value M is incremented by 1, and is then overwritten with the resultant value in the memory M2. Thereafter, in Step P80, the total number Mmax of the printing units is read from the memory M9. Then, in Step P81, it is determined whether or not the count value M is larger than the total number Mmax of the printing units.

When the determination in Step P81 is YES, in Step P82, a reverse rotation instruction is outputted to the motor driver for horizontal movement for line-portion area measurement. On the other hand, when the determination in Step P81 is NO, the process returns to Step P43.

When an output of the detector for detecting the home position of the line-portion area measuring camera 44A in the horizontal directions is turned on in Step P83, the output of the reverse rotation instruction to the motor driver for horizontal movement for line-portion area measurement is stopped in Step P84. In Step P85, a reverse rotation instruction is outputted to the motor driver for vertical movement for line-portion area measurement.

When an output of the detector for detecting the home position of the line-portion area measuring camera 44A in the vertical directions is turned on in Step P86, the output of the reverse rotation instruction to the motor driver for vertical movement for line-portion area measurement is stopped in Step P87.

Through the above-described steps, the binary image signal of the line portion of each ink color ICm is received from the line-portion area measuring camera 44A.

In Step P88, 1 is written in the count value M. Thereafter, in Step P89, 0 is written in the memory M41 for storing the count value IAC for the printed-portion area measurement. Then, in Step P90, 1 is written in the count value Y. Thereafter, in Step P91, 1 is written in the count value X.

In Step P92, the ink color ICm of the printing unit M is read from the memory M1. Thereafter, in Step P93, the image data Ixy of the address (X,Y) for the ink color ICm is read from the frame memory M10.

In Step P94, it is determined whether or not the image data Ixy is 1. When the determination in Step P94 is YES, in Step P95, the count value IAC for printed-portion area measurement is read from the memory M41. When the determination in Step P94 is NO, the process proceeds to Step P97.

In Step P96, the count value IAC for printed-portion area measurement is incremented by 1, and is then overwritten with the resultant value in the memory M41 for storing the count value IAC for printed-portion area measurement. Thereafter, in Step P97, the count value X is incremented by 1, and is then overwritten with the resultant value in the memory M12.

In Step P98, the total number DPXmax of the pixels detected in the horizontal directions of the line-portion area measuring camera is read from the memory M14a. Thereafter, in Step P99, it is determined whether or not the count value X is larger than the total number DPXmax of the pixels detected in the horizontal directions of the line-portion area measuring camera. When the determination in Step P99 is YES, in Step P100, the count value Y is incremented by 1, and is then overwritten with the resultant value in the memory M11. On the other hand, when the determination in Step P99 is NO, the process returns to Step P92.

In Step P101, the total number DPYmax of the pixels detected in the vertical directions of the line-portion area measuring camera is read from the memory M16a. Thereafter, in Step P102, it is determined whether or not the count value Y is larger than the total number DPYmax of the pixels detected in the vertical directions of the line-portion area measuring camera. When the determination in Step P102 is YES, in Step P103, the count value IAC for printed-portion area measurement is read from the memory M41. On the other hand, when the determination in Step P102 is NO, the process returns to Step P91.

Through the above-described steps, the number of pixels corresponding to the area of the line portion is obtained.

In Step P104, the printed portion area IA of the printing unit M is calculated from the count value IAC for printed-portion area measurement, and is then stored in the address location for the printed unit M in the memory M42. Thereafter, in Step P105, the printed-portion reference area IAF is read from the memory M43.

In Step P106, the printed-portion reference area IAF is subtracted from the printed portion area IA of the printed unit M. Thereby, the printed-portion area difference IAD of the printed unit M is calculated, and is then stored in the address location for the printed unit M in the memory M44.

In Step P107, the ink color ICm of the printing unit M is read from the memory M1. Thereafter, in Step P108, the conversion table between the printed-portion area difference of the ink color ICm and a compensation amount of the nip pressure between the plate cylinder and each of the ink form rollers is read from the memory M45.

In Step P109, the compensation amount of the nip pressure between the plate cylinder and each of the ink form rollers is obtained from the printed-portion area difference IAD by using the conversion table between the printed-portion area difference of the ink color ICm and the compensation amount of nip pressure between the plate cylinder and each of the ink form rollers, and is then stored in the address location for the printing unit M in the memory M22. Thereafter, in Step P110, the conversion table between the printed-portion area difference of the ink color ICm and the compensation amount of nip pressure between the plate cylinder and the blanket cylinder is read from the memory M46.

In Step P111, the compensation amount of the nip pressure between the plate cylinder and the blanket cylinder is obtained from the printed-portion area difference IAD by using the conversion table between the printed-portion area difference of the ink color ICm and the compensation amount of nip pressure between the plate cylinder and the blanket cylinder, and is then stored in the address location for the printing unit M in the memory M24. Thereafter, in Step P112, the conversion table between the printed-portion area difference of the ink color ICm and the compensation amount of printing pressure between the blanket cylinder and the impression cylinder is read from the memory M47. Then, in Step P113, the compensation amount of the printing pressure between the blanket cylinder and the impression cylinder is obtained from the printed-portion area difference IAD by using the conversion table between the printed-portion area difference of the ink color ICm and the compensation amount of printing pressure between the blanket cylinder and the impression cylinder, and is then stored in the address location for the printing unit M in the memory M26.

In Step P114, an output of the A/D convertor 46 connected to the potentiometer 47 for the motor for adjusting the nip pressure between the plate cylinder and each of the ink form rollers of the printing unit M is read, and is then stored in the address location for the printing unit M in the memory M27. Thereafter, in Step P115, the current nip pressure between the plate cylinder and each of the ink form rollers of the printing unit M is calculated from the output of the A/D convertor connected to the potentiometer for the motor for adjusting the nip pressure between the plate cylinder and each of the ink form rollers of the printing unit M, and is then stored in the address location for the printing unit M in the memory M28.

In Step P116, the compensation amount of the nip pressure between the plate cylinder and each of the ink form rollers of the printing unit M is read from the memory M22. Thereafter, in Step P117, it is determined whether the compensation amount of the nip pressure between the plate cylinder and each of the ink form rollers of the printing unit M is not 0. When the determination in step P117 is NO, it is determined, in Step P118, whether or not the compensation amount of the nip pressure between the plate cylinder and each of the ink form rollers of the printing unit M is larger than 0. On the other hand, when the determination in Step P117 is YES, the process proceeds to Step P131.

When the determination in Step P118 is YES, the compensation amount of the nip pressure between the plate cylinder and each of the ink form rollers of the printing unit M is added to the current nip pressure between the plate cylinder and each of the ink form rollers of the printing unit M in Step P119. Then, the target nip pressure between the plate cylinder and each of the ink form rollers of the printing unit M is calculated, and is then stored in the address location for the printing unit M in the memory M29. Thereafter, in Step P120, the target output of the A/D convertor connected to the potentiometer for the motor for adjusting the nip pressure between the plate cylinder and each of the ink form rollers of the printing unit M is calculated from the target nip pressure between the plate cylinder and each of the ink form rollers of printing unit M, and is then stored in the address location for the printing unit M in the memory M30.

In Step P121, a normal rotation instruction is outputted to the motor driver 45 for adjusting the nip pressure between the plate cylinder and each of the ink form rollers of the printing unit M. Thereafter, in Step P122, the output of the A/D convertor 46 connected to the potentiometer 47 for the motor for adjusting the nip pressure between the plate cylinder and each of the ink form rollers of the printing unit M is read, and is then stored in the address location for the printing unit M in the memory M27.

In Step P123, it is determined whether or not the output of the A/D convertor connected to the potentiometer for the motor for adjusting the nip pressure between the plate cylinder and each of the ink form rollers of the printing unit M is equal to the target output of the A/D convertor connected to the potentiometer for the motor for adjusting the nip pressure between the plate cylinder and each of the ink form rollers of the printing unit M. When the determination in Step P123 is YES, in Step P124, the output of the normal rotation instruction to the motor driver 45 for adjusting the nip pressure between the plate cylinder and each of the ink form rollers of the printing unit M is stopped. Thereafter, the process proceeds to Step P131. On the other hand, when the determination in Step P123 is NO, the process returns to Step P122.

When the determination in Step P118 is NO, in Step P125, the compensation amount of the nip pressure between the plate cylinder and each of the ink form rollers of the printing unit M is added to the current nip pressure between the plate cylinder and each of the ink form rollers of the printing unit M. Thereby, the target nip pressure between the plate cylinder and each of the ink form rollers of the printing unit M is calculated, and is then stored in the address location for the printing unit M in the memory M29. Thereafter, in Step P126, the target output of the A/D convertor connected to the potentiometer for motor for adjusting the nip pressure between the plate cylinder and each of the ink form rollers of the printing unit M is calculated from the target nip pressure between the plate cylinder and each of the ink form rollers of the printing unit M, and is then stored in the address location for the printing unit M in the memory M30.

In Step P127, a reverse rotation instruction is outputted to the motor driver 45 for adjusting the nip pressure between the plate cylinder and each of the ink form rollers of the printing unit M. Thereafter, in Step P128, the output of the A/D convertor connected to the potentiometer for the motor for adjusting the nip pressure between the plate cylinder and each of the ink form rollers of the printing unit M is read, and is then stored in the address location for the printing unit M in the memory M27.

In Step P129, it is determined whether or not the output of the A/D convertor connected to the potentiometer for the motor for adjusting the nip pressure between the plate cylinder and each of the ink form rollers of the printing unit M is equal to the target output of the A/D convertor connected to the potentiometer for the motor for adjusting the nip pressure between the plate cylinder and each of the ink form rollers of the printing unit M. When the determination in Step P129 is YES, in Step P130 the output of the reverse rotation instruction to the motor driver 45 for adjusting the nip pressure between the plate cylinder and each of the ink form rollers of the printing unit M is stopped. Then, the process proceeds to Step P131. When the determination in Step P129 is NO, the process returns to Step P128.

In Step P131, an output of the A/D convertor 49 connected to the potentiometer 50 for the motor for adjusting the nip pressure between the plate cylinder and the blanket cylinder of the printing unit M is read, and is then stored in the address location for the printing unit M in the memory M31. Thereafter, in Step P132, the current nip pressure between the plate cylinder and the blanket cylinder of the printing unit M is calculated from the output of the A/D convertor connected to the potentiometer for the motor for adjusting the nip pressure between the plate cylinder and the blanket cylinder of the printing unit M is calculated, and is then stored in the address location for the printing unit M in the memory M32.

In Step P133, the compensation amount of the nip pressure between the plate cylinder and the blanket cylinder of the printing unit M is read from the memory M24. Thereafter, in Step P134, it is determined whether the compensation amount of the nip pressure between the plate cylinder and the blanket cylinder of the printing unit M is not 0. When the determination in Step P134 is NO, it is determined, in Step P135, whether or not the compensation amount of the nip pressure between the plate cylinder and the blanket cylinder of the printing unit M is larger than 0. When the determination in Step P134 is YES, the process proceeds to Step P148.

When the determination in Step P135 is YES, in Step P136, the compensation amount of the nip pressure between the plate cylinder and the blanket cylinder of the printing unit M is added to the current nip pressure between the plate cylinder and the blanket cylinder of the printing unit M. Thereby, the target nip pressure between the plate cylinder and the blanket cylinder of the printing unit M is calculated, and is then stored in the address location for the printing unit M in the memory M33. Thereafter, in Step P137, the target output of the A/D convertor connected to the potentiometer for the motor for adjusting the nip pressure between the plate cylinder and the blanket cylinder of the printing unit M is calculated from the target nip pressure between the plate cylinder and the blanket cylinder of the printing unit M, and is then stored in the address location for the printing unit M in the memory M34.

In Step P138, a normal rotation instruction is outputted to the motor driver 48 for adjusting the nip pressure between the plate cylinder and the blanket cylinder of the printing unit M. Thereafter, in Step P139, the output of the A/D convertor 49 connected to the potentiometer 50 for the motor for adjusting the nip pressure between the plate cylinder and the blanket cylinder of the printing unit M is read, and is then stored in the address location for the printing unit M in the memory M31.

In Step P140, it is determined whether or not the output of the A/D convertor connected to the potentiometer for the motor for adjusting the nip pressure between the plate cylinder and the blanket cylinder of the printing unit M is equal to the target output of the A/D convertor connected to the potentiometer for the motor for adjusting the nip pressure between the plate cylinder and the blanket cylinder of the printing unit M. When the determination in Step P140 is YES, in Step P141, the output of the normal rotation instruction to the motor driver 48 for adjusting the nip pressure between the plate cylinder and the blanket cylinder of the printing unit M is stopped. Then, the process proceeds to Step P148. On the other hand, when the determination in Step P140 is NO, the process returns to Step P139.

When the determination in Step P135 is NO, in Step P142, the compensation amount of the nip pressure between the plate cylinder and the blanket cylinder of the printing unit M is added to the current nip pressure between the plate cylinder and the blanket cylinder of the printing unit M. Thereby, the target nip pressure between the plate cylinder and the blanket cylinder of the printing unit M is calculated, and is then stored in the address location for the printing unit M in the memory M33. Thereafter, in Step P143, the target output of the A/D convertor connected to the potentiometer for the motor for adjusting the nip pressure between the plate cylinder and the blanket cylinder of the printing unit M is calculated from the target nip pressure between the plate cylinder and the blanket cylinder of the printing unit M, and is then stored in the address location for the printing unit M in the memory M34.

In Step P144, a reverse rotation instruction is outputted to the motor driver 48 for adjusting the nip pressure between the plate cylinder and the blanket cylinder of the printing unit M. Thereafter, in Step P145, the output of the A/D convertor 49 connected to the potentiometer 50 for the motor for adjusting the nip pressure between the plate cylinder and the blanket cylinder of the printing unit M is read, and is then stored in the address location for the printing unit M in the memory M31.

In Step P146, it is determined whether or not the output of the A/D convertor connected to the potentiometer for the motor for adjusting the nip pressure between the plate cylinder and the blanket cylinder of the printing unit M is equal to the target output of the A/D convertor connected to the potentiometer for the motor for adjusting the nip pressure between the plate cylinder and the blanket cylinder of the printing unit M. When the determination in Step P146 is YES, in Step 147, the output of the reverse rotation instruction to the motor driver 48 for adjusting the nip pressure between the plate cylinder and the blanket cylinder of the printing unit M is stopped. Then, the process proceeds to Step P148. On the other hand, when the determination in Step P146 is NO, the process returns to Step P145.

In Step P148, the output of the A/D convertor 52 connected to the potentiometer 53 for the motor for adjusting the printing pressure between the blanket cylinder and the impression cylinder of the printing unit M is read, and is then stored in the address location for the printing unit M in the memory M35. Thereafter, in Step P149, the current printing pressure between the blanket cylinder and the impression cylinder of the printing unit M is calculated from the output of the A/D convertor connected to the potentiometer for the motor for adjusting the impression pressure between the blanket cylinder and the impression cylinder of the printing unit M, and is then stored in the address location for the printing unit M in the memory M36.

In Step P150, the compensation amount of the printing pressure between the blanket cylinder and the impression cylinder of the printing unit M is read from the memory M26. Thereafter, in Step P151, it is determined whether the compensation amount of the printing pressure between the blanket cylinder and the impression cylinder of the printing unit M is not 0. When the determination in Step P151 is NO, it is determined, in Step P152, whether or not the compensation amount of the printing pressure between the blanket cylinder and the impression cylinder of the printing unit M is larger than 0. On the other hand, when the determination in Step P151 is YES, the process proceeds to Step P165.

When the determination in Step P152 is YES, in Step P153, the compensation amount of the printing pressure between the blanket cylinder and the impression cylinder of the printing unit M is added to the current printing pressure between the blanket cylinder and the impression cylinder of the printing unit M. Thereby, the target printing pressure between the blanket cylinder and the impression cylinder of the printing unit M is calculated, and is then stored in the address location for the printing unit M in the memory M37. Thereafter, in Step P154, the target output of the A/D converter connected to the potentiometer for the motor for adjusting the printing pressure between the blanket cylinder and the impression cylinder of the printing unit M is calculated, from the target printing pressure between the blanket cylinder and the impression cylinder of the printing unit M and is then stored in the address location for the printing unit M in the memory M38.

In Step P155, a normal rotation instruction is outputted to the motor driver 51 for adjusting the printing pressure between the blanket cylinder and the impression cylinder of the printing unit M. Thereafter, in Step P156, the output of the A/D converter 52 connected to the potentiometer 53 for the motor for adjusting the printing pressure between the blanket cylinder and the impression cylinder of the printing unit M is read, and is then stored in the address location for the printing unit M in the memory M35.

In Step P157, it is determined whether or not the output of the A/D converter connected to the potentiometer for the motor for adjusting the printing pressure between the blanket cylinder and the impression cylinder of the printing unit M is equal to the target output of the A/D converter connected to the potentiometer for the motor for adjusting the printing pressure between the blanket cylinder and the impression cylinder of the printing unit M. When the determination in Step P157 is YES, in Step P158, the output of the normal rotation instruction to the motor driver 51 for adjusting the printing pressure between the blanket cylinder and the impression cylinder of the printing unit M is stopped. Then, the process proceeds to Step P165. On the other hand, when the determination in Step P157 is NO, the process returns to Step P156.

When the determination in Step P152 is NO, the compensation amount of the printing pressure between the blanket cylinder and the impression cylinder of the printing unit M is added to the current printing pressure between the plate cylinder and the blanket cylinder of the printing unit M in Step P159. Thereby, the target printing pressure between the blanket cylinder and the impression cylinder of the printing unit M is calculated, and is then stored in the address location for the printing unit M in the memory M37. Thereafter, in Step P160, the target output of the A/D converter connected to the potentiometer for the motor for adjusting the printing pressure between the blanket cylinder and the impression cylinder of the printing unit M is calculated from the target printing pressure between the blanket cylinder and the impression cylinder of the printing unit M, and is then stored in the address location for the printing unit M in the memory M38.

In Step P161, a reverse rotation instruction is outputted to the motor driver 51 for adjusting the printing pressure between the blanket cylinder and the impression cylinder of the printing unit M. Thereafter, in Step P162, the output of the A/D converter 52 connected to the potentiometer 53 for the motor for adjusting the printing pressure between the blanket cylinder and the impression cylinder of the printing unit M is read, and is then stored in the address location for the printing unit M in the memory M35.

In Step P163, it is determined whether or not the output of the A/D converter connected to the potentiometer for the motor for adjusting the printing pressure between the blanket cylinder and the impression cylinder of the printing unit M is equal to the target output of the A/D converter connected to the potentiometer for the motor for adjusting the printing pressure between the blanket cylinder and the impression cylinder of the printing unit M. When the determination in Step P163 is YES, in Step P164, the output of the reverse rotation instruction to the motor driver 51 for adjusting the printing pressure between the blanket cylinder and the impression cylinder of the printing unit M is stopped. Then, the process proceeds to Step P165. On the other hand, when the determination in Step P163 is NO, the process returns to Step P162.

In Step P165, the count value M is incremented by 1, and is then overwritten with the resultant value in the memory M2. Thereafter, in Step P166, the total number Mmax of the printing units is read from the memory M9. Then, in Step P167, it is determined whether or not the count value M is larger than the total number Mmax of the printing units. When the determination in Step P167 is YES, the process returns to Step P1. On the other hand, when the determination in Step P167 is NO, the process returns to Step P89. Thereafter, this process is repeated.

As described above, in the third embodiment, the area of the printed line portion is measured by the line-portion area measuring camera 44A, and the control device 30 controls the drive of each of the motors 9, 18, and 24 on the basis of the measuring result, to automatically adjust the nip pressure between the plate cylinder and each of the ink form rollers, the nip pressure between the plate cylinder and the blanket cylinder, and the printing pressure between the blanket cylinder and the impression cylinder. With this configuration, as those of the first embodiment and the second embodiment, it is possible to reduce the burden of the operator, and also to reduce the amount of waste paper to be produced, by preventing errors in manual adjustment.

It should be noted that the present invention is not limited to the above-described embodiments. It is obvious that various modifications such as modifications in the contact pressure adjustment means and the printing pressure adjustment means are possible without departing from the scope of the present invention.

What is claimed is:

1. A printing quality control method for a relief printing press including: a first rotor to which ink is supplied; a second rotor to which the ink is supplied from the first rotor; and contact pressure adjustment means for adjusting a contact pressure between the first rotor and the second rotor, the printing quality control method comprising:
measuring a width of a line portion printed on a print member by the relief printing press; and
controlling the contact pressure adjustment means on the basis of the width of the line portion thus measured.

2. A printing quality control method for a relief printing press including: a first rotor to which ink is supplied; a second rotor facing the first rotor, and holding a print member to which the ink is supplied from the first rotor; and printing pressure adjustment means for adjusting a printing pressure between the first rotor and the second rotor, the printing quality control method comprising:
measuring a width of a line portion printed on the print member by the relief printing press; and
controlling the printing pressure adjustment means on the basis of the width of the line portion thus measured.

3. A printing quality control method for a relief printing press including: a first rotor to which ink is supplied; a second rotor to which the ink is supplied from the first rotor; and
contact pressure adjustment means for adjusting a contact pressure between the first rotor and the second rotor, the printing quality control method comprising:
measuring an area of printed portion printed on a predetermined section of the print member by the relief printing press; and
controlling the contact pressure adjustment means on the basis of the area of the printed portion thus measured.

4. A printing quality control method for a relief printing press including: a first rotor to which ink is supplied; a second rotor facing the first rotor, and holding a print member to which the ink is supplied from the first rotor; and printing pressure adjustment means for adjusting a printing pressure between the first rotor and the second rotor, the printing quality control method comprising:
measuring an area of printed portion printed on a predetermined section of the print member by the relief printing press; and
controlling the printing pressure adjustment means on the basis of the area of the printed portion thus measured.

5. A printing quality control system for a relief printing press including: a first rotor to which ink is supplied; a second rotor to which the ink is supplied from the first rotor; and contact pressure adjustment means for adjusting a contact pressure between the first rotor and the second rotor, the printing quality control system comprising:
width measurement means for measuring a width of a line portion printed on a print member by the relief printing press; and
control means for controlling the contact pressure adjustment means on the basis of the width of the line portion obtained by the width measurement means.

6. A printing quality control system for a relief printing press including: a first rotor to which ink is supplied; a second rotor facing the first rotor, and holding a print member to which the ink is supplied from the first rotor; and printing pressure adjustment means for adjusting a printing pressure between the first rotor and the second rotor, the printing quality control system comprising:
width measurement means for measuring a width of a line portion printed on the print member by the relief printing press; and
control means for controlling the printing pressure adjustment means on the basis of the width of the line portion obtained by the width measurement means.

7. A printing quality control system for a relief printing press including: a first rotor to which ink is supplied; a second rotor to which the ink is supplied from the first rotor; and contact pressure adjustment means for adjusting a contact pressure between the first rotor and the second rotor, the printing quality control system comprising:
area measurement means for measuring an area of printed portion printed on a predetermined section of a print member by the relief printing press; and
control means for controlling the contact pressure adjustment means on the basis of the area of the printed portion obtained by the area measurement means.

8. A printing quality control system for a relief printing press including: a first rotor to which ink is supplied; a second rotor facing the first rotor, and holding a print member to which the ink is supplied from the first rotor; and printing pressure adjustment means for adjusting a printing pressure between the first rotor and the second rotor, the printing quality control system comprising:
area measurement means for measuring an area of printed portion printed on a predetermined section of a print member by the relief printing press; and
control means for controlling the printing pressure adjustment means on the basis of the area of the printed portion obtained by the area measurement means.

9. A relief printing press, comprising:
a first rotor to which ink is supplied;
a second rotor to which the ink is supplied from the first rotor;
contact pressure adjustment means for adjusting a contact pressure between the first rotor and the second rotor;
width measurement means for measuring a width of a line portion printed on a print member by the relief printing press; and
control means for controlling the contact pressure adjustment means on the basis of the width of the line portion obtained by the width measurement means.

10. A relief printing press, comprising:
a first rotor to which ink is supplied;
a second rotor facing the first rotor, and holding a print member to which the ink is supplied from the first rotor;
printing pressure adjustment means for adjusting a printing pressure between the first rotor and the second rotor;
width measurement means for measuring a width of a line portion printed on the print member by the relief printing press; and
control means for controlling the printing pressure adjustment means on the basis of the width of the line portion obtained by the width measurement means.

11. A relief printing press, comprising:
a first rotor to which ink is supplied;
a second rotor to which the ink is supplied from the first rotor;
contact pressure adjustment means for adjusting a contact pressure between the first rotor and the second rotor;
area measurement means for measuring an area of printed portion printed on a predetermined section of a print member by the relief printing press; and
control means for controlling the contact pressure adjustment means on the basis of the area of the printed portion obtained by the area measurement means.

12. A relief printing press, comprising:
a first rotor to which ink is supplied;
a second rotor facing the first rotor, and holding a print member to which the ink is supplied from the first rotor;
printing pressure adjustment means for adjusting a printing pressure between the first rotor and the second rotor;
area measurement means for measuring an area of printed portion printed on a predetermined section of a print member by the relief printing press; and
control means for controlling the printing pressure adjustment means on the basis of the area of the printed portion obtained by the area measurement means.
